(19) United States
(12) Patent Application Publication
(10) Pub. No.: US 2024/0038985 A1
(43) Pub. Date: Feb. 1, 2024

(54) BATTERY

(71) Applicant: SEMICONDUCTOR ENERGY LABORATORY CO., LTD., Atsugi-shi (JP)

(72) Inventors: Kengo AKIMOTO, Isehara (JP); Kazutaka KURIKI, Ebina (JP)

(21) Appl. No.: 18/356,310

(22) Filed: Jul. 21, 2023

(30) Foreign Application Priority Data
Jul. 22, 2022 (JP) 2022-117349

(51) Int. Cl. H01M 4/525; H01M 4/66; H01M 4/1315; H01M 50/178; H01M 50/105

(52) U.S. Cl. CPC H01M 4/525; H01M 4/663; H01M 4/1315; H01M 50/178; H01M 50/105; H01M 2004/028

(57) ABSTRACT

A positive electrode active material that inhibits a decrease in discharge capacity in charge and discharge cycles and a battery using the positive electrode active material are provided. A high-safety battery is provided. The battery includes a positive electrode including a positive electrode current collector and a positive electrode active material layer. The positive electrode current collector is a carbon sheet. The positive electrode active material contains lithium cobalt oxide containing nickel and magnesium. The detected amount of nickel in a surface portion of the positive electrode active material is larger than that in an inner portion of the positive electrode active material. The detected amount of magnesium in the surface portion of the positive electrode active material is larger than the detected amount of magnesium in the inner portion of the positive electrode active material. The surface portion in the positive electrode active material includes a region where the distribution of nickel and the distribution of magnesium overlap with each other.

### BACKGROUND OF THE INVENTION

### 1. Field of the Invention

One embodiment of the present invention relates to a power storage device (also referred to as a battery or a secondary battery). The present invention is not limited to the above field and relates to a semiconductor device, a display device, a light-emitting device, a lighting device, an electronic device, a vehicle, and manufacturing methods thereof. The battery of the present invention can be used as a power supply necessary for the above semiconductor device, display device, light-emitting device, lighting device, electronic device, and vehicle. Examples of the battery include secondary batteries such as a lithium-ion secondary battery and a sodium-ion secondary battery. For example, the above electronic device may be an information terminal device provided with the lithium-ion secondary battery. Furthermore, the above power storage device may be a stationary power storage device, for example.

### 2. Description of the Related Art

In recent years, a variety of storage batteries such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

It is said that lithium-ion secondary batteries can hardly be safe when having high capacity. A positive electrode active material with a layered rock-salt crystal structure, which includes two-dimensional lithium ion diffusion paths, is expected to enable high capacity, for example. However, the positive electrode active material having a layered rock-salt crystal structure has been disadvantageous in terms of safety because the crystal structure will be collapsed by excessive extraction of lithium ions at the time of charging, easily resulting in thermal runaway. To suppress an increase in battery temperature under abnormal conditions, e.g., at the time of nail penetration that is conducted in safety testing called a nail penetration test, Patent Document 1 proposes a structure in which a protective layer is disposed between a positive electrode composite layer and a positive electrode current collector, for example.

Lithium cobalt oxide (LiCoO₂) is one of known positive electrode active materials with a layered rock-salt crystal structure. In lithium cobalt oxide, which has a layered rock-salt crystal structure, lithium ions can move two-dimensionally between layers composed of CoO₆ octahedrons, leading to favorable cycle performance. However, lithium cobalt oxide unfortunately undergoes a phase change due to charging and discharging. For example, a phase change from the hexagonal phase to the monoclinic phase occurs in lithium cobalt oxide when lithium ions are extracted to some extent at the time of charging. Thus, to use lithium cobalt oxide such that it enables favorable cycle performance, the amount of lithium ions to be extracted has been limited. Patent Documents 2 to 4, for example, propose structures for solving these problems, in which an additive element is added to lithium cobalt oxide. In the examination of the additive element, the descriptions in Non-Patent Document 1 known as Shannon's ionic radii are sometimes referred to. Crystal structures of positive electrode active materials have also been studied (Non-Patent Documents 2 to 5).

X-ray diffraction (XRD) is one of methods used for analysis of positive electrode active materials of secondary batteries. XRD data can be analyzed with the use of the Inorganic Crystal Structure Database (ICSD) described in Non-Patent Document 6. For example, the ICSD can be referred to for the lattice constant of the lithium cobalt oxide described in Non-Patent Document 7. For Rietveld analysis, the analysis program RIETAN-FP (Non-Patent Document 8) can be used, for example.

As image processing software, for example, ImageJ (see Non-Patent Documents 9 to 11) is known. Using this software makes it possible to analyze the shape of a positive electrode active material, for example.

Nanobeam electron diffraction can also be effectively used to identify the positive electrode active material, in particular, the crystal structure of a surface portion of the positive electrode active material. For analysis of electron diffraction patterns, an analysis program called ReciPro (Non-Patent Document 12) can be used, for example.

Fluorides such as fluorite (calcium fluoride) have been used as fusing agents in iron manufacture and the like for a very long time, and the physical properties of fluorides have been studied (Non-Patent Document 13).

Lithium-ion secondary batteries are known to enter thermal runaway after passing through several states when the temperature increases at the time of charging (Non-Patent Documents 14 and 15).

### REFERENCE

### Patent Documents

[Patent Document 1] Japanese Published Patent Application No. 2019-129009
[Patent Document 2] Japanese Published Patent Application No. 2019-179758
[Patent Document 3] PCT International publication No. 2020/026078 pamphlet
[Patent Document 4] Japanese Published Patent Application No. 2020-140954

### Non-Patent Documents

[Non-Patent Document 1] R. D. Shannon et al., Acta Cryst. Section A, (1976) 32 751.
[Non-Patent Document 2] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 3] T. Motohashi et al., “Electronic phase diagram of the layered cobalt oxide system LiₓCoO₂ (0.0≤x≤1.0)”, Physical Review B, 80 (16); 165114.
[Non-Patent Document 4] Zhaohui Chen et al., “Staging Phase Transitions in LiₓCoO₂”, Journal of The Electrochemical Society, 2002, 149 (12), A1604-A1609.
[Non-Patent Document 5] G. G. Amatucci et al., “CoO₂, The End Member of the LiₓCoO₂ Solid Solution”, J. Electrochem. Soc., 143 (3), 1114 (1996).
[Non-Patent Document 6] A. Belsky, et al., “New developments in the Inorganic Crystal Structure Database (ICSD): accessibility in support of materials research and design”, Acta Cryst., (2002), B58, 364-369.
[Non-Patent Document 7] Akimoto, J.; Gotoh, Y.; Oosawa, Y. “Synthesis and structure refinement of LiCoO₂ single crystals”, Journal of Solid State Chemistry (1998) 141, pp. 298-302.
[Non-Patent Document 8] F. Izumi and K. Momma, Solid State Phenom., (2007) 130, 15-20.
[Non-Patent Document 9] Rasband, W. S., ImageJ, U. S. National Institutes of Health, Bethesda, Maryland, USA, http://rsb.info.nih.gov/ij/, 1997-2012.
[Non-Patent Document 10] Schneider, C. A., Rasband, W. S., Eliceiri, K. W., “NIH Image to ImageJ: 25 years of image analysis”, Nature Methods, 9, 671-675, 2012.
[Non-Patent Document 11] Abramoff, M. D., Magelhaes, P. J., Ram, S. J., “Image Processing with ImageJ”, Biophotonics International, volume 11, issue 7, pp. 36-42, 2004.
[Non-Patent Document 12] Seto, Y. & Ohtsuka, M., “ReciPro: free and open-source multipurpose crystallographic software integrating a crystal model database and viewer, diffraction and microscopy simulators, and diffraction data analysis tools” (2022) J. Appl. Cryst., 55.
[Non-Patent Document 13] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1], 12-17 (1953).
[Non-Patent Document 14] Nobuo Eda, “2-4: Mechanism of Heat Generation” in “Learning Charging and Discharging Techniques of Li-Ion Batteries from Data” [Translated from Japanese.], CQ Publishing Co., Ltd., published on Apr. 4, 2020, pp. 68-72.
[Non-Patent Document 15] Takashi Mukai, Tetsuo Sakai, and Masahiro Yanagida. “Thermal Runaway Mechanism and High Safety Technology of Lithium Ion Battery”, Journal of the Surface Finishing Society of Japan, 70(6), 301-307 (2019).

### SUMMARY OF THE INVENTION

In a charged battery, lithium cobalt oxide (LiCoO₂, also referred to as LCO) is said to have low thermal stability. In a lithium-ion secondary battery, when an internal short circuit occurs by a nail penetration test or the like, Joule heat is generated to make lithium cobalt oxide have high temperatures and release oxygen. The oxygen released from the lithium cobalt oxide reacts with an electrolyte solution or the like, which leads to thermal runaway in some cases. In the case where the lithium cobalt oxide has high temperatures, it is known that a thermite reaction between the lithium cobalt oxide and aluminum that is generally used for a positive electrode current collector occurs (Non-Patent Document 15).

When the thermite reaction occurs, the temperature of the lithium cobalt oxide is increased to as high as 1000° C. or more. Thus, it is important to suppress the thermite reaction between a positive electrode active material and aluminum foil.

In view of the above, an object of one embodiment of the present invention is to provide a high-safety battery. Another object of one embodiment of the present invention is to provide a high-capacity and high-safety battery.

Another object of one embodiment of the present invention is to provide a novel material, a novel active material, a novel storage device, or a manufacturing method thereof.

Note that the description of these objects does not preclude the existence of other objects. In one embodiment of the present invention, there is no need to achieve all these objects. Other objects can be derived from the description of the specification, the drawings, and the claims.

One embodiment of the present invention is a battery which includes a positive electrode. The positive electrode includes a positive electrode current collector and a positive electrode active material layer. The positive electrode current collector is a carbon sheet.

In the above, the carbon sheet preferably includes carbon nanotubes.

Another embodiment of the present invention is a battery which includes a positive electrode. The positive electrode includes a positive electrode current collector and a positive electrode active material layer. The positive electrode current collector includes a stack of a first carbon sheet and a second carbon sheet. The first carbon sheet and the second carbon sheet each include carbon nanotubes.

In the above, in the first carbon sheet, the carbon nanotubes are preferably oriented in a first direction parallel to a surface of the first carbon sheet. In the second carbon sheet, the carbon nanotubes are preferably oriented in a second direction parallel to a surface of the second carbon sheet. The first direction and the second direction are preferably substantially orthogonal to each other.

In the above, the battery preferably includes an exterior body surrounding the positive electrode and a positive electrode lead extending from the inside to the outside of the exterior body. The positive electrode lead preferably includes a region positioned between the first carbon sheet and the second carbon sheet.

In the battery described in any one of the above, the positive electrode active material layer preferably contains a positive electrode active material. The positive electrode active material preferably contains lithium cobalt oxide containing nickel and magnesium. The detected amount of nickel in a surface portion of the positive electrode active material is preferably larger than the detected amount of nickel in an inner portion of the positive electrode active material. The detected amount of magnesium in the surface portion of the positive electrode active material is preferably larger than the detected amount of magnesium in the inner portion of the positive electrode active material. The surface portion of the positive electrode active material preferably includes a region where the distribution of nickel and the distribution of magnesium overlap with each other.

In the above, nickel is preferably detected on a plane other than the (001) plane of lithium cobalt oxide in the surface portion of the positive electrode active material.

In the above, in EDX line analysis, the difference between the depth of the peak of the detected amount of nickel and the peak of the detected amount of magnesium in the surface portion of the positive electrode active material is preferably less than or equal to 3 nm.

In the above, the positive electrode active material preferably contains aluminum. In EDX line analysis of nickel, magnesium, and aluminum in the positive electrode active material, a maximum value of the detected amount of aluminum is preferably observed at an inner portion than a maximum value of the detected amount of nickel and a maximum value of the detected amount of magnesium. When a peak width at the height that is ⅕ of the height of the maximum value of the detected amount of aluminum is divided into two parts by a perpendicular extending from the maximum value to a horizontal axis, a peak width W_{c} on an inner portion side is preferably larger than a peak width Wₛ on a surface side.

In the above, the lithium is used for the positive electrode and a counter electrode. When the positive electrode is analyzed by powder X-ray diffraction using a CuKα₁ ray in a state where the battery is charged to 4.6 V, a diffraction pattern of the positive electrode active material preferably includes at least a first peak at 2θ of greater than or equal to 19.13° and less than 19.37° and a second peak at 2θ of greater than or equal to 45.37° and less than 45.57°.

In the above, the positive electrode active material preferably contains fluorine. The detected amount of fluorine in the surface portion of the positive electrode active material is preferably larger than the detected amount of fluorine in the inner portion of the positive electrode active material.

According to one embodiment of the present invention, a high-safety battery can be provided. According to another embodiment of the present invention, a high-capacity and high-safety battery can be provided.

According to another embodiment of the present invention, a novel material, a novel active material, a novel storage device, or a manufacturing method thereof can be provided.

Note that the description of these effects does not preclude the existence of other effects. One embodiment of the present invention does not need to have all the effects. Other effects will be apparent from and can be derived from the description of the specification, the drawings, the claims, and the like.

### BRIEF DESCRIPTION OF THE DRAWINGS

FIG. 1A is a perspective view of a battery, and FIGS. 1B and 1C are cross-sectional views of the battery.

FIGS. 2A and 2B are graphs showing the internal temperature of a battery.

FIGS. 3A and 3B illustrate a nail penetration test.

FIGS. 4A to 4D illustrate structure examples of a positive electrode.

FIGS. 5A to 5C illustrate structure examples of a positive electrode.

FIGS. 6A to 6E illustrate a formation method of a positive electrode.

FIGS. 7A to 7E illustrate a formation method of a negative electrode.

FIGS. 8A to 8C illustrate structure examples of a stack.

FIGS. 9A to 9C are cross-sectional views of a positive electrode active material.

FIGS. 10A to 10C show distribution examples of additive elements contained in a positive electrode active material.

FIG. 11A shows a distribution example of additive elements contained in a positive electrode active material, and FIG. 11B shows the distribution of the additive element.

FIG. 12 is a phase diagram showing a relation between temperature and compositions of lithium fluoride and magnesium fluoride.

FIG. 13 shows results of DSC measurement.

FIG. 14 is an example of a TEM image showing crystal orientations substantially aligned with each other.

FIG. 15A is an example of a STEM image showing crystal orientations substantially aligned with each other, FIG. 15B shows an FFT pattern of a region of a rock-salt crystal RS, and FIG. 15C shows an FFT pattern of a region of a layered rock-salt crystal LRS.

FIG. 16 illustrates crystal structures of a positive electrode active material.

FIG. 17 illustrates crystal structures of a conventional positive electrode active material.

FIG. 18 shows charge depths and lattice constants of a positive electrode active material.

FIG. 19 shows XRD patterns calculated from crystal structures.

FIG. 20 shows XRD patterns calculated from crystal structures.

FIGS. 21A and 21B show XRD patterns calculated from crystal structures.

FIGS. 22A to 22C show lattice constants calculated using XRD.

FIGS. 23A to 23C show lattice constants calculated using XRD.

FIGS. 24A and 24B are cross-sectional views of a positive electrode active material.

FIGS. 25A to 25C illustrate formation steps of a positive electrode active material.

FIG. 26 illustrates a formation method of a positive electrode active material.

FIGS. 27A to 27C illustrate formation methods of a positive electrode active material.

FIGS. 28A to 28H illustrate examples of electronic devices.

FIGS. 29A to 29D illustrate examples of electronic devices.

FIGS. 30A to 30C illustrate examples of electronic devices.

FIGS. 31A to 31C illustrate examples of vehicles.

FIG. 32 is a photograph of the appearance of a positive electrode formed in Example 1.

FIG. 33 is a graph showing results of a charge and discharge cycle test of a test cell fabricated in Example 1.

### DETAILED DESCRIPTION OF THE INVENTION

Hereinafter, examples of embodiments of the present invention will be described with reference to the drawings and the like. Note that the present invention should not be construed as being limited to the examples of embodiments given below. Embodiments of the invention can be changed unless it deviates from the spirit of the present invention.

In this specification and the like, a space group is represented using the short symbol of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing a minus sign (−) in front of a number instead of placing a bar over the number. Furthermore, an individual direction that shows an orientation in crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. A trigonal system represented by the space group R-3m is generally represented by a composite hexagonal lattice for easy understanding of the structure and is also represented by a composite hexagonal lattice in this specification and the like unless otherwise specified. In some cases, not only (hkl) but also (hkil) is used as the Miller index. Here, i is −(h+k). In this specification and the like, a crystal plane or the like in the space group R-3m is represented with use of a composite hexagonal lattice, unless otherwise specified.

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium that can be inserted into and extracted from the positive electrode active material is extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

The remaining amount of lithium that can be inserted into and extracted from a positive electrode active material is represented by x in a compositional formula, e.g., LiₓCoO₂. In the case of a positive electrode active material in a lithium-ion secondary battery, x can be represented by (theoretical capacity−charge capacity)/theoretical capacity. For example, when a lithium-ion secondary battery that includes LiₓCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, 0.1<x≤0.24.

Lithium cobalt oxide to be used for a positive electrode, which has been appropriately synthesized and almost satisfies the stoichiometric proportion, is LiCoO₂ With x of 1. Also in a secondary battery after its discharging ends, it can be said that lithium cobalt oxide therein is LiCoO₂ with x of 1. Here, “discharging ends” means that a voltage becomes 3.0 V or 2.5 V or lower at a discharge current of 100 mA/g or lower, for example.

Charge capacity and/or discharge capacity used for calculation of x in LiₓCoO₂ are/is preferably measured under the conditions where there is no influence or small influence of a short circuit and/or decomposition of an electrolyte solution or the like. For example, data of a lithium-ion secondary battery that is measured while a sudden change in capacity that seems to be derived from a short circuit is caused should not be used for calculation of x.

The space group of a lithium-ion secondary battery is identified by XRD, electron diffraction, neutron diffraction, or the like. Thus, in this specification and the like, belonging to a space group or being a space group can be rephrased as being identified as a space group.

A structure is referred to as a cubic close-packed structure when three layers of anions are shifted and stacked like “ABCABC” in the structure. Accordingly, anions do not necessarily form a cubic lattice structure. At the same time, actual crystals always have a defect and thus, analysis results are not necessarily consistent with the theory. For example, in an electron diffraction pattern or a fast Fourier transform (FFT) pattern of a TEM image or the like, a spot may appear in a position different from a theoretical position. For example, anions may be regarded as forming a cubic close-packed structure when a difference in orientation from a theoretical position is 5° or less or 2.5° or less.

The distribution of an element indicates the region where the element is successively detected by a successive analysis method to the extent that the detection value is no longer on the noise level.

In this specification and the like, a positive electrode active material to which an additive element is added is sometimes referred to as a composite oxide, a positive electrode member, a positive electrode material, a lithium-ion secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a complex.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a lithium-ion secondary battery containing the positive electrode active material is sufficiently obtained.

The voltage applied to a positive electrode usually increases with increasing charge voltage of a lithium-ion secondary battery. The positive electrode active material of one embodiment of the present invention is stable when being in a charged state, which inhibits a reduction in charge and discharge capacity due to repeated charging and discharging in a lithium-ion secondary battery.

An internal short circuit or an external short circuit of a lithium-ion secondary battery might cause not only a malfunction in charging operation and/or discharging operation of the lithium-ion secondary battery but also heat generation and ignition. In order to obtain a safe lithium-ion secondary battery, an internal short circuit or an external short circuit is preferably inhibited even at a high charge voltage. With the positive electrode active material of one embodiment of the present invention, an internal short circuit or an external short circuit is inhibited even at a high charge voltage. Thus, a lithium-ion secondary battery with both high discharge capacity and high safety can be obtained. Note that an internal short circuit of a lithium-ion secondary battery refers to contact between a positive electrode and a negative electrode in the battery. An external short circuit of a lithium-ion secondary battery refers to contact between a positive electrode and a negative electrode outside the battery on the assumption that the battery is misused.

Note that the description is made on the assumption that materials (such as a positive electrode active material, a negative electrode active material, an electrolyte solution, and a separator) of a lithium-ion secondary battery have not been degraded unless otherwise specified. A decrease in discharge capacity due to aging treatment and burn-in treatment during the manufacturing process of a lithium-ion secondary battery is not regarded as degradation. For example, a state where discharge capacity is higher than or equal to 97% of the rated capacity of a lithium-ion secondary battery composed of a cell or an assembled battery can be regarded as a non-degraded state. The rated capacity conforms to Japanese Industrial Standards (JIS C 8711:2019) in the case of a lithium-ion secondary battery for a portable device. The rated capacities of other lithium-ion secondary batteries conform to JIS described above, JIS for electric vehicle propulsion, industrial use, and the like, standards defined by the International Electrotechnical Commission (IEC), and the like.

In this specification and the like, in some cases, materials included in a lithium-ion secondary battery that have not been degraded are referred to as initial products or materials in an initial state, and materials that have been degraded (have discharge capacity lower than 97% of the rated capacity of the lithium-ion secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ion in the present invention, alkali metal ions or alkaline earth metal ions (specifically, sodium ions or the like) can be used. In that case, the present invention can be understood by replacing lithium ions with sodium ions or the like. In the case where there is no limitation on carrier ions, a simple term “secondary battery” is sometimes used.

### Embodiment 1

In this embodiment, structure examples of a battery of one embodiment of the present invention are described.

### [Battery]

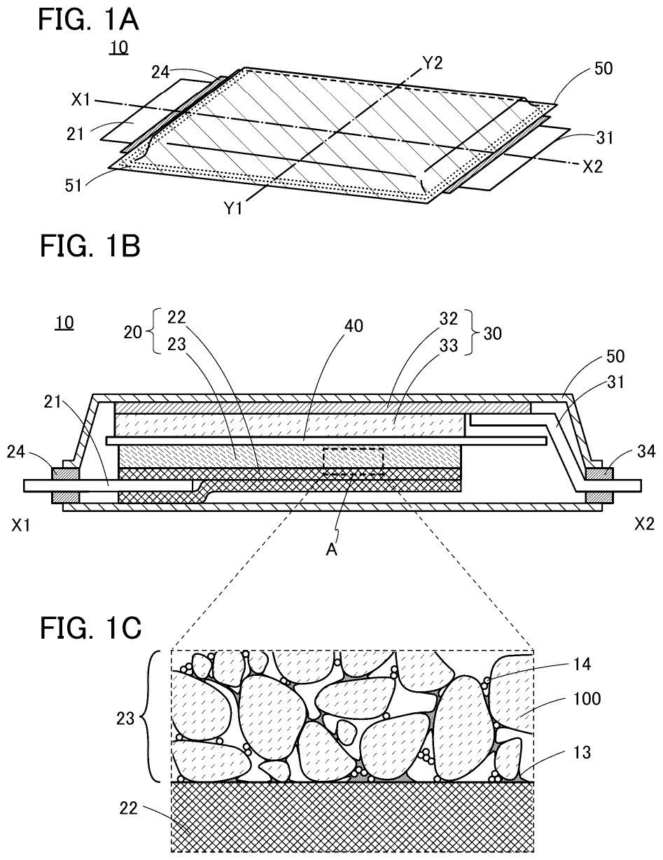

FIGS. 1A and 1B illustrate the battery of one embodiment of the present invention. FIG. 1C illustrates an example of an electrode included in the battery of one embodiment of the present invention.

FIG. 1A illustrates a battery 10. The battery 10 includes an exterior body 50, and a positive electrode lead 21 and a negative electrode lead 31 extending from the inside to the outside of the exterior body 50. The exterior body 50 is sealed with a sealing portion 24, a sealing portion 34, and a sealing portion 51.

FIG. 1B is a schematic cross-sectional view taken along the dashed-dotted line X1-X2 in FIG. 1A. The battery 10 includes a positive electrode 20, a negative electrode 30, a separator 40, and the exterior body 50. The positive electrode 20, the negative electrode 30, and the separator 40 are surrounded by the exterior body 50. The positive electrode 20 and the positive electrode lead 21 are electrically connected to each other, and the positive electrode lead 21 extends from the inside to the outside of the exterior body 50. The negative electrode 30 and the negative electrode lead 31 are electrically connected to each other, and the negative electrode lead 31 extends from the inside to the outside of the exterior body 50.

The positive electrode 20 includes a positive electrode current collector 22 and a positive electrode active material layer 23, and the negative electrode 30 includes a negative electrode current collector 32 and a negative electrode active material layer 33. The separator 40 includes at least a region positioned between the positive electrode active material layer 23 and the negative electrode active material layer 33. In the structure example in FIG. 1B, the positive electrode 20 includes two of the positive electrode current collectors 22, and the positive electrode lead 21 is sandwiched between the two positive electrode current collectors 22. Although not illustrated, electrolytes are contained in a space included in the positive electrode active material layer 23, a space included in the separator 40, and a space included in the negative electrode active material layer 33.

An example of an electrode included in the battery of one embodiment of the present invention is described with reference to FIG. 1C. FIG. 1C is an example of an enlarged view of a region A surrounded by a dashed-dotted line in FIG. 1B.

In a schematic cross-sectional view illustrated in FIG. 1C in which part of the positive electrode 20 is enlarged, the positive electrode active material layer 23 provided over the positive electrode current collector 22 contains a positive electrode active material 100 and a binder 13. Note that the positive electrode active material layer 23 may contain a conductive material 14 in addition to the positive electrode active material 100 and the binder 13, but may contain no conductive material 14 when the conductivity of the positive electrode active material 100 is sufficiently high. The positive electrode active material 100 is preferably a composite oxide having a layered rock-salt crystal structure belonging to the space group R-3m, such as lithium cobalt oxide. Note that the details of the positive electrode active material 100 of one embodiment of the present invention are described in Embodiment 2.

It is preferable that the positive electrode current collector 22 not contain a metal having high ionization tendency and low melting point, such as aluminum. For example, in the case where the positive electrode current collector contains aluminum, a thermite reaction between the composite oxide that is the positive electrode active material and aluminum might occur when the battery has high temperatures. It is difficult to stop the thermite reaction in the middle once it is started, and thus not only does the battery ignite but also the fire might be spread around the battery.

Accordingly, in the battery of one embodiment of the present invention, a non-metallic sheet is preferably used for the positive electrode current collector 22. As the non-metallic sheet, for example, a carbon sheet or a conductive resin sheet can be used.

The carbon sheet refers to a sheet formed of a conductive carbon material. As the conductive carbon material, one or more of carbon fibers such as a carbon nanofiber and a carbon nanotube and a graphene compound can be used. Note that a graphene compound includes graphene, multilayer graphene, reduced graphene oxide, reduced multilayer graphene oxide, and the like.

An example of a formation method of a carbon sheet using a carbon nanotube as the conductive carbon material is described. First, a catalyst layer is provided over a substrate, and then a carbon nanotube layer is formed by a CVD method, whereby a carbon nanotube substrate is formed. Then, part of the carbon nanotube layer is horizontally pulled out from a side surface of the carbon nanotube substrate, so that a carbon sheet made of carbon nanotubes can be obtained. In the carbon sheet formed by such a method, carbon nanotubes are aligned in the pulled-out direction, and this carbon sheet is also referred to as a uniaxially aligned carbon sheet.

An example of a formation method of a carbon sheet using reduced graphene oxide (RGO) as the conductive carbon material is described. First, an aqueous dispersion liquid of graphene oxide is applied to a substrate and dried to form a graphene oxide layer. After that, the graphene oxide layer is reduced to obtain a reduced graphene oxide (RGO) layer. Then, the substrate is removed, whereby a carbon sheet made of RGO can be obtained.

The carbon sheet preferably has a thickness greater than or equal to 0.5 μm. In the case where the mechanical strength is not enough, the carbon sheets are preferably stacked to be thick. Note that the thickness is preferably less than or equal to 1 mm so that the volume energy density is improved.

The conductive resin sheet refers to, for example, a sheet containing a resin such as polyolefin (e.g., polypropylene or polyethylene), nylon (polyamide), polyimide, vinylon, polyester, acrylic, or polyurethane, and a particulate or fibrous conductive material (also referred to as a conductive filler).

As the conductive material contained in the conductive resin sheet, a conductive carbon material can be used. As the conductive carbon material, for example, one or more of carbon black such as acetylene black or furnace black, graphite such as artificial graphite or natural graphite, carbon fibers such as a carbon nanofiber and a carbon nanotube, graphene, and a graphene compound can be used. Note that in the case where the conductive resin sheet is used as the positive electrode current collector, an antioxidant such as a hindered phenol-based material is further preferably used.

Examples of the carbon fiber include a mesophase pitch-based carbon fiber and an isotropic pitch-based carbon fiber. As the carbon fiber, a carbon nanofiber, a carbon nanotube, or the like can be used. Carbon nanotube can be formed by, for example, a vapor deposition method.

Note that the average particle diameter of the conductive material(s) contained in the conductive resin sheet can be greater than or equal to 10 nm and less than or equal to 10 μm and is preferably greater than or equal to 30 nm and less than or equal to 5 μm.

Thus, in the battery of one embodiment of the present invention using a non-metallic sheet such as a carbon sheet or a conductive resin sheet for the positive electrode current collector 22, a thermite reaction between the composite oxide that is the positive electrode active material and the positive electrode current collector 22 does not occur when the battery has high temperatures, which can prevent ignition of the battery and fire spread around the battery. In other words, thermal runaway can be inhibited in the battery of one embodiment of the present invention. The thermal runaway of a battery is described below.

### [Thermal Runaway of Battery]

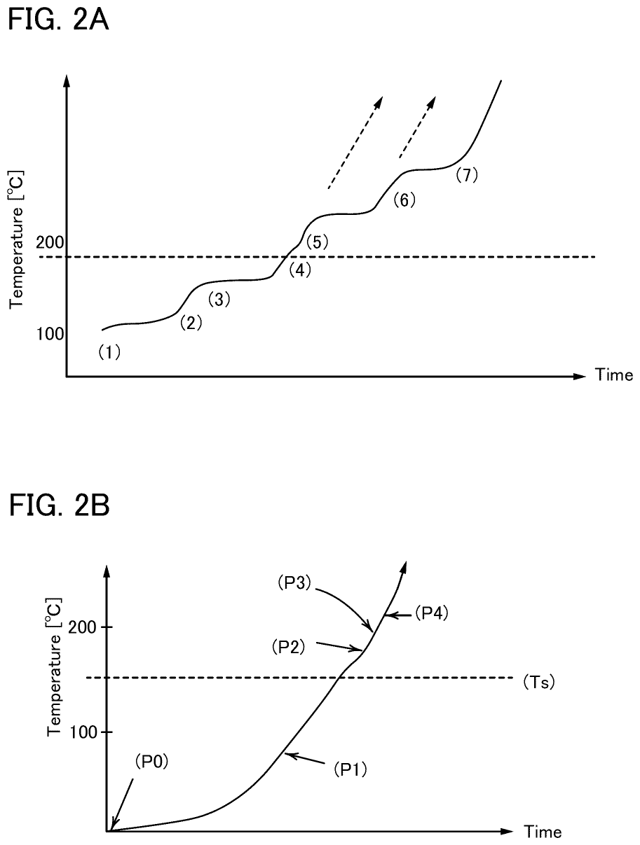

The mechanism of thermal runaway of a general lithium-ion battery is described with reference to FIG. 2A showing a graph cited from [FIG. 2-11] on p. 69 of Non-Patent Document 14, which is partly retouched. A battery as described above enters thermal runaway after experiencing some states when the temperature (specifically, the internal temperature) increases during charging, for example. FIG. 2A is a graph showing the temperature of a battery as a function of time. When the temperature of the battery reaches 100° C. or the vicinity thereof, for example, (1) collapse of a solid electrolyte interphase (SEI) of a negative electrode and heat generation are caused. When the temperature of the battery exceeds 100° C., (2) reduction of an electrolyte solution by the negative electrode (the negative electrode is C₆Li when graphite is used) and heat generation are caused, and (3) oxidation of the electrolyte solution by a positive electrode and heat generation are caused. When the temperature of the battery reaches 180° C. or the vicinity thereof, (4) thermal decomposition of the electrolyte solution is caused and (5) oxygen release from the positive electrode and thermal decomposition of the positive electrode (the thermal decomposition includes a structural change of a positive electrode active material) are caused. Subsequently, when the temperature of the battery exceeds 200° C., (6) decomposition of the negative electrode is caused, and finally, (7) the positive electrode and the negative electrode come into direct contact with each other. The battery enters thermal runaway after experiencing such states, specifically the state (5), the state (6), or the state (7).

According to FIG. 1 of Non-Patent Document 15, when the temperature of a battery exceeds 660° C., aluminum used for a positive electrode current collector is melted and a thermite reaction between the melted aluminum and an oxide used as a positive electrode active material occurs, whereby the battery has a high temperature of 1000° C. or higher.

To prevent thermal runaway, it is probably preferable that an increase in the temperature of the battery be inhibited and components of the battery (e.g., negative electrode, positive electrode, and electrolyte solution) be stable at high temperatures.

In the battery of one embodiment of the present invention using a non-metallic sheet such as a carbon sheet or a conductive resin sheet for the positive electrode current collector 22, the thermite reaction between the composite oxide that is the positive electrode active material and the positive electrode current collector 22 does not occur when the battery has high temperatures, which is preferable.

### [Nail Penetration Test]

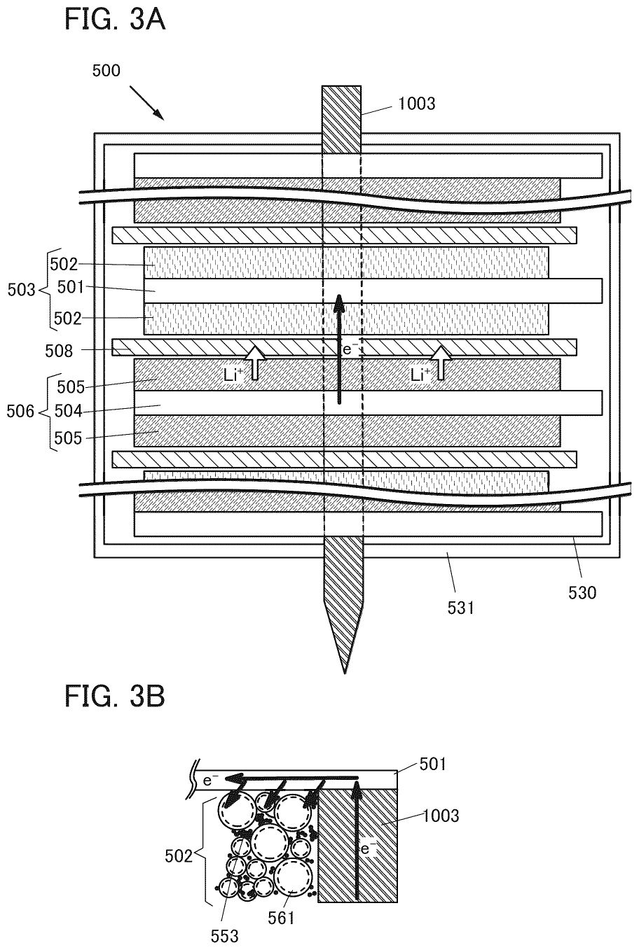

Next, a nail penetration test of a general lithium-ion battery is described with reference to FIGS. 3A and 3B and the like. In the nail penetration test, a nail 1003 having a predetermined diameter in the range of 2 mm to 10 mm penetrates a battery 500 in a fully charged state (a state of charge (SOC) of the battery is 100%) at a predetermined speed. The nail penetrating speed can be, for example, greater than or equal to 1 mm/s and less than or equal to 20 mm/s. FIG. 3A is a cross-sectional view illustrating the state where the nail 1003 penetrates the battery 500. The battery 500 has a structure in which a positive electrode 503, a separator 508, a negative electrode 506, and an electrolyte solution 530 are held in an exterior body 531. The positive electrode 503 includes a positive electrode current collector 501 and positive electrode active material layers 502 formed over both surfaces of the positive electrode current collector 501. The negative electrode 506 includes a negative electrode current collector 504 and negative electrode active material layers 505 formed over both surfaces of the negative electrode current collector 504. FIG. 3B is an enlarged view of the nail 1003 and the positive electrode current collector 501. The enlarged view also details the positive electrode active material 100 and a conductive material 553 of the positive electrode active material layer 502.

As illustrated in FIGS. 3A and 3B, when the nail 1003 penetrates the positive electrode 503 and the negative electrode 506, an internal short circuit occurs. This makes the potential of the nail 1003 equal to that of the negative electrode 506, so that an electron (e) flows to the positive electrode 503 through the nail 1003 and the like as indicated by the black arrows and Joule heat is generated in the portion where the internal short circuit has occurred and the vicinity of the portion. The internal short circuit causes carrier ions, typically lithium ions (Li⁺), to be extracted from the negative electrode 506 and to be released into the electrolyte solution as indicated by the white arrows. Here, in the case where anions are insufficient in the electrolyte solution 530, the electrical neutrality of the electrolyte solution 530 is not maintained when lithium ions are extracted from the negative electrode 506 to the electrolyte solution 530, so that the electrolyte solution 530 starts decomposing to maintain the electrical neutrality. This is one of electrochemical reactions and is referred to as a reduction reaction of an electrolyte solution by a negative electrode.

The Joule heat sometimes increases the temperature of the battery 500. At this time, when lithium cobalt oxide is used for the positive electrode active material, the crystal structure of the lithium cobalt oxide might be changed, and heat generation is further caused in some cases.

Then, the electron (e⁻) that has flowed to the positive electrode 503 reduces Co, which is tetravalent in the lithium cobalt oxide in the charged state, to trivalent or divalent Co. This reduction reaction causes oxygen release from the lithium cobalt oxide, and an oxidation reaction due to the oxygen decomposes the electrolyte solution 530. This is one of electrochemical reactions and is referred to as an oxidation reaction of an electrolyte solution by a positive electrode. The speed at which a current flows into the positive electrode active material 100 or the like varies depending on the insulating property of the positive electrode active material, and it is presumable that the speed at which a current flows affects the above electrochemical reaction.

When an internal short circuit of a battery occurs, its temperature is presumed to change as shown in the graph of FIG. 2B. FIG. 2B is the graph cited from [FIG. 2-12] on p. 70 of Non-Patent Document 14, which is partly retouched. This graph shows the temperature (specifically, the internal temperature) of a battery as a function of time. Upon an internal short circuit at (P0), the temperature of the battery increases over time. When the temperature of the battery increases to reach approximately 100° C. as indicated by (P1) owing to heat generation due to Joule heat by the internal short circuit, the temperature sometimes further increases to exceed the threshold temperature for thermal runaway of the battery, the reference temperature (Ts). Then, reduction of an electrolyte solution by a negative electrode (the negative electrode is C₆Li when graphite is used) and heat generation of the electrolyte solution are caused at (P2), oxidation of the electrolyte solution by a positive electrode and heat generation of the electrolyte solution are caused at (P3), and heat generation due to thermal decomposition of the electrolyte solution is caused at (P4). Accordingly, the battery enters thermal runaway, resulting in ignition, smoking, or the like.

To prevent smoking, heat generation, and the like in the nail penetration test, it is probably preferable that an increase in the temperature of the battery be inhibited and components of the battery (e.g., negative electrode, positive electrode, and electrolyte solution) be stable at high temperatures. Specifically, it is preferable that the positive electrode active material have a stable structure from which no oxygen is released even at high temperatures. Alternatively, the positive electrode active material preferably has a structure such that a current flows to the positive electrode active material at a low speed. As described later in Embodiment 2, the positive electrode active material 100 of one embodiment of the present invention can have both the above stable structure and the structure such that a current flows at a low speed.

### [Positive Electrode]

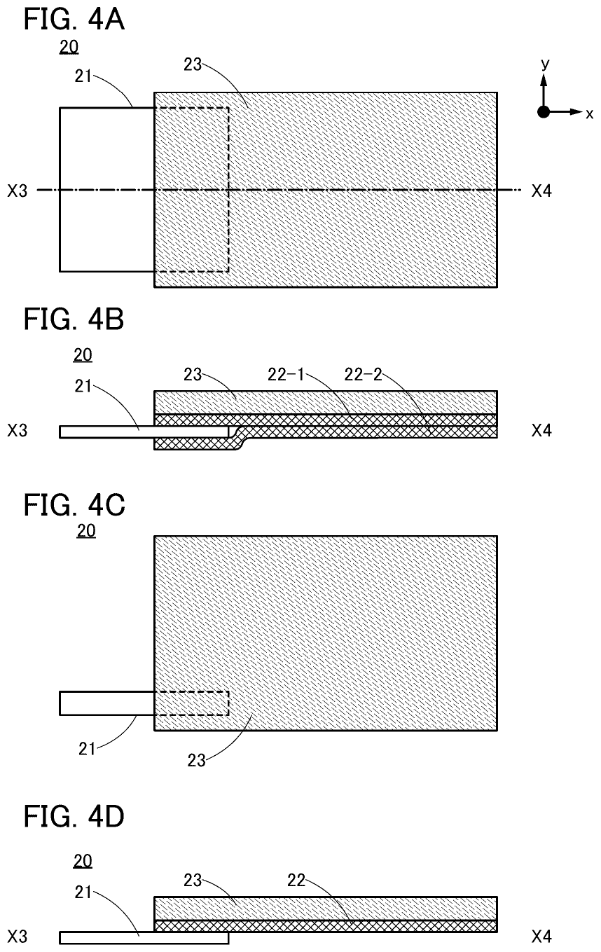

An example of the positive electrode 20 is described with reference to FIGS. 4A to 4D. FIGS. 4A and 4C are top views of the positive electrode 20. FIGS. 4B and 4D are cross-sectional views along the dashed-dotted line X3-X4 in FIG. 4A.

As illustrated in the top view of FIG. 4A, the positive electrode 20 includes a region overlapping with the positive electrode lead 21. In addition, as illustrated in FIG. 4B, the positive electrode 20 includes two of the positive electrode current collectors 22, which are a positive electrode current collector 22-1 and a positive electrode current collector 22-2, and the positive electrode active material layer 23. In a cross-sectional view, the positive electrode lead 21 can be provided to be sandwiched between the positive electrode current collectors 22-1 and 22-2.

Note that the shape of the positive electrode lead 21 is not limited to the shape that is wide in the y-direction as illustrated in FIG. 4A and may be the shape that is narrow in the y-direction as illustrated in FIG. 4C.

The positive electrode lead 21 is not necessarily provided to have the structure illustrated in FIG. 4B. Although the example is illustrated in FIG. 4B in which the positive electrode lead 21 is provided to be sandwiched between the two positive electrode current collectors 22 of the positive electrode current collectors 22-1 and 22-2, one positive electrode current collector 22 can be fixed with the positive electrode lead 21 with the use of a conductive adhesive or the like as illustrated in FIG. 4D.

For the positive electrode lead 21, metal foil such as aluminum foil, titanium foil, stainless steel foil, copper foil, or copper foil coated with nickel can be used. In the case where a metal having high ionization tendency and low melting point, such as aluminum foil, is used for the positive electrode lead 21, a structure is preferably employed in which the positive electrode lead 21 and the positive electrode active material layer 23 are not directly in contact with each other as illustrated in FIGS. 4B and 4D.

Assuming that an electronic device or a vehicle provided with the battery 10 is broken because of accidents or the like, the area of the region where the positive electrode 20 and the positive electrode lead 21 overlap with each other is preferably small when a metal having high ionization tendency and low melting point, such as aluminum foil, is used for the positive electrode lead 21. For example, in the top view, the area of the region where the positive electrode 20 and the positive electrode lead 21 overlap with each other is preferably larger than or equal to 1% and smaller than or equal to 30%, further preferably larger than or equal to 1% and smaller than or equal to 20%, still further preferably larger than or equal to 1% and smaller than or equal to 10%, yet further preferably larger than or equal to 1% and smaller than or equal to 5% of that of the positive electrode 20. With such a structure, occurrence of a thermite reaction can be suppressed even when the battery 10 is damaged.

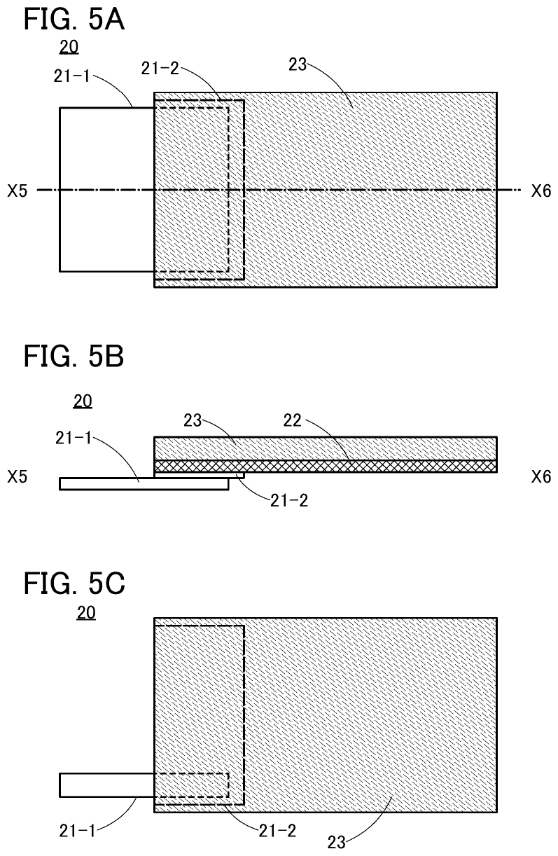

FIGS. 5A to 5C illustrate the positive electrode 20 having a structure different from that of the positive electrode 20 described in FIGS. 4A to 4D. FIGS. 5A and 5C are top views of the positive electrode 20. FIG. 5B is a cross-sectional view along the dashed-dotted line X5-X6 in FIG. 5A.

As illustrated in the top view of FIG. 5A, the positive electrode 20 includes a region overlapping with a first positive electrode lead 21-1 and a second positive electrode lead 21-2. A region where the positive electrode 20 and the second positive electrode lead 21-2 overlap with each other is larger than a region where the positive electrode 20 and the first positive electrode lead 21-1 overlap with each other. As illustrated in FIG. 5B, the positive electrode current collector 22 included in the positive electrode 20 and the second positive electrode lead 21-2 are connected, and the second positive electrode lead 21-2 and the first positive electrode lead 21-1 are connected. Note that the thickness of the second positive electrode lead 21-2 is preferably smaller than the thickness of the first positive electrode lead 21-1.

For the first positive electrode lead 21-1 and the second positive electrode lead 21-2, metal foil such as aluminum foil, titanium foil, stainless steel foil, copper foil, or copper foil coated with nickel can be used. In the case where a metal having high ionization tendency and low melting point, such as aluminum foil, is used for the first positive electrode lead 21-1 and the second positive electrode lead 21-2, the area of the region where the positive electrode 20 and the second positive electrode lead 21-2 overlap with each other is preferably small. For example, in the top view, the area of the region where the positive electrode 20 and the second positive electrode lead 21-2 overlap with each other is preferably larger than or equal to 1% and smaller than or equal to 30%, further preferably larger than or equal to 1% and smaller than or equal to 20%, still further preferably larger than or equal to 1% and smaller than or equal to 10%, yet further preferably larger than or equal to 1% and smaller than or equal to 5% of that of the positive electrode 20. With such a structure, occurrence of a thermite reaction can be suppressed even when the battery 10 is damaged.

Note that the shape of the first positive electrode lead 21-1 is not limited to the shape that is wide in the y-direction as illustrated in FIG. 5A and may be the shape that is narrow in the y-direction as illustrated in FIG. 5C.

### [Formation Method of Positive Electrode]

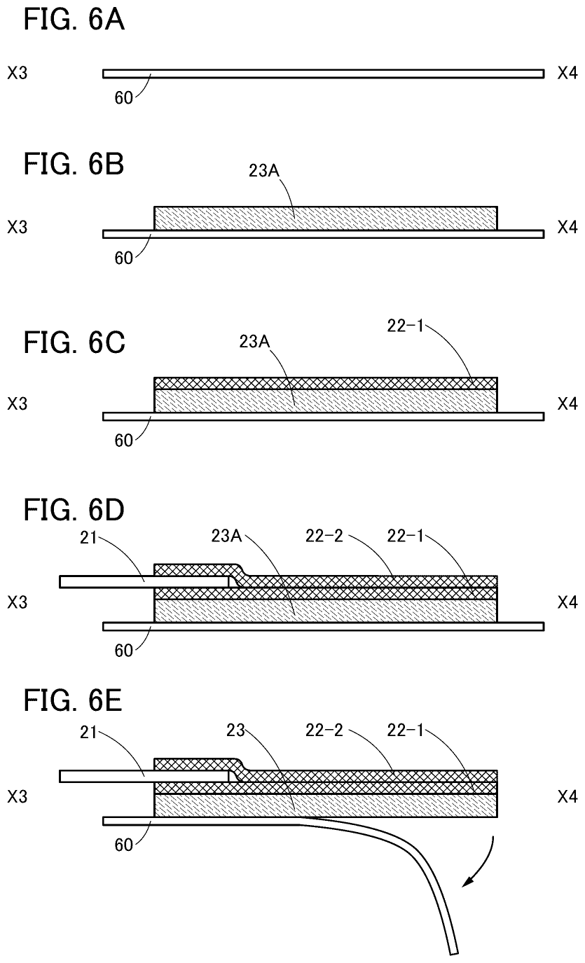

A formation method of the positive electrode 20 in FIG. 4B is described with reference to FIGS. 6A to 6E.

First, a base 60 is prepared as illustrated in FIG. 6A. A flexible resin film can be used as the base 60. As the resin film, for example, nylon (polyamide), polyimide, vinylon (polyvinyl alcohol-based fiber), polyester, acrylic, polyolefin, or polyurethane processed into a sheet can be used.

Next, as illustrated in FIG. 6B, a positive electrode active material slurry is applied to the base 60 to form a positive electrode active material slurry coating layer 23A.

A slurry refers to a material solution that is used to form an active material layer over a current collector and contains an active material, a binder, and a dispersion medium, preferably also a conductive material mixed therewith. The slurry may also be referred to as a slurry for an electrode or active material slurry; in some cases, a slurry for forming a positive electrode active material layer is referred to as a slurry for a positive electrode. For example, one or more of water, N-methylpyrrolidone (NMP), methanol, ethanol, acetone, tetrahydrofuran (THF), dimethylformamide (DMF), and dimethyl sulfoxide (DMSO) can be used as a dispersion medium.

As the positive electrode active material slurry, a mixture of the positive electrode active material 100, a conductive material, a binder, and a dispersion medium is preferably used. Although a binder and a conductive material used for a positive electrode included in the battery of one embodiment of the present invention are described later, for example, polyvinylidene fluoride and acetylene black can be used for the binder and the conductive material, respectively. When a polypropylene film is used for the base 60, NMP is preferably used for the dispersion medium.

Next, as illustrated in FIG. 6C, the positive electrode current collector 22-1 is provided over the positive electrode active material slurry coating layer 23A. At this time, the positive electrode active material slurry coating layer 23A contains a dispersion medium and a binder. When the positive electrode active material slurry coating layer 23A and the positive electrode current collector 22-1 are in contact with each other, the dispersion medium and the binder contained in the positive electrode active material slurry coating layer 23A soak into the positive electrode current collector 22-1, and the positive electrode active material slurry coating layer 23A and the positive electrode current collector 22-1 are integrated with each other.

Next, as illustrated in FIG. 6D, the positive electrode lead 21 is provided to partly overlap with the positive electrode current collector 22-1, and then the positive electrode current collector 22-2 is provided. At this time, the dispersion medium and the binder contained in the positive electrode active material slurry coating layer 23A soak into the positive electrode current collector 22-2, and the positive electrode active material slurry coating layer 23A, the positive electrode current collector 22-1, the positive electrode lead 21, and the positive electrode current collector 22-2 are integrated with each other.

In the case where a uniaxially aligned carbon sheet is used as each of the positive electrode current collectors 22-1 and 22-2, the uniaxially aligned carbon sheets are preferably provided such that the alignment direction of carbon of the positive electrode current collector 22-1 (e.g., alignment direction of carbon nanotubes) and the alignment direction of carbon of the positive electrode current collector 22-2 are orthogonal or substantially orthogonal to each other. Such a structure can increase the electron conductivity of the whole positive electrode 20. The term “orthogonal” indicates a state where two straight lines intersect or are in contact with each other at an angle greater than or equal to 80° and less than or equal to 100°. Thus, the case where the angle is greater than or equal to 85° and less than or equal to 95° is also included. The term “substantially orthogonal” indicates a state where two straight lines intersect or are in contact with each other at an angle greater than or equal to 60° and less than or equal to 120°.

Next, the positive electrode active material slurry coating layer 23A is dried to remove the dispersion medium, so that the positive electrode active material layer 23 is obtained. Since the base 60 is a flexible film, the base 60 can be removed easily as shown by the arrow in FIG. 6E.

In the above-described manner, the positive electrode 20 can be formed.

A binder and a conductive material that can be used for forming the positive electrode 20 are described below.

### [Binder]

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, poly(vinylidene fluoride) (PVDF), polyacrylonitrile (PAN), ethylene-propylene-diene polymer, polyvinyl acetate, or nitrocellulose is preferably used.

At least two of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. An example of a water-soluble polymer having a significant viscosity modifying effect is the above-mentioned polysaccharide; for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as the binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is preferred that the passivation film can conduct lithium ions while suppressing electrical conduction.

### [Conductive Material]

A conductive material is also referred to as a conductivity-imparting agent and a conductive additive, and a carbon material is used as the conductive material. A conductive material is attached between a plurality of active materials, whereby the plurality of active materials are electrically connected to each other, and the conductivity increases. Note that the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

An active material layer such as a positive electrode active material layer or a negative electrode active material layer preferably contains a conductive material.

As the conductive material, for example, one or more of carbon black such as acetylene black or furnace black, graphite such as artificial graphite or natural graphite, carbon fibers such as a carbon nanofiber and a carbon nanotube, and a graphene compound can be used.

Examples of the carbon fiber include a mesophase pitch-based carbon fiber and an isotropic pitch-based carbon fiber. As the carbon fiber, a carbon nanofiber, a carbon nanotube, or the like can be used. Carbon nanotube can be formed by, for example, a vapor deposition method.

The content of the conductive material to the total amount of the active material layer is preferably greater than or equal to 1 wt % and less than or equal to 10 wt %, further preferably greater than or equal to 1 wt % and less than or equal to 5 wt %.

Unlike a particulate conductive material such as carbon black, which makes point contact with an active material, the graphene compound is capable of making low-resistance surface contact; accordingly, the electrical conduction between the particulate active material and the graphene compound can be improved with a smaller amount of the graphene compound than that of a normal conductive material. This can increase the proportion of the active material in the active material layer. Accordingly, the discharge capacity of a battery can be increased.

A compound containing particulate carbon such as carbon black or graphite or a compound containing fibrous carbon such as a carbon nanotube easily enters a microscopic space. A microscopic space refers to, for example, a region between a plurality of active materials. When a carbon-containing compound that easily enters a microscopic space and a compound containing sheet-like carbon, such as graphene, that can impart conductivity to a plurality of particles are used in combination, the density of the electrode increases and an excellent conductive path can be formed. The battery obtained by the fabrication method of one embodiment of the present invention can have high capacitive density per volume and stability, and is effective as an in-vehicle battery.

### [Negative Electrode]

The negative electrode included in the battery of one embodiment of the present invention may be formed using a metal sheet or may be formed using a non-metallic sheet like the positive electrode 20 described above. When anon-metallic sheet is used in the negative electrode, the battery can be reduced in weight.

### [Formation Method of Negative Electrode]

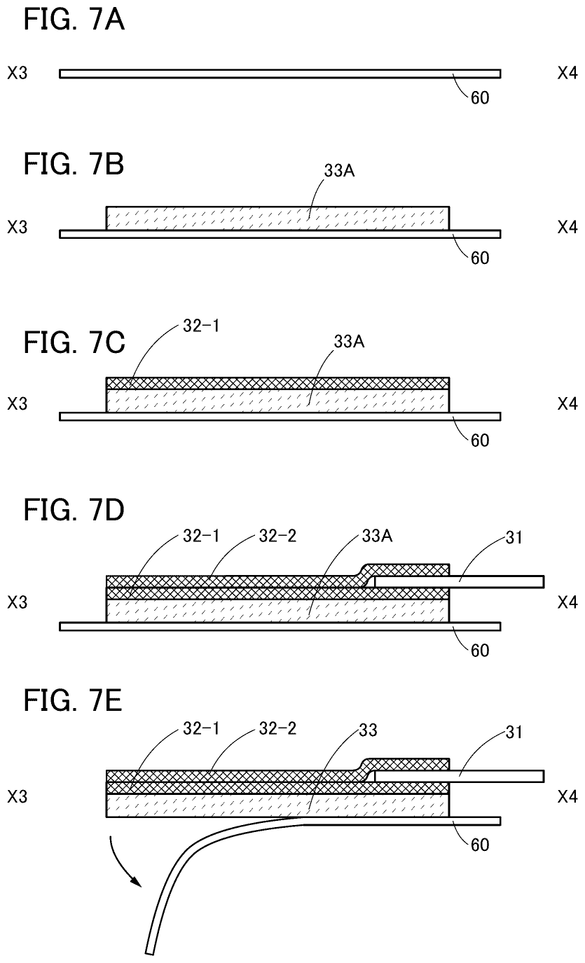

In FIGS. 7A to 7E, a formation method of a negative electrode in which a non-metallic sheet is used for a negative electrode current collector is described.

First, the base 60 is prepared as illustrated in FIG. 7A. A flexible resin film can be used as the base 60. As the resin film, for example, nylon (poly amide), polyimide, vinylon (polyvinyl alcohol-based fiber), polyester, acrylic, polyolefin, or polyurethane processed into a sheet can be used.

Next, as illustrated in FIG. 7B, a negative electrode active material slurry is applied to the base 60 to form a negative electrode active material slurry coating layer 33A.

As the negative electrode active material slurry, a mixture of a negative electrode active material, a binder, and a dispersion medium is preferably used. Here, in the case where the conductivity of the negative electrode active material is low, a conductive material may be further added. Note that the binder, the dispersion medium, and the conductive material described above can be used. For example, polyvinylidene fluoride and acetylene black can be used for the binder and the conductive material, respectively. When a polypropylene film is used for the base 60, NMP is preferably used for the dispersion medium.

Next, as illustrated in FIG. 7C, the negative electrode current collector 32-1 is provided over the negative electrode active material slurry coating layer 33A. At this time, the negative electrode active material slurry coating layer 33A contains a dispersion medium and a binder. When the negative electrode active material slurry coating layer 33A and the negative electrode current collector 32-1 are in contact with each other, the dispersion medium and the binder contained in the negative electrode active material slurry coating layer 33A soak into the negative electrode current collector 32-1, and the negative electrode active material slurry coating layer 33A and the negative electrode current collector 32-1 integrated with each other.

Next, as illustrated in FIG. 7D, the negative electrode lead 31 is provided to partly overlap with the negative electrode current collector 32-1, and then the negative electrode current collector 32-2 is provided. At this time, the dispersion medium and the binder contained in the negative electrode active material slurry coating layer 33A soak into the negative electrode current collector 32-2, and the negative electrode active material slurry coating layer 33A, the negative electrode current collector 32-1, the negative electrode lead 31, and the negative electrode current collector 32-2 are integrated with each other.

In the case where a uniaxially aligned carbon sheet is used as each of the negative electrode current collector 32-1 and the negative electrode current collector 32-2, the uniaxially aligned carbon sheets are preferably provided so that the alignment direction of carbon of the negative electrode current collector 32-1 and the alignment direction of carbon of the negative electrode current collector 32-2 are substantially orthogonal to each other. Such a structure can increase the electron conductivity of the whole negative electrode 30.

Next, the negative electrode active material slurry coating layer 33A is dried to remove the dispersion medium, so that the negative electrode active material layer 33 is obtained. Since the base 60 is a flexible film, the base 60 can be removed easily as shown by the arrow in FIG. 7E.

In the above-described manner, the negative electrode 30 can be formed.

In a negative electrode having a structure different from that of the negative electrode 30 described in FIGS. 7A to 7E, metal foil such as copper foil can be used for a current collector, for example. In this case, the negative electrode can be formed by applying a slurry onto the metal foil and drying the slurry. Note that pressing may be performed after drying. The negative electrode lead may be fixed with part of the current collector by welding.

### [Negative Electrode Active Material]

As the negative electrode active material, for example, a carbon material or an alloy-based material can be used.

As the carbon material, for example, graphite (natural graphite or artificial graphite), graphitizing carbon (soft carbon), non-graphitizing carbon (hard carbon), a carbon fiber (carbon nanotube), graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into the graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of a lithium metal.

Non-graphitizing carbon can be obtained by baking a synthetic resin such as a phenol resin, and an organic substance of plant origin, for example. In non-graphitizing carbon contained in the negative electrode active material of the lithium-ion battery of one embodiment of the present invention, the interplanar spacing of a (002) plane, which is measured by X-ray diffraction (XRD), is preferably greater than or equal to 0.34 nm and less than or equal to 0.50 nm, further preferably greater than or equal to 0.35 nm and less than or equal to 0.42 nm.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sns, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying reaction and a dealloying reaction with lithium, a compound containing the element, and the like may be referred to as an alloy-based material.

In this specification and the like, SiO refers, for example, to silicon monoxide. Note that SiO can alternatively be expressed as SiOₓ. Here, it is preferable that x be 1 or have an approximate value of 1. For example, x is preferably greater than or equal to 0.2 and less than or equal to 1.5, further preferably greater than or equal to 0.3 and less than or equal to 1.2.

As the negative electrode active material, an oxide such as titanium dioxide (TiO₂), lithium titanium oxide (Li₄TisO₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a nitride containing lithium and a transition metal, can be used. For example, Li_{2.6}Co_{0.4}N₃ is preferable because of its high discharge capacity (900 mAh/g and 1890 mAh/cm³).

A nitride containing lithium and a transition metal is preferably used, in which case lithium ions are contained in the negative electrode active material and thus the negative electrode active material can be used in combination with a material for the positive electrode active material that does not contain lithium ions, such as V₂O₅ or Cr₃O₈. Note that in the case of using a material containing lithium ions as the positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used for the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Note that one kind or a combination of various kinds of the negative electrode active materials described above can be used. For example, a combination of a carbon material and silicon or a combination of a carbon material and silicon monoxide can be used.

As another mode of the negative electrode, a negative electrode that does not contain a negative electrode active material after completion of the fabrication of the battery may be used. As the negative electrode that does not contain a negative electrode active material, for example, a negative electrode can be used in which only a negative electrode current collector is included after completion of the fabrication of the battery and in which lithium ions extracted from the positive electrode active material due to charge of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

When the negative electrode that does not contain a negative electrode active material is used, a film may be included over a negative electrode current collector for uniforming lithium deposition. For the film for uniforming lithium deposition, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over a negative electrode current collector relatively easily, and thus is preferable as the film for uniforming lithium deposition. Moreover, as the film for uniforming lithium deposition, for example, a metal film that forms an alloy with lithium can be used. As the metal film that forms an alloy with lithium, for example, a magnesium metal film can be used. Lithium and magnesium form a solid solution in a wide range of compositions, and thus is suitable for the film for uniforming lithium deposition.

### [Electrolyte]

As one mode of an electrolyte, an electrolyte solution containing a solvent and an electrolyte dissolved in the solvent can be used. The electrolyte solution contains the solvent and a lithium salt. As the solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used, or two or more of these solvents can be used in an appropriate combination at an appropriate ratio.

As an organic solvent containing ethylene carbonate (EC) and diethyl carbonate (DEC) in the electrolyte solution, it is possible to use a mixed organic solvent in which the volume ratio between EC and DEC is x:100−x (where 20≤x≤40) on the assumption that EC and DEC account for 100 vol %. More specifically, a mixed organic solvent containing EC and DEC at EC:DEC=30:70 in a volume ratio can be used.

As an organic solvent containing ethylene carbonate (EC), ethyl methyl carbonate (EMC), and dimethyl carbonate (DMC) in the electrolyte solution, it is possible to use a mixed organic solvent in which the volume ratio between EC, EMC, and DMC is x:y:100−x−y (where 5≤x≤35 and 0<y<65) on the assumption that EC, EMC, and DMC account for 100 vol %. More specifically, a mixed organic solvent containing EC, EMC, and DMC at EC:EMC:DMC=30:35:35 in a volume ratio can be used.

As the organic solvent contained in the electrolyte solution, a mixed organic solvent containing a fluorinated cyclic carbonate or a fluorinated linear carbonate can be used. The above mixed organic solvent preferably contains both a fluorinated cyclic carbonate and a fluorinated linear carbonate. A fluorinated cyclic carbonate and a fluorinated linear carbonate are preferred because they each include a substituent with an electron-withdrawing property and thereby lower the solvation energy of a lithium ion. Accordingly, a fluorinated cyclic carbonate and a fluorinated linear carbonate are suitable for the electrolyte solution and a mixed organic solvent containing these carbonates are preferable.

As the fluorinated cyclic carbonate, fluoroethylene carbonate (FEC or F1EC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes a substituent with an electron-withdrawing property and is thus presumed to allow the solvation energy of a lithium ion to be low. The substituent with an electron-withdrawing property in FEC is an F group.

An example of the fluorinated linear carbonate is methyl 3,3,3-trifluoropropionate. An abbreviation of methyl 3,3,3-trifluoropropionate is MTFP. The substituent with an electron-withdrawing property in MTFP is a CF₃ group.

FEC, which is a cyclic carbonate, has a high dielectric constant and thus has an effect of promoting dissociation of a lithium salt when used in an organic solvent. Meanwhile, because FEC includes the substituent with an electron-withdrawing property, a lithium ion is desolvated with FEC more easily than with ethylene carbonate (EC). Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC is presumed to have a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a linear carbonate, can have an effect of reducing the viscosity of an electrolyte solution or preventing the viscosity at room temperature (typically, 25° C.) from increasing even at low temperatures (typically, 0° C.). Furthermore, while the solvation energy is lower in MTFP than in methyl propionate (abbreviation: MP), which does not include a substituent with an electron-withdrawing property, MTFP may solvate a lithium ion when used for the electrolyte solution.

FEC and MTFP having the above-described physical properties are preferably mixed such that the volume ratio between FEC and MTFP is x:100−x (where 5≤x≤30, preferably 10≤x≤20) on the assumption that a mixed organic solvent containing FEC and MTFP accounts for 100 vol %. In other words, MTFP and FEC are preferably mixed such that the amount of MTFP is larger than that of FEC in the mixed organic solvent. The negative electrode of one embodiment of the present invention includes a coating layer on a surface of the negative electrode active material. In the case where the coating layer contains titanium metal, a passivating film can be formed on a surface of the titanium metal even when fluorine ions are generated in an electrolyte solution containing FEC or MTFP above. Thus, the negative electrode of one embodiment of the present invention can be suitably combined with an electrolyte solution containing a mixed organic solvent containing FEC and MTFP.

Alternatively, the use of one or more ionic liquids (room temperature molten salts) that are unlikely to burn and volatize as the solvent of the electrolyte solution can prevent the secondary battery from exploding and/or igniting even when the secondary battery internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion. For example, lithium bis(fluorosulfonyl)imide (also referred to as EMI-FSI) can be used.

[Lithium salt] As the lithium salt (also referred to as electrolyte) dissolved in the above-described solvent, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(SO₂F)₂ (also referred to as LiFSI), LiN(CF₃SO₂)₂, LiN(C₄F₉SO₂)(CF₃SO₂), and LiN(C₂F₅SO₂)₂ can be used, or two or more of these lithium salts can be used in an appropriate combination at an appropriate ratio. The lithium salt is preferably at greater than or equal to 0.5 mol/L and less than or equal to 3.0 mol/L with respect to the solvent. Using a fluoride such as LiPF₆ or LiBF₄ enables a lithium-ion secondary battery to have improved safety.

The above electrolyte solution is preferably highly purified and contains a small number of dust particles or elements other than the constituent elements of the electrolyte solution (hereinafter, also simply referred to as impurities). Specifically, the weight ratio of impurities to the electrolyte solution is less than or equal to 1 wt %, preferably less than or equal to 0.1 wt %, further preferably less than or equal to 0.01 wt %.

### [Additive Agent]

The electrolyte solution may contain an additive agent. An additive agent can inhibit a decomposition reaction of an electrolyte which might occur on a positive electrode surface or a negative electrode surface when a secondary battery operates at a high voltage and/or high temperatures. As the additive agent, for example, vinylene carbonate (VC), propane sultone (PS), tert-butylbenzene (TBB), fluoroethylene carbonate (FEC), or lithium bis(oxalate)borate (LiBOB) is preferably used. LiBOB is particularly preferable because it facilitates formation of a favorable coating film. VC or FEC is preferable because it forms a favorable coating film on a negative electrode at the time of aging the secondary battery or charging the secondary battery at the initial use, which improves the cycle performance.

As the additive agent, one or more kinds of dinitrile compounds can be used. Specific examples of the dinitrile compound include succinonitrile, glutaronitrile, adiponitrile (ADN), and ethylene glycol bis(propionitrile) ether (EGBE).

Furthermore, fluorobenzene may be added to the above organic solvent. The concentration of the additive agent in the whole electrolyte solution is, for example, higher than or equal to 0.1 wt % and lower than or equal to 5 wt %. PS or EGBE is preferable because it forms a favorable coating film on a positive electrode at the time of charging and discharging, which improves the cycle performance. FB is preferable because it improves the wettability of the organic solvent with respect to the positive electrode and the negative electrode. The dinitrile compound is preferable because its nitrile groups are oriented in normal lines of the surface of the positive electrode active material and the surface of the negative electrode active material and oxidative decomposition of the organic solvent is hindered, whereby resistance against a high voltage can be increased. Furthermore, the dinitrile compound is preferable because it can inhibit dissolution of copper used in the current collector of the negative electrode at the time of overdischarging. Considering the usage of the secondary battery at a high voltage, a dinitrile compound is preferably added.

### [Gel Electrolyte]

A polymer gel obtained by swelling a polymer with an electrolyte solution may be used as a gel electrolyte. When a polymer gel electrolyte is used, a semisolid electrolyte layer can be obtained, so that safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### [Solid Electrolyte]

Instead of the electrolyte solution, a solid electrolyte containing an inorganic material such as a sulfide-based or oxide-based inorganic material, a solid electrolyte containing a polymer material such as a polyethylene oxide (PEO)-based polymer material, or the like may alternatively be used. When the solid electrolyte is used, a separator and/or a spacer is/are not necessary. Furthermore, the battery can be entirely solidified; therefore, there is no possibility of liquid leakage and thus the safety of the battery is dramatically improved.

### [Separator]

Next, the separator 40 illustrated in FIG. 1B is described. When the electrolyte includes an electrolyte solution, the separator is positioned between the positive electrode and the negative electrode. The separator can be formed using, for example, a fiber containing cellulose, such as paper; nonwoven fabric; glass fiber; ceramics; or synthetic fiber containing nylon (polyamide), polyimide, vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a poly amide-based material, a mixture thereof, or the like. Examples of the ceramic-based material include aluminum oxide particles (e.g., alumina or boehmite) and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator in high-voltage charging can be suppressed and thus the reliability of the battery can be improved. When the separator is coated with the fluorine-based material, the separator is easily brought into close contact with the electrode, resulting in high output characteristics. When the separator is coated with the polyamide-based material, in particular, aramid, heat resistance is improved; thus, the safety of the battery is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the battery can be increased because the safety of the battery can be maintained even when the total thickness of the separator is small.

### [Exterior Body]

Next, the exterior body 50 illustrated in FIG. TA and the like is described. For the exterior body included in the battery, a metal material such as aluminum, stainless steel, or titanium or a resin material can be used, for example. A film-like exterior body can also be used. As the film, for example, it is possible to use a film having a three-layer structure in which a highly flexible metal thin film or metal foil of aluminum, stainless steel, titanium, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. Such a layered film can be referred to as a laminate film. At this time, the laminate film can be referred to as an aluminum laminate film, a stainless steel laminate film, a titanium laminate film, a copper laminate film, a nickel laminate film, or the like using the material name of the metal layer in the laminate film.

The material or thickness of the metal layer in the laminate film sometimes affect flexibility of the battery. As an exterior body used for a highly flexible (bendable) battery, for example, an aluminum laminate film including a polypropylene layer, an aluminum layer, and nylon is preferably used. Here, the thickness of the aluminum layer is preferably smaller than or equal to 50 μm, further preferably smaller than or equal to m, still further preferably smaller than or equal to 30 μm, yet further preferably smaller than or equal to 20 μm. Note that in the case where the thickness of the aluminum layer is smaller than 10 μm, a gas barrier property might be lowered by pinholes of the aluminum layer; thus, the thickness of the aluminum layer is preferably larger than or equal to 10 μm.

A graphene sheet may be substituted for the above metal layer of the laminate film. As the graphene sheet, a multilayer graphene sheet with a thickness larger than or equal to 100 nm and smaller than or equal to 30 μm, preferably larger than or equal to 200 nm and smaller than or equal to 20 μm can be used. The graphene sheet is flexible and has a gas barrier property with the interlayer distance of graphene of 0.34 nm and thus is suitable as a film used for the exterior body of the secondary battery.

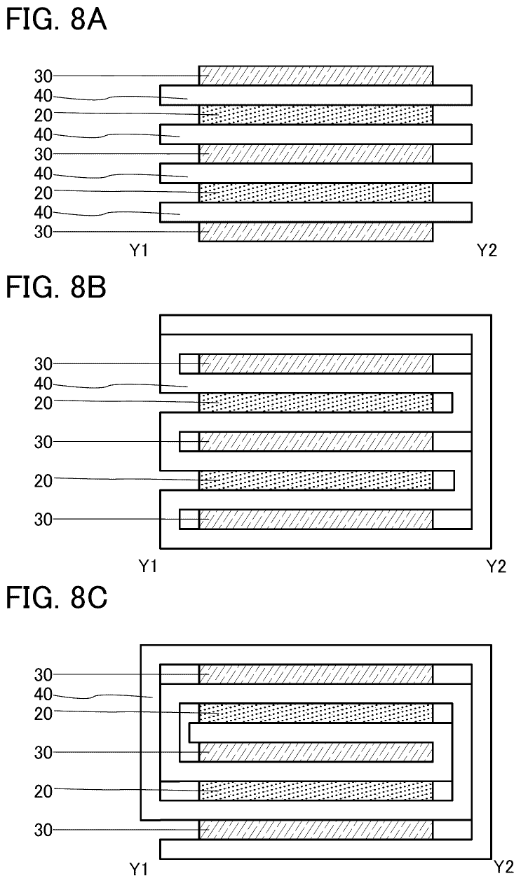

FIGS. 8A to 8C are schematic cross-sectional views illustrating examples of a stack including the positive electrode 20, the negative electrode 30, and the separator 40. FIGS. 8A to 8C are schematic cross-sectional views of the battery 10 along Y1-Y2 in FIG. 1A, and the exterior body 50 is not illustrated. In the positive electrode 20 and the negative electrode 30, a current collector and an active material layer are omitted in order to avoid the complexity of the drawing.

As illustrated in FIGS. 8A to 8C, the separator 40 includes a region positioned between the positive electrode 20 and the negative electrode 30. In other words, the positive electrode 20 and the negative electrode 30 include a region where they overlap with each other with the separator 40 therebetween. Note that the separator 40 may include a region positioned between the positive electrode 20 and the exterior body 50 and may include a region positioned between the negative electrode 30 and the exterior body 50.

Like the stack illustrated in FIG. 8A, a stack including a plurality of the positive electrodes 20, a plurality of the negative electrodes 30, and a plurality of the separators 40 can be used.

Like the stacks illustrated in FIGS. 8B and 8C, a stack including the plurality of the positive electrodes 20, the plurality of the negative electrodes 30, and one separator 40 can be used.

As in the stack illustrated in FIG. 8B, the separator 40 having a winding shape can be positioned between the plurality of the positive electrodes 20 and the plurality of the negative electrodes 30.

As in the stack illustrated in FIG. 8C, the separator 40 having a wound shape can be positioned between the plurality of the positive electrodes 20 and the plurality of the negative electrodes 30.

This embodiment can be implemented in appropriate combination with any of the other embodiments.

### Embodiment 2

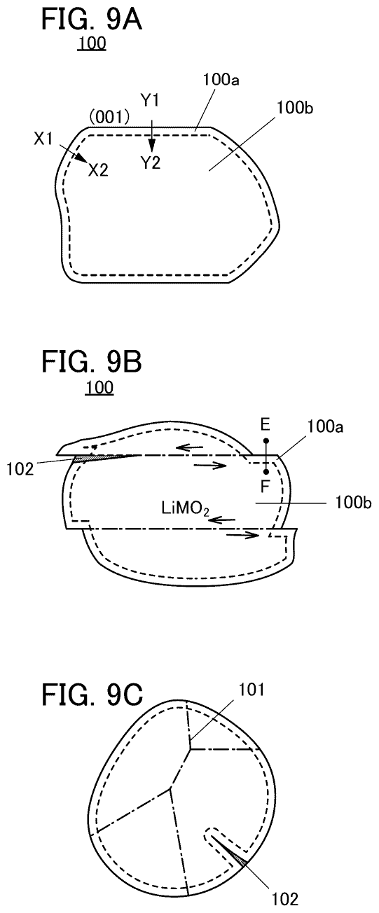

In this embodiment, a positive electrode active material that can be used for a positive electrode of the battery of one embodiment of the present invention is described with reference to FIGS. 9A to 9C, FIGS. 10A to 10C, FIGS. 11A and 11B, FIG. 12, FIG. 13, FIG. 14, FIGS. 15A to 15C, FIG. 16, FIG. 17, FIG. 18, FIG. 19, FIG. 20, FIGS. 21A and 21B, FIGS. 22A to 22C, FIGS. 23A to 23C, and FIGS. 24A and 24B.

FIGS. 9A to 9C are cross-sectional views of the positive electrode active material 100 of one embodiment of the present invention. As illustrated in FIG. 9A, the positive electrode active material 100 includes a surface portion 100a and an inner portion 100b. In each drawing, the dashed line denotes a boundary between the surface portion 100a and the inner portion 100b. FIG. 9B illustrates the positive electrode active material 100 including a filling portion 102. (001) in FIG. 9B indicates the (001) plane of lithium cobalt oxide. LiCoO₂ belongs to the space group R-3m. In FIG. 9C, the dashed-dotted line denotes part of a crystal grain boundary 101. Note that the surface portion 100a can be referred to as a barrier film, and lithium cobalt oxide including the surface portion 100a is sometimes referred to as lithium cobalt oxide including a barrier film.

In this specification and the like, the surface portion 100a of the positive electrode active material 100 refers to a region that is 50 nm, preferably 35 nm, further preferably 20 nm in depth from the surface toward the inner portion, and most preferably 10 nm in depth in a perpendicular direction or a substantially perpendicular direction from the surface toward the inner portion. Note that “substantially perpendicular” refers to a state where an angle is greater than or equal to 80° and less than or equal to 100°. A plane generated by a crack can be considered as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

The surface of the positive electrode active material 100 refers to a surface of a composite oxide that includes the surface portion 100a and the inner portion 100b. Thus, the positive electrode active material 100 does not contain a material to which a metal oxide that does not contain a lithium site contributing to charging and discharging, such as aluminum oxide (Al₂O₃), is attached, or a carbonate, a hydroxy group, or the like which is chemically adsorbed after formation of the positive electrode active material 100. The attached metal oxide refers to, for example, a metal oxide having a crystal structure different from that of the inner portion 100b.

Furthermore, an electrolyte, an organic solvent, a binder, a conductive material, and a compound originating from any of these that are attached to the positive electrode active material 100 are not contained either.

The crystal grain boundary 101 refers to, for example, a portion where particles of the positive electrode active material 100 adhere to each other, or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional transmission electron microscope (TEM) image, a cross-sectional scanning transmission electron microscope (STEM) image, or the like, i.e., a structure including another atom between lattices, a cavity, or the like. The crystal grain boundary 101 can be regarded as a plane defect. The vicinity of the crystal grain boundary 101 refers to a region extending less than or equal to 10 nm from the crystal grain boundary 101.

### <Contained Element>

The positive electrode active material 100 contains lithium, cobalt, oxygen, and an additive element. The positive electrode active material 100 contains lithium cobalt oxide (LiCoO₂) to which an additive element is added. Note that the positive electrode active material 100 of one embodiment of the present invention has a crystal structure described later, and thus the composition of the lithium cobalt oxide is not strictly limited to Li:Co:O=1:1:2.

A positive electrode active material of a lithium-ion secondary battery needs to contain a transition metal which can take part in an oxidation-reduction reaction in order to maintain a neutrally charged state even when lithium ions are inserted and extracted. It is preferable that the positive electrode active material 100 of one embodiment of the present invention mainly contain cobalt as a transition metal taking part in an oxidation-reduction reaction. In addition to cobalt, at least one or both of nickel and manganese may be contained. Using cobalt at greater than or equal to 75 atomic %, preferably greater than or equal to 90 atomic %, further preferably greater than or equal to 95 atomic % as the transition metal contained in the positive electrode active material 100 brings many advantages such as relatively easy synthesis, easy handling, and excellent cycle performance, which is preferable.

When cobalt is used as the transition metal contained in the positive electrode active material 100 at greater than or equal to 75 atomic %, preferably greater than or equal to 90 atomic %, further preferably greater than or equal to 95 atomic %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

As the additive element contained in the positive electrode active material 100, one or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used. The total percentage of the transition metal among the additive elements is preferably less than 25 atomic %, further preferably less than 10 atomic %, still further preferably less than 5 atomic %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

The additive element is preferably dissolved in the positive electrode active material 100. Thus, in STEM-EDX linear analysis, for example, a position where the amount of the detected additive element increases is preferably at a deeper level than a position where the amount of the detected transition metal Mincreases, i.e., on the inner portion side of the positive electrode active material 100.

In this specification and the like, the depth at which the amount of detected element increases in STEM-EDX linear analysis refers to the depth at which a measured value, which can be determined not to be a noise in terms of intensity, spatial resolution, and the like, is successively obtained.

Such an additive element further stabilizes the crystal structure of the positive electrode active material 100 as described later. In this specification and the like, an additive element can be rephrased as part of a raw material or a mixture.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

When the positive electrode active material 100 is substantially free from manganese, for example, advantages such as relatively easy synthesis, easy handling, and excellent cycle performance are enhanced. The weight of manganese contained in the positive electrode active material 100 is preferably less than or equal to 600 ppm, further preferably less than or equal to 100 ppm, for example.

### <Crystal Structure>

<<x in LiₓCoO₂ is 1>>

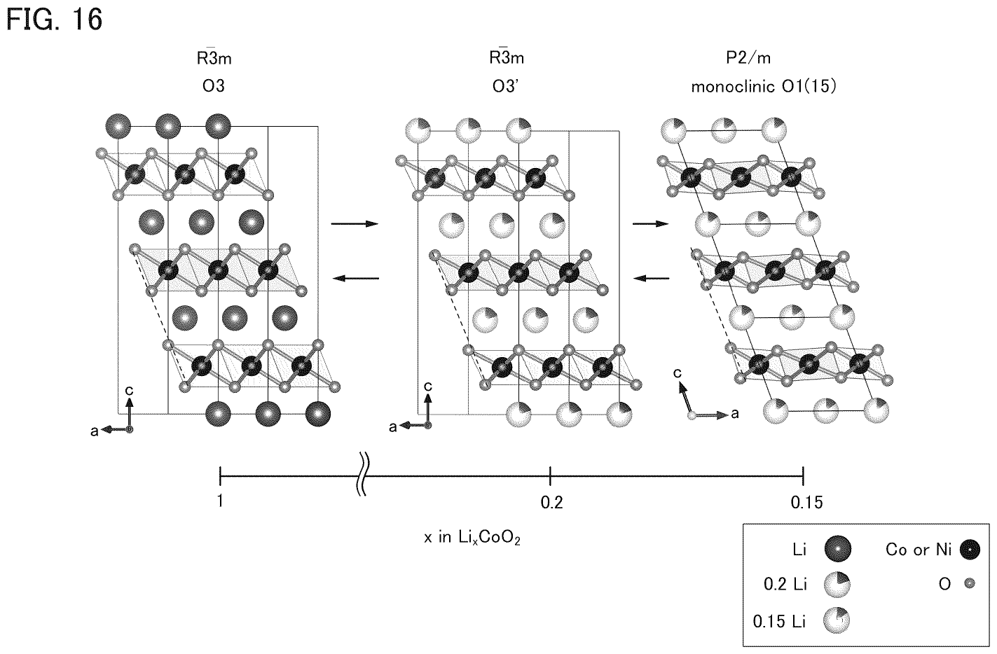

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt crystal structure is favorably used as a positive electrode active material of a secondary battery because it has high discharge capacity and a two-dimensional diffusion path for lithium ions and is thus suitable for an insertion/extraction reaction of lithium ions. For this reason, it is particularly preferable that the inner portion 100b, which accounts for the majority of the volume of the positive electrode active material 100, have a layered rock-salt crystal structure. In FIG. 16, the layered rock-salt crystal structure is denoted by R-3m O3. In the R-3m O3 type structure, the lattice constants are as follows: a=2.81610, b=2.81610, c=14.05360, α=90.0000, β=90.0000, and γ=120.0000; the coordinates of lithium, cobalt, and oxygen in a unit cell are represented by Li (0, 0, 0), Co (0, 0, 0.5), and O (0, 0, 0.23951), respectively (Non-Patent Document 7).

Meanwhile, the surface portion 100a of the positive electrode active material 100 of one embodiment of the present invention preferably has a function of reinforcing the layered structure, which is formed of octahedrons of cobalt and oxygen, of the inner portion 100b so that the layered structure does not break even when lithium is extracted from the positive electrode active material 100 by charging. Alternatively, the surface portion 100a preferably functions as a barrier film of the positive electrode active material 100. Alternatively, the surface portion 100a, which is the outer portion of the positive electrode active material 100, preferably reinforces the positive electrode active material 100. Here, the term “reinforce” means inhibiting extraction of oxygen and/or a structural change of the surface portion 100a and the inner portion 100b of the positive electrode active material 100 such as a shift in the layered structure formed of octahedrons of cobalt and oxygen, and/or inhibiting oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has a rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted first in charging, and tends to have a lower lithium concentration than the inner portion 100b. It can be said that bonds between atoms are partly cut on the surface of the particle of the positive electrode active material 100 included in the surface portion 100a. Therefore, the surface portion 100a is regarded as a region which is likely to be unstable and in which degradation of the crystal structure is likely to begin. For example, it is presumable that a shift in the crystal structure of the layered structure formed of octahedrons of cobalt and oxygen in the surface portion 100a has an influence on the inner portion 100b to cause a shift in the crystal structure of the layered structure in the inner portion 100b, leading to degradation of the crystal structure in the whole positive electrode active material 100. Meanwhile, if the surface portion 100a can have sufficient stability, the layered structure, which is formed of octahedrons of cobalt and oxygen, of the inner portion 100b is difficult to break even when x in LiₓCoO₂ is small, e.g., 0.24 or less. Furthermore, a shift in layers, which are formed of octahedrons of cobalt and oxygen, of the inner portion 100b can be inhibited.

### [Distribution]

To obtain a stable composition and a stable crystal structure of the surface portion 100a, the surface portion 100a preferably contains the additive element, further preferably a plurality of the additive elements. The surface portion 100a preferably has a higher concentration of one or more selected from the additive elements than the inner portion 100b. The one or more selected from the additive elements contained in the positive electrode active material 100 preferably have a concentration gradient. In addition, it is further preferable that the additive elements contained in the positive electrode active material 100 be differently distributed. For example, it is further preferable that peaks of the detected amounts of the additive elements in the surface portion be exhibited at different depths from the surface or the reference point in EDX line analysis described later. The peak of the detected amount here refers to a local maximum value of the detected amount in the surface portion 100a or a region that extends less than or equal to 50 nm from the surface. The detected amount refers to counts in EDX line analysis.

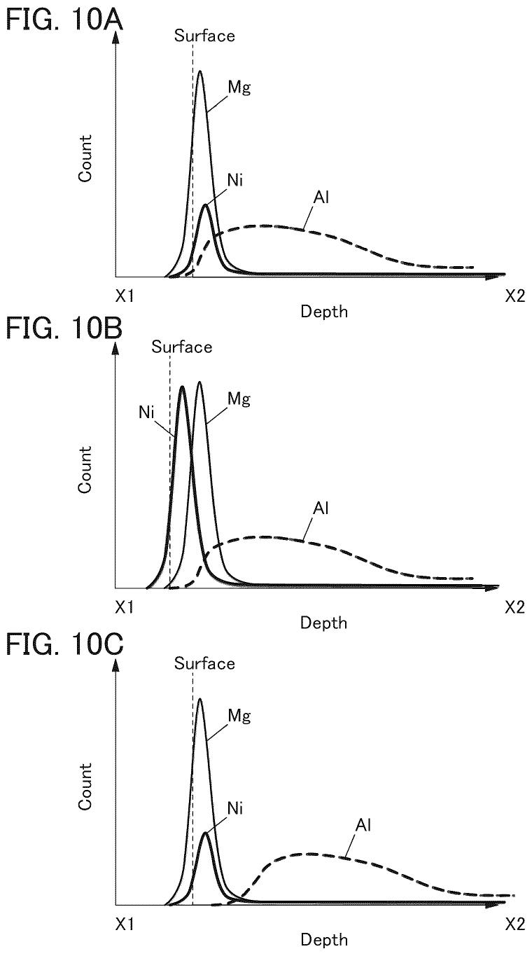

The arrow X1-X2 is shown in FIG. 9A as a depth direction example of a crystal plane, which is not the (001) plane, of lithium cobalt oxide of the positive electrode active material 100 of one embodiment of the present invention. FIGS. 10A to 10C show examples of the intensity distribution of the characteristic X-ray of the additive elements (also referred to as a profile of EDX line analysis) obtained when EDX line analysis is conducted on the portion indicated by the arrow X1-X2.

As shown in FIGS. 10A to 10C, the detected amounts of at least magnesium and nickel among the additive elements are preferably larger in the surface portion 100a than in the inner portion 100b. Peaks of the detected amounts of magnesium and nickel are preferably observed in a narrow region of the surface portion 100a that is closer to the surface. For example, the peaks of the detected amounts of magnesium and nickel are preferably observed in a region that extends less than or equal to 3 nm from the surface or the reference point. The distribution of magnesium and that of nickel preferably overlap with each other. The peak of the detected amount of magnesium and that of the detected amount of nickel are at the same depth, the peak of magnesium may be closer to the surface, or the peak of nickel may be closer to the surface as shown in FIG. 10B. The difference between the depth of the peak of the detected amount of magnesium and that of the peak of the detected amount of nickel is preferably less than or equal to 3 nm, further preferably less than or equal to 1 nm.

In some cases, the detected amount of nickel in the inner portion 100b is much smaller than that of nickel in the surface portion 100a or lower than or equal to the lower detection limit, i.e., no nickel is detected in the inner portion.

Although not shown, as in the case of magnesium or nickel, the detected amount of fluorine is preferably larger in the surface portion 100a than in the inner portion 100b. A peak of the detected amount of fluorine is preferably observed in a region of the surface portion 100a that is closer to the surface. For example, the peak of the detected amount of fluorine is preferably observed in a region that extends less than or equal to 3 nm from the surface or the reference point. Similarly, the detected amount(s) of titanium, silicon, phosphorus, boron, and/or calcium are/is also preferably larger in the surface portion 100a than in the inner portion 100b. A peak(s) of the detected amount(s) of titanium, silicon, phosphorus, boron, and/or calcium are/is preferably observed in a region of the surface portion 100a that is closer to the surface. For example, the peak(s) of the detected amount(s) of titanium, silicon, phosphorus, boron, and/or calcium are/is preferably observed in a region that extends less than or equal to 3 nm from the surface or the reference point.

A peak of the detected amount of at least aluminum among the additive elements is preferably observed in a region that is located inward from a region in which a peak of the detected amount of magnesium is observed. The distribution of magnesium and that of aluminum may overlap with each other as shown in FIG. 10A; alternatively, there may be almost no overlap between the distribution of magnesium and that of aluminum as shown in FIG. 10C. A peak of the detected amount of aluminum may be observed in the surface portion 100a or a region at a larger depth than the surface portion 100a. For example, the peak is preferably observed in a region extending, toward the inner portion, from a depth from the surface or the reference point of 5 nm to a depth from the surface or the reference point of 30 nm.

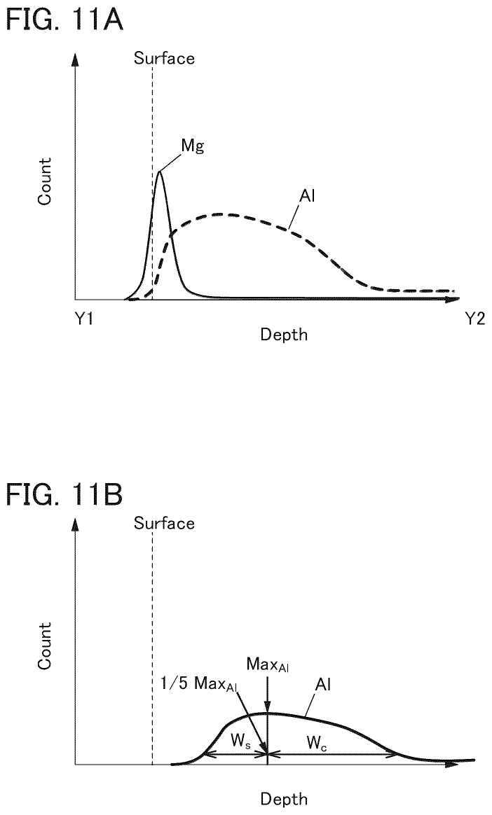

The distribution of aluminum is not normal distribution in some cases. For example, when the curve of the distribution of aluminum is divided by the maximum value Max_{Al}, the length of the tail on the surface side is sometimes different from that of the tail on the inner portion side. More specifically, when the peak width at the height (⅕ Max_{Al}) that is ⅕ of the height of the maximum value (Max_{Al}) of the detected amount of aluminum is divided into two parts by a perpendicular extending from the maximum value to the horizontal axis, the peak width W_{c} on the inner portion side is sometimes larger than the peak width Wₛ on the surface side as shown in FIG. 11B.

Aluminum is distributed more inwardly than magnesium as described above probably because the diffusion rate of aluminum is higher than that of magnesium. The detected amount of aluminum is small in the region that is the closest to the surface, by contrast, presumably because aluminum is less stable in a region where magnesium or the like at a high concentration forms a solid solution than in other regions.

To be specific, in a region having a layered rock-salt crystal structure belonging to the space group R-3m or a cubic rock-salt crystal structure, the distance between a cation and oxygen in a region where magnesium at a high concentration forms a solid solution is longer than the distance between a cation and oxygen in LiAlO₂ having a layered rock-salt crystal structure, and aluminum is thus likely to be unstable. In the vicinity of cobalt, valence change due to substitution of Mg²⁺ for Li⁺ can be compensated for by Co³⁺ becoming Co²⁺, so that cation balance can be maintained. By contrast, Al is always trivalent and is thus presumed to be unlikely to coexist with magnesium in a rock-salt or layered rock-salt crystal structure.

Although not shown, as in the case of aluminum, a peak of the detected amount of manganese among the additive elements is preferably observed in a region that is located inward from a region in which a peak of the detected amount of magnesium is observed.

Note that the additive elements do not necessarily have similar concentration gradients and similar distributions throughout the surface portion 100a of the positive electrode active material 100. The arrow Y1-Y2 is shown in FIG. 9A as a depth direction example of the (001) plane of lithium cobalt oxide of the positive electrode active material 100. FIG. 11A shows an example of the intensity distribution of the characteristic X-ray of the additive elements at the portion indicated by the arrow Y1-Y2.

The distribution of the additive element at the surface having a (001) orientation may be different from that at other surfaces. For example, the detected amount(s) of one or more of the additive elements may be smaller at the surface having the (001) orientation and the surface portion 100a thereof than at a surface having an orientation other than the (001) orientation. Specifically, the detected amount of nickel may be smaller. Alternatively, at the surface having a (001) orientation and the surface portion 100a thereof, the detected amount of one or more of the additive elements may be lower than the lower detection limit. Specifically, the detected amount nickel may be lower than the lower detection limit. Especially in the case of EDX or any other analysis method in which characteristic X-rays are detected, the energy of Kβ for cobalt is close to that of Kα for nickel and it is thus difficult to detect a slight amount of nickel in a material whose main element is cobalt. Alternatively, the peak(s) of the detected amount(s) of one or more of the additive elements at the surface having the (001) orientation and the surface portion 100a thereof may be positioned shallower than the peak(s) of the detected amount(s) of the one or more of the additive elements at the surface having an orientation other than the (001) orientation. Specifically, the peaks of the detected amounts of magnesium and aluminum at the surface having the (001) orientation and the surface portion 100a thereof may be positioned shallower than the peaks of the detected amounts of magnesium and aluminum at the surface having an orientation other than the (001) orientation.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane.

The CoO₂ layer is relatively stable and thus, the surface of the positive electrode active material 100 is more stable when having the (001) orientation. A main diffusion path of lithium ions in charging and discharging is not exposed at the (001) plane.

By contrast, a diffusion path of lithium ions is exposed at a surface having an orientation other than the (001) orientation. Thus, the surface having an orientation other than the (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is important that the intensity distribution of the characteristic X-ray of the additive element at the surface having an orientation other than a (001) orientation and the surface portion 100a thereof is distribution in any one of FIGS. 10A to 10C. In particular, among the additive elements, nickel is preferably detected at the surface having an orientation other than the (001) orientation and the surface portion 100a thereof. By contrast, at the surface having the (001) orientation and the surface portion 100a thereof, the concentration of the additive element may be low as described above or the additive element may be absent.

For example, the half width of the distribution of magnesium at the surface having the (001) orientation and the surface portion 100a thereof is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium at the surface not having the (001) orientation and the surface portion 100a thereof is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel at the surface not having the (001) orientation and the surface portion 100a thereof is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method as described in the following embodiment, in which high-purity LiCoO₂ is formed, the additive element is mixed afterwards, and heating is performed, the additive element spreads mainly via a diffusion path of lithium ions. Thus, distribution of the additive element at the surface having an orientation other than the (001) orientation and the surface portion 100a thereof can easily fall within a preferred range.

### [Magnesium]

Magnesium is divalent, and a magnesium ion is more stable in lithium sites than in cobalt sites in a layered rock-salt crystal structure; thus, magnesium is likely to enter the lithium sites. An appropriate concentration of magnesium at the lithium sites of the surface portion 100a facilitates maintenance of the layered rock-salt crystal structure. This is probably because magnesium at the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high magnesium concentration in the surface portion 100a probably increases the corrosion resistance to hydrofluoric acid generated by the decomposition of the electrolyte solution.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide or a fluoride) which does not enter the lithium site or the cobalt site might be unevenly distributed at the surface of the positive electrode active material or the like to serve as a resistance component of a secondary battery. As the magnesium concentration of the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. The number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms, for example. The amount of magnesium contained in the entire positive electrode active material 100 may be, for example, a value obtained by element analysis on the entire positive electrode active material 100 with glow discharge mass spectrometry (GD-MS), inductively coupled plasma mass spectrometry (ICP-MS), or the like or may be a value based on the ratio of the raw materials mixed in the process of forming the positive electrode active material 100.

### [Nickel]

Nickel in a layered rock-salt crystal structure of LiMeO₂ can exist at a cobalt site and/or a lithium site. Since nickel has a lower oxidation-reduction potential than cobalt, the presence of nickel at a cobalt site facilitates release of lithium and electrons during charging, for example. As a result, the charge and discharge speed is expected to be increased. Accordingly, at the same charging voltage, the charge and discharge capacity in the case of the transition metal M being nickel is higher than that in the case of the transition metal M being cobalt.

In addition, when nickel exists at a lithium site, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel at the lithium sites also serves as a column supporting the CoO₂ layers. Therefore, in particular, the crystal structure is expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO having a rock-salt crystal structure and CoO having a rock-salt crystal structure, and the orientations of NiO and LiCoO₂ are likely to be aligned with each other.

Ionization tendency is the highest in nickel and lower in the order of cobalt, aluminum, and magnesium. Therefore, it is considered that in charging, nickel is less likely to be dissolved into an electrolyte solution than the other elements described above. Accordingly, nickel is considered to have a high effect of stabilizing the crystal structure of the surface portion in a charged state.

Furthermore, in nickel, Ni²⁺ is more stable than Ni³⁺ and Ni⁴⁺, and nickel has higher trivalent ionization energy than cobalt. Thus, it is known that a spinel crystal structure does not appear only with nickel and oxygen. Therefore, nickel is considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, the number of nickel atoms is preferably greater than 0% and less than or equal to 4%, greater than 0% and less than or equal to 2%, greater than or equal to 0.05% and less than or equal to 7.5%, greater than or equal to 0.05% and less than or equal to 2%, greater than or equal to 0.1% and less than or equal to 7.5%, or greater than or equal to 0.1% and less than or equal to 4% of the number of cobalt atoms. The amount of nickel described here may be a value obtained by element analysis on the entire positive electrode active material with GD-MS, ICP-MS, or the like or may be a value based on the ratio of the raw materials mixed in the process of forming the positive electrode active material, for example.

### [Aluminum]

Aluminum can exist at a cobalt site in a layered rock-salt crystal structure. Since aluminum is a trivalent representative element and its valence does not change, lithium around aluminum is less likely to move even in charging and discharging. Thus, aluminum and lithium around aluminum serve as columns to inhibit a change in the crystal structure. This would inhibit degradation of the positive electrode active material 100 if force of expansion and contraction of the positive electrode active material 100 in the c-axis direction operates owing to insertion and extraction of lithium ions, i.e., owing to a change in charge depth or charge rate, as described later.

Furthermore, aluminum has an effect of inhibiting dissolution of cobalt around aluminum and improving continuous charging tolerance. Moreover, an Al—O bond is stronger than a Co—O bond and thus extraction of oxygen around aluminum can be inhibited. These effects improve thermal stability. Therefore, a secondary battery that includes the positive electrode active material 100 containing aluminum as the additive element can have higher stability. In addition, the positive electrode active material 100 having a crystal structure that is unlikely to be broken by repeated charging and discharging can be provided.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, the number of aluminum atoms is preferably greater than or equal to 0.05% and less than or equal to 2% or greater than or equal to 0.1% and less than or equal to 4% of the number of cobalt atoms. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

### [Fluorine]

When fluorine, which is a monovalent anion, is substituted for part of oxygen in the surface portion 100a, the lithium extraction energy is lowered. This is because the oxidation-reduction potential of cobalt ions associated with lithium extraction differs depending on whether fluorine exists. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs in these cases. It can thus be said that when fluorine is substituted for part of oxygen in the surface portion 100a of the positive electrode active material 100, lithium ions near fluorine are likely to be extracted and inserted smoothly. Thus, a secondary battery including such a positive electrode active material 100 can have improved charge and discharge characteristics, improved large current characteristics, or the like. When fluorine exists at the surface portion 100a including the surface that is in contact with an electrolyte solution, or when a fluoride is adsorbed onto or attached to the surface, an overreaction between the positive electrode active material 100 and the electrolyte solution can be inhibited. In addition, the corrosion resistance to hydrofluoric acid can be effectively increased.

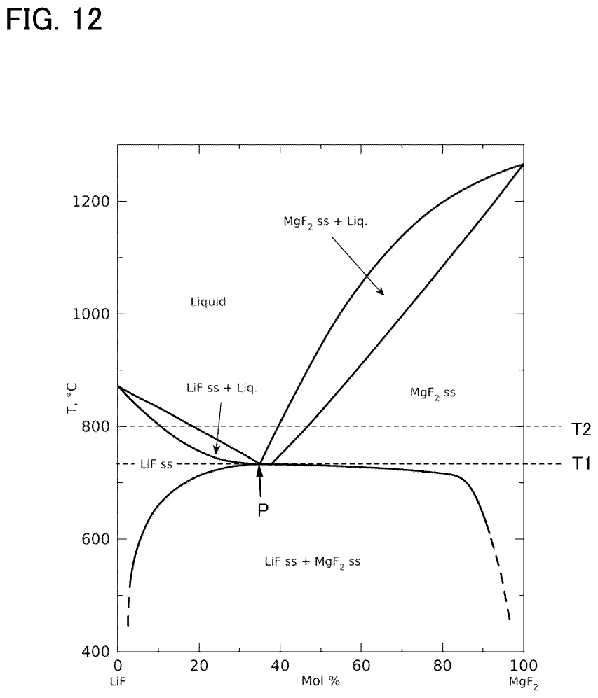

A fluoride such as lithium fluoride that has a lower melting point than a different additive element source can serve as a fusing agent (also referred to as a flux) for lowering the melting point of the different additive element source. The eutectic point P of LiF and MgF₂ is around 742° C. (T1) as shown in FIG. 12 obtained by retouching a diagram cited from Non-Patent Document 13 (FIG. 5). Thus, in the case of using mixed fluoride that contains LiF and MgF₂ as fluoride as an additive element source, the heating temperature in the heating step following the mixing of the additive element is preferably set higher than or equal to 742° C.

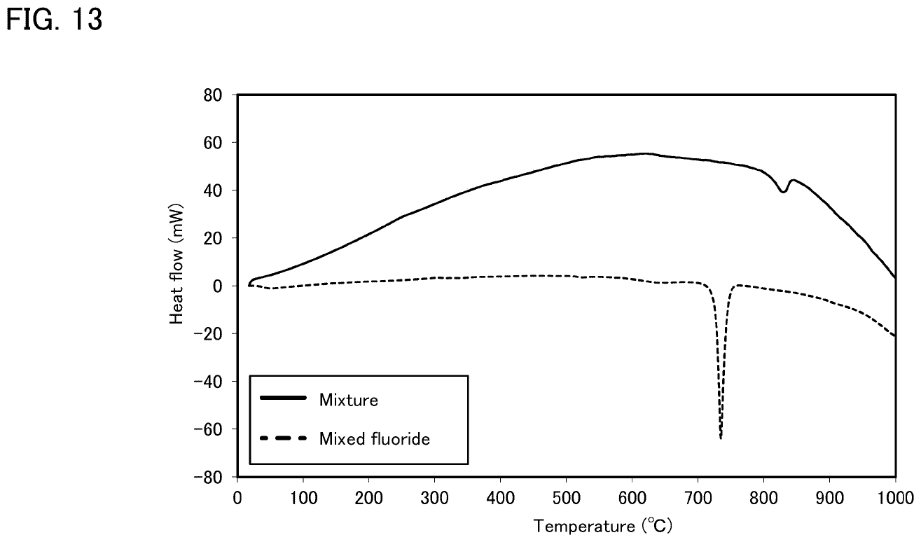

Here, differential scanning calorimetry measurement (DSC measurement) of mixed fluoride and a mixture is described with reference to FIG. 13. In FIG. 13, the curve denoted by mixed fluoride is a DSC measurement result of a mixture of LiF and MgF₂. LiF and MgF₂ are mixed in a molar ratio of LiF:MgF₂=1:3 to form the mixed fluoride. In FIG. 13, the curve denoted by mixture is a DSC measurement result of a mixture of lithium cobalt oxide, LiF, and MgF₂. Lithium cobalt oxide, LiF, and MgF₂ are mixed in a molar ratio of LiCoO₂:LiF:MgF₂=100:0.33:1 to form the mixture.

As shown in FIG. 13, the endothermic peak of the mixed fluoride is observed at around 735° C. The endothermic peak of the mixture is observed at around 830° C. Thus, the temperature of the heating following the mixing of the additive element is preferably higher than or equal to 742° C., further preferably higher than or equal to 830° C. Alternatively, the temperature of the heating may be higher than or equal to 800° C. (T2 in FIG. 12), which is between the above temperatures.

### [Other Additive Elements]

An oxide of titanium is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

The surface portion 100a preferably contains phosphorus, in which case a short circuit can be sometimes inhibited while a state with small x in LiₓCoO₂ is maintained. For example, a compound containing phosphorus and oxygen preferably exists in the surface portion 100a.

When the positive electrode active material 100 contains phosphorus, phosphorus may react with hydrogen fluoride generated by the decomposition of the electrolyte solution or the electrolyte, which might decrease the hydrogen fluoride concentration in the electrolyte and is preferable.

In the case where the electrolyte contains LiPF₆, hydrogen fluoride might be generated by hydrolysis. In addition, hydrogen fluoride might be generated by the reaction of poly(vinylidene fluoride) (PVDF) used as a component of the positive electrode and alkali. The decrease in hydrogen fluoride concentration in the electrolyte may inhibit corrosion of a current collector and/or separation of a coating portion 104 or may inhibit a reduction in adhesion properties due to gelling and/or insolubilization of PVDF.

The positive electrode active material 100 preferably contains magnesium and phosphorus, in which case the crystal structure is extremely stable in a state with small x in LiₓCoO₂. When the positive electrode active material 100 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, the number of phosphorus atoms is preferably greater than or equal to 1% and less than or equal to 10%, greater than or equal to 1% and less than or equal to 8%, greater than or equal to 2% and less than or equal to 20%, greater than or equal to 2% and less than or equal to 8%, greater than or equal to 3% and less than or equal to 20%, or greater than or equal to 3% and less than or equal to 10% of the number of cobalt atoms. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, the number of magnesium atoms is preferably greater than or equal to 0.1% and less than or equal to 5%, greater than or equal to 0.1% and less than or equal to 4%, greater than or equal to 0.5% and less than or equal to 10%, greater than or equal to 0.5% and less than or equal to 4%, greater than or equal to 0.7% and less than or equal to 10%, or greater than or equal to 0.7% and less than or equal to 5% of the number of cobalt atoms. The phosphorus concentration and the magnesium concentration described here may each be a value obtained by element analysis on the entire positive electrode active material 100 using GD-MS, ICP-MS, or the like, or may be a value based on the ratio of the raw materials mixed in the process of forming the positive electrode active material 100, for example.

In the case where a crack is formed at part of surface of the positive electrode active material 100, crack development is sometimes inhibited by phosphorus, more specifically, a compound containing phosphorus and oxygen or the like that exists in the filling portion 102 of the positive electrode active material including the surface.

### [Synergistic Effect Between a Plurality of Additive Elements]

When the surface portion 100a contains both magnesium and nickel, divalent nickel might be able to exist more stably in the vicinity of divalent magnesium. Thus, even when x in LiₓCoO₂ is small, dissolution of magnesium might be inhibited, which might contribute to stabilization of the surface portion 100a.

For a similar reason, when the additive element is added to lithium cobalt oxide in the formation process, magnesium is preferably added in a step before a step where nickel is added. Alternatively, magnesium and nickel are preferably added in the same step. The reason is as follows: magnesium has a large ion radius and thus is likely to remain in the surface portion of lithium cobalt oxide regardless of in which step magnesium is added, but nickel may be widely diffused to the inner portion of lithium cobalt oxide when magnesium does not exist. Thus, when nickel is added before magnesium is added, nickel might be diffused to the inner portion of lithium cobalt oxide and a preferable amount of nickel might not remain in the surface portion.

Additive elements that are differently distributed are preferably contained at a time, in which case the crystal structure of a wider region can be stabilized. For example, the stable crystal structure can be obtained in a wider region in the case where the positive electrode active material 100 contains all of magnesium, nickel, and aluminum distributed in the surface portion 100a (specifically, the magnesium and nickel are distributed in a region closer to the surface, and aluminum is distributed in a region deeper than magnesium and nickel), than in the case where magnesium and nickel are contained and the case where aluminum is contained. In the case where the positive electrode active material 100 contains the additive elements that are differently distributed as described above, the surface can be sufficiently stabilized by magnesium, nickel, or the like; thus, aluminum is not necessary for the surface. It is preferable that aluminum be widely distributed in a deeper region. For example, it is preferable that aluminum be continuously detected in a region extending from a depth from the surface of 1 nm to a depth from the surface of 25 nm. Aluminum is preferably widely distributed in a region extending from a depth from the surface of 0 nm to a depth from the surface of 100 nm, further preferably a region extending from a depth from the surface of 0.5 nm to a depth from the surface of 50 nm, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, and also contain lithium in a discharged state to have the path through which lithium is inserted and extracted.

To ensure the sufficient path through which lithium is inserted and extracted, the concentration of cobalt is preferably higher than that of magnesium in the surface portion 100a. For example, when measurement by X-ray photoelectron spectroscopy (XPS) is performed from the surface of the positive electrode active material 100, the ratio of the number of magnesium (Mg) atoms to the number of cobalt (Co) atoms (Mg/Co) is preferably less than or equal to 0.62. In addition, the concentration of cobalt is preferably higher than those of nickel, aluminum, and fluorine in the surface portion 100a.

Moreover, excess nickel might hinder diffusion of lithium; thus, the concentration of magnesium is preferably higher than that of nickel in the surface portion 100a. For example, when measurement by XPS is performed from the surface of the positive electrode active material 100, the number of nickel atoms is preferably ⅙ or less of that of magnesium atoms.

It is preferable that some additive elements, in particular, magnesium, nickel, and aluminum have higher concentrations in the surface portion 100a than in the inner portion 100b and exist randomly also in the inner portion 100b to have low concentrations. When magnesium and aluminum exist at the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting dissolution of magnesium can be expected in a manner similar to the above.

It is preferable that the crystal structure continuously change from the inner portion 100b toward the surface owing to the above-described concentration gradient of the additive element. Alternatively, it is preferable that the orientations of a crystal in the surface portion 100a and a crystal in the inner portion 100b be substantially aligned with each other.

For example, a crystal structure preferably changes continuously from the inner portion 100b that has a layered rock-salt crystal structure toward the surface and the surface portion 100a that have a feature of a rock-salt crystal structure or features of both a rock-salt crystal structure and a layered rock-salt crystal structure. Alternatively, the orientations of a crystal in the surface portion 100a that has the feature of a rock-salt crystal structure or the features of both a rock-salt crystal structure and a layered rock-salt crystal structure and a crystal in the layered rock-salt inner portion 100b are preferably substantially aligned with each other.

Note that in this specification and the like, a layered rock-salt crystal structure, which belongs to the space group R-3m, of a composite oxide containing lithium and a transition metal such as cobalt refers to a crystal structure in which a rock-salt ion arrangement where cations and anions are alternately arranged is included and lithium and the transition metal are regularly arranged to form a two-dimensional plane, so that lithium can diffuse two-dimensionally. Note that a defect such as a cation or anion vacancy may exist. In the layered rock-salt crystal structure, strictly, a lattice of a rock-salt crystal is distorted in some cases.

A rock-salt crystal structure refers to a structure in which a cubic crystal structure such as a crystal structure belonging to the space group Fm-3m is included and cations and anions are alternately arranged. Note that a cation or anion vacancy may exist.

Having features of both a layered rock-salt crystal structure and a rock-salt crystal structure can be judged by electron diffraction, a TEM image, a cross-sectional STEM image, and the like.

There is no distinction among cation sites in a rock-salt crystal structure. Meanwhile, a layered rock-salt crystal structure has two types of cation sites: one type is mostly occupied by lithium, and the other is occupied by the transition metal. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt and layered rock-salt crystal structures has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a lager atomic number than lithium exists in part of the layers with low luminance, i.e., the lithium layers.

Anions of a layered rock-salt crystal and anions of a rock-salt crystal form a cubic close-packed structure (face-centered cubic lattice structure). Anions of an O3′ type crystal and a monoclinic O1(15) crystal, which are described later, are presumed to form a cubic close-packed structure. Thus, when a layered rock-salt crystal and a rock-salt crystal are in contact with each other, there is a crystal plane at which orientations of cubic close-packed structures formed of anions are aligned with each other.

The description can also be made as follows. An anion on the {111} plane of a cubic crystal structure has a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, in the layered rock-salt crystal, the O3′ crystal, and the rock-salt crystal, a state where the orientations of the cubic close-packed structures formed of anions are aligned with each other may be referred to as a state where crystal orientations are substantially aligned with each other. In addition, a state where three-dimensional structures have similarity, e.g., crystal orientations are substantially aligned with each other, or orientations are crystallographically the same is referred to as “topotaxy”.

The crystal orientations in two regions being substantially aligned with each other can be judged, for example, from a TEM image, a STEM image, a high-angle annular dark field scanning TEM (HAADF-STEM) image, an annular bright-field scanning transmission electron microscope (ABF-STEM) image, an electron diffraction pattern, or the like. It can be judged also from an FFT pattern of a TEM image or an FFT pattern of a STEM image or the like. Furthermore, XRD, neutron diffraction, and the like can also be used for judging.

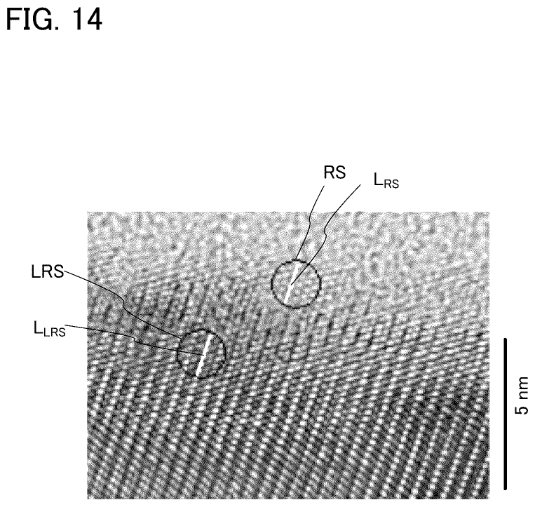

FIG. 14 shows an example of a TEM image in which orientations of a layered rock-salt crystal LRS and a rock-salt crystal RS are substantially aligned with each other. In a TEM image, a STEM image, a HAADF-STEM image, an ABF-STEM image, and the like, an image showing a crystal structure is obtained.

For example, in a high-resolution TEM image, a contrast derived from a crystal plane is obtained. When an electron beam is incident perpendicularly to the c-axis of a composite hexagonal lattice of a layered rock-salt crystal structure, for example, a contrast derived from the (0003) plane is obtained as repetition of bright bands (bright strips) and dark bands (dark strips) because of diffraction and interference of the electron beam. Thus, when repetition of bright lines and dark lines is observed and the angle between the bright lines (e.g., L_{RS} and L_{LRS} in FIG. 14) is 5° or less or 2.5° or less in the TEM image, it can be judged that the crystal planes are substantially aligned with each other, that is, orientations of the crystals are substantially aligned with each other. Similarly, when the angle between the dark lines is 5° or less or 2.5° or less, it can be judged that orientations of the crystals are substantially aligned with each other.

In a HAADF-STEM image, a contrast corresponding to the atomic number is obtained, and an element having a larger atomic number is observed to be brighter. For example, in the case of lithium cobalt oxide that has a layered rock-salt crystal structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots in the direction perpendicular to the c-axis, and arrangement of lithium atoms and oxygen atoms is observed as dark lines or a low-luminance region in the direction perpendicular to the c-axis. The same applies to the case where fluorine (atomic number: 9) and magnesium (atomic number: 12) are included as the additive elements of the lithium cobalt oxide.

Consequently, in the case where repetition of bright lines and dark lines is observed in two regions having different crystal structures and the angle between the bright lines is 5° or less or 2.5° or less in a HAADF-STEM image, it can be judged that arrangements of the atoms are substantially aligned with each other, that is, orientations of the crystals are substantially aligned with each other. Similarly, when the angle between the dark lines is 5° or less or 2.5° or less, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

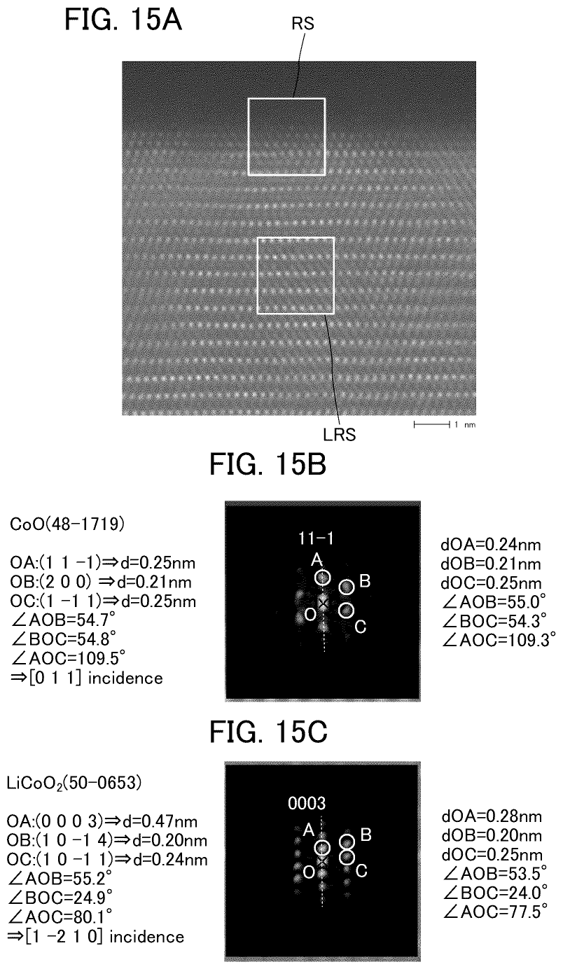

FIG. 15A shows an example of a STEM image in which orientations of the layered rock-salt crystal LRS and the rock-salt crystal RS are substantially aligned with each other. FIG. 15B shows an FFT pattern of a region of the rock-salt crystal RS, and FIG. 15C shows an FFT pattern of a region of the layered rock-salt crystal LRS. In FIGS. 15B and 15C, the composition, the JCPDS card number, and d values and angles calculated from the JCPDS card data are shown on the left. The measured values are shown on the right. A spot denoted by O is zero-order diffraction.

A spot denoted by A in FIG. 15B is derived from 11-1 reflection of a cubic structure. A spot denoted by A in FIG. 15C is derived from 0003 reflection of a layered rock-salt crystal structure. It is found from FIGS. 15B and 15C that the direction of the 11-1 reflection of the cubic structure and the direction of the 0003 reflection of the layered rock-salt crystal structure are substantially aligned with each other. That is, a straight line that passes through AO in FIG. 15B is substantially parallel to a straight line that passes through AO in FIG. 15C. Here, the terms “substantially aligned” and “substantially parallel” mean that the angle between the two is 5° or less or 2.5° or less.

When the orientations of the layered rock-salt crystal and the rock-salt crystal are substantially aligned with each other in the above manner in an FFT pattern and an electron diffraction pattern, the <0003> orientation of the layered rock-salt crystal and the <11-1> orientation of the rock-salt crystal may be substantially aligned with each other. In that case, it is preferred that these reciprocal lattice points be spot-shaped, that is, they not be connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 15C is derived from 1014 reflection of the layered rock-salt crystal structure. This is sometimes observed at a position where the difference in orientation from the reciprocal lattice point derived from the 0003 reflection of the layered rock-salt crystal structure (A in FIG. 15C) is greater than or equal to 520 and less than or equal to 56° (i.e., ∠AOB is 52° to 56°) and d is greater than or equal to 0.19 nm and less than or equal to 0.21 nm. Note that these indices are just an example, and the spot does not necessarily correspond with them and may be, for example, a reciprocal lattice point equivalent to 0003 and 1014.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 15B is derived from 200 reflection of the cubic structure. This diffraction spot is sometimes observed at a position where the difference in orientation from the reciprocal lattice point derived from the 11-1 reflection of the cubic structure (A in FIG. 15B) is greater than or equal to 54° and less than or equal to 56° (i.e., ∠AOB is greater than or equal to 54° and less than or equal to 56°). Note that these indices are just an example, and the spot does not necessarily correspond with them and may be, for example, a reciprocal lattice point equivalent to 11-1 and 200.

It is known that in a layered rock-salt positive electrode active material, such as lithium cobalt oxide, the (0003) plane and a plane equivalent thereto and the (10-14) plane and a plane equivalent thereto are likely to appear as crystal planes. Thus, to observe the (0003) plane with a TEM or the like, for example, a positive electrode active material particle in which a crystal plane that is presumably the (0003) plane is observed with a SEM is preferably selected first; then, the positive electrode active material particle is preferably processed to be thin using a focused ion beam (FIB) or the like such that the (0003) plane can be observed with the TEM or the like with an electron beam thereof entering in [12-10]. To judge alignment of crystal orientations, a sample is preferably processed to be thin so that the (0003) plane of the layered rock-salt crystal structure is easily observed.

<<x in LiₓCoO₂ is Small>>

The crystal structure in a state where x in LiₓCoO₂ is small of the positive electrode active material 100 of one embodiment of the present invention is different from that of a conventional positive electrode active material because the positive electrode active material 100 has the above-described additive element distribution and/or crystal structure in a discharged state. Here, “x is small” means 0.1<x≤0.24.

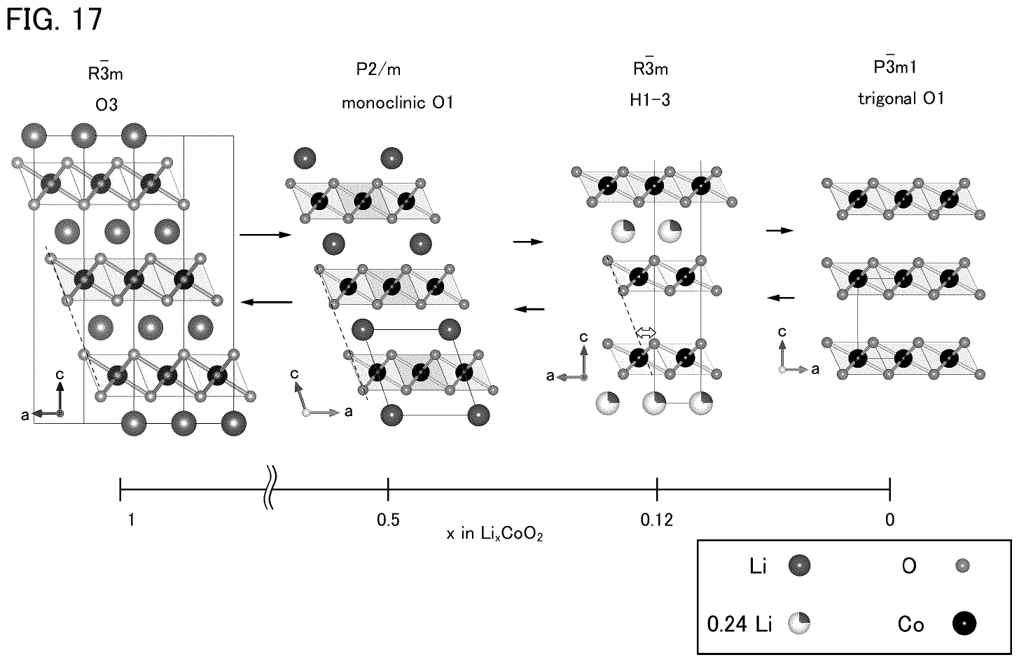

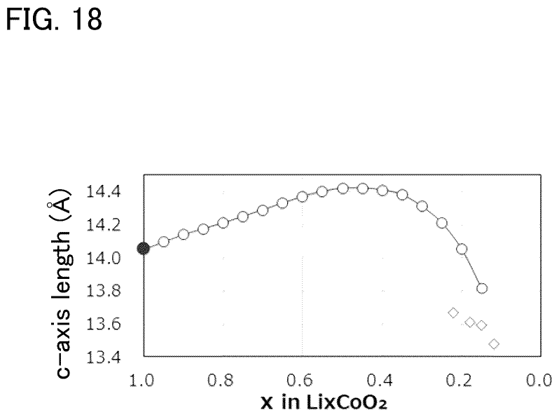

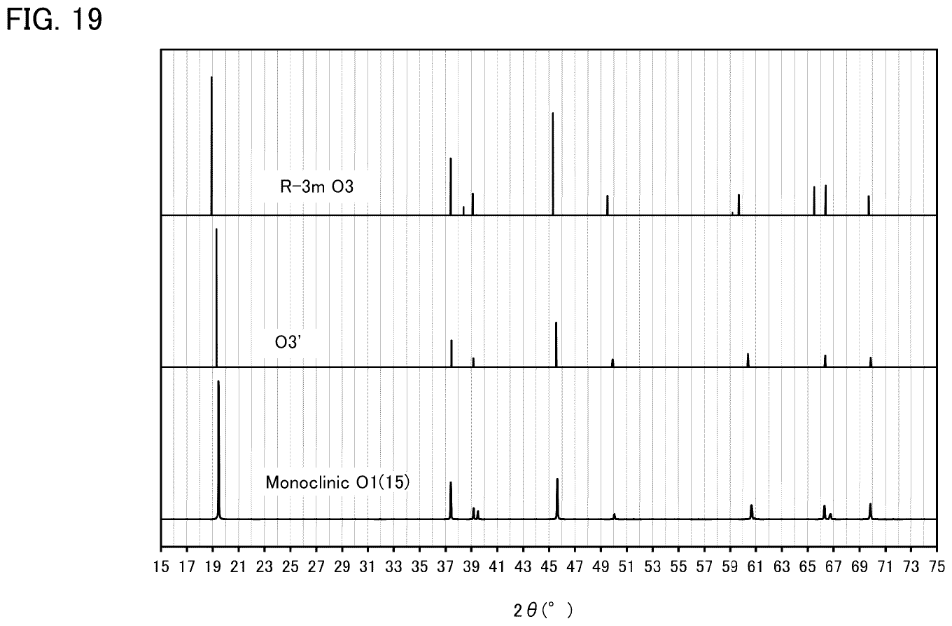

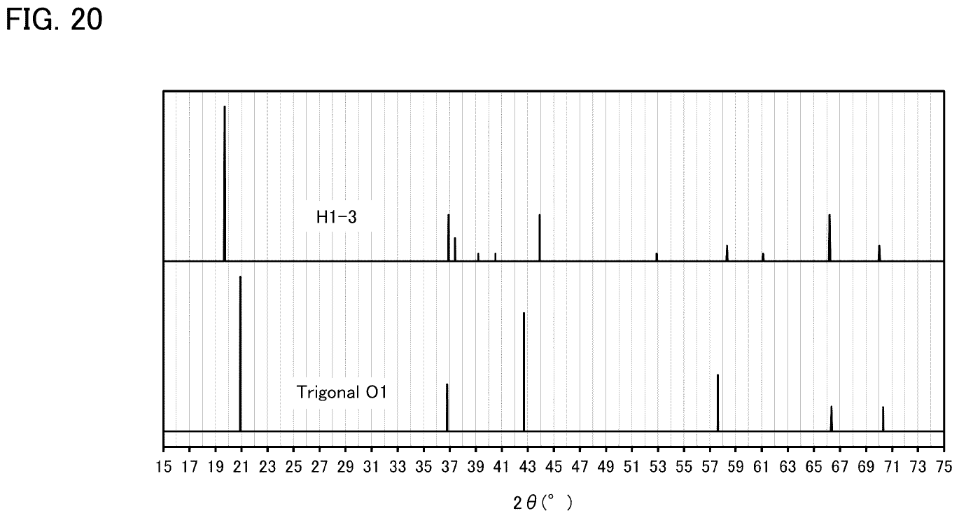

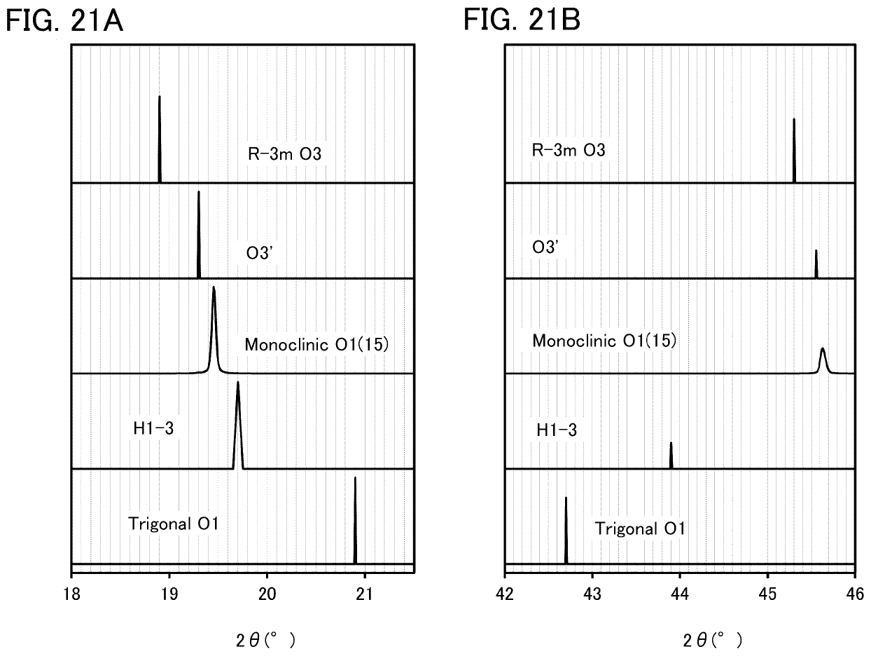

A conventional positive electrode active material and the positive electrode active material 100 of one embodiment of the present invention are compared, so that changes in the crystal structures owing to a change in x in LiₓCoO₂ are described with reference to FIG. 16, FIG. 17, FIG. 18, FIG. 19, FIG. 20, and FIGS. 21A and 21B.

A change in the crystal structure of the conventional positive electrode active material is shown in FIG. 17. The conventional positive electrode active material shown in FIG. 17 is lithium cobalt oxide (LiCoO₂) containing no additive element. A change in the crystal structure of lithium cobalt oxide containing no additive element is described in Non-Patent Documents 2 to 5 and the like.

In FIG. 17, the crystal structure of lithium cobalt oxide with x in LiₓCoO₂ of 1 is denoted by R-3m 03. In this crystal structure, lithium occupies octahedral sites and a unit cell includes three CoO₂ layers. Thus, this crystal structure is referred to as an O₃ type structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x of approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3m1 and includes one CoO₂ layer in a unit cell. Hence, this crystal structure is referred to as an O1 type structure or a trigonal O1 type structure in some cases. Moreover, in some cases, this crystal structure is referred to as a hexagonal O1 type structure when a trigonal crystal system is converted into a composite hexagonal lattice.

Conventional lithium cobalt oxide with x of approximately 0.12 has the crystal structure belonging to the space group R-3m. This structure can also be regarded as a structure in which CoO₂ structures such as a trigonal O1 type structure and LiCoO₂ structures such as an R-3m O3 type structure are alternately stacked. Thus, this crystal structure is sometimes referred to as an H1-3 type structure. Note that since insertion and extraction of lithium do not necessarily uniformly occur in the positive electrode active material in reality, the lithium concentrations can vary in the positive electrode active material. Thus, the H1-3 type structure is started to be observed when x is approximately 0.25 in practice. The number of cobalt atoms per unit cell in the actual H1-3 type structure is twice that in other structures. However, in this specification including FIG. 17, the c-axis of the H1-3 type structure is half that of the unit cell for easy comparison with the other crystal structures.

For the H1-3 type structure, as disclosed in Non-Patent Document 4, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). Note that O1 and O2 are each an oxygen atom. A preferred unit cell for representing a crystal structure in a positive electrode active material can be selected by Rietveld analysis of XRD patterns, for example. In this case, a unit cell is selected such that the value of goodness of fit (GOF) is small.

When charging that makes x in LiₓCoO₂ be 0.24 or less and discharging are repeated, the crystal structure of conventional lithium cobalt oxide repeatedly changes between the H1-3 type structure and the R-3m O3 type structure in a discharged state (i.e., an unbalanced phase change).

However, there is a large shift in the CoO₂ layers between these two crystal structures. As denoted by the dotted lines and the arrows in FIG. 17, the CoO₂ layer in the H1-3 type structure largely shifts from that in the structure belonging to R-3m O3 in a discharged state. Such a dynamic structural change can adversely affect the stability of the crystal structure.

A difference in volume between the two crystal structures is also large. The crystal structure and the volume of the unit cell of lithium cobalt oxide change in accordance with a change in charge depth, i.e., a change in x in LiₓCoO₂. FIG. 18 shows a change in c-axis length of conventional lithium cobalt oxide described in Non-Patent Document 5. A circle indicates a hexagonal phase and a rhombus indicates a monoclinic phase. The c-axis length contracts in an H1-3 phase as shown by the rhombuses in FIG. 18. The phase transition from an O3 phase to an H1-3 phase is due to extraction of lithium ions, whereby a phase transition probably occurs from a surface of a positive electrode active material from which lithium ions are extracted first and eventually spreads to the entire positive electrode active material.

A change in c-axis length of lithium cobalt oxide corresponds to a change in the angle at which a peak of, for example, the (003) plane of lithium cobalt oxide appears in an XRD pattern. It is known that a peak of the (003) plane of lithium cobalt oxide appears at around 2θ=19° to 20° in XRD using CuKα₁ radiation.

Thus, when the H1-3 type structure and the R-3m O3 type structure in a discharged state contain the same number of cobalt atoms, these structures have a difference in volume of greater than 3.5%, typically greater than or equal to 3.9%.

In addition, a structure in which CoO₂ layers are arranged continuously, as in the trigonal O1 type structure, included in the H1-3 type structure is highly likely to be unstable.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

Meanwhile, in the positive electrode active material 100 of one embodiment of the present invention shown in FIG. 16, a change in the crystal structure between a discharged state with x in LiₓCoO₂ of 1 and a state with x of 0.24 or less is smaller than that in a conventional positive electrode active material. Specifically, a shift in the CoO₂ layers between the state with x of 1 and the state with x of 0.24 or less can be small. In addition, when the positive electrode active material 100 and the conventional positive electrode active material having the same number of cobalt atoms are compared, the positive electrode active material 100 changes in volume less than the conventional positive electrode active material. Thus, in the positive electrode active material 100 of one embodiment of the present invention, the crystal structure is unlikely to be broken even when charging that makes x be 0.24 or less and discharging are repeated; accordingly, the positive electrode active material 100 enables excellent cycle performance. In addition, the positive electrode active material 100 of one embodiment of the present invention with x in LiₓCoO₂ of 0.24 or less can have a more stable crystal structure than the conventional positive electrode active material. Thus, the positive electrode active material 100 of one embodiment of the present invention with x in LiₓCoO₂ being kept at 0.24 or less inhibits a short circuit. This is preferable because the safety of a secondary battery is further improved.

FIG. 16 shows crystal structures of the inner portion 100b of the positive electrode active material 100 in a state where x in LiₓCoO₂ is 1, approximately 0.2, and approximately 0.15. The inner portion 100b, accounting for the majority of the volume of the positive electrode active material 100, largely contributes to charging and discharging and is accordingly a portion where a shift in CoO₂ layers and a volume change matter most.

The positive electrode active material 100 with x of 1 has the R-3m O3 type structure, which is the same as that of conventional lithium cobalt oxide.

However, in a state where x is 0.24 or less, e.g., approximately 0.2 or approximately 0.15, the positive electrode active material 100 has a crystal structure different from the H1-3 type structure whereas conventional lithium cobalt oxide has the H1-3 type structure.

The positive electrode active material 100 of one embodiment of the present invention with x of approximately 0.2 has a trigonal crystal structure belonging to the space group R-3m. The symmetry of the CoO₂ layers of this structure is the same as that of the O3 type structure. Thus, this crystal structure is referred to as an O3′ type structure. In FIG. 16, this crystal structure is denoted by R-3m O3′.

Note that in the unit cell of the O3′ type structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811 (×10⁻¹ nm), typically, c=13.781 (×10⁻¹ nm).

When x is approximately 0.15, the positive electrode active material 100 of one embodiment of the present invention has a monoclinic crystal structure belonging to the space group P2/m. In this structure, a unit cell includes one CoO₂ layer. Here, lithium in the positive electrode active material 100 is approximately 15 atomic % of that in a discharged state. Thus, this crystal structure is referred to as a monoclinic O1(15) type structure. In FIG. 16, this crystal structure is denoted by P2/m monoclinic O1(15).

In the unit cell of the monoclinic O1(15) type structure, the coordinates of cobalt and oxygen can be represented by Co1 (0.5, 0, 0.5), Co2 (0, 0.5, 0.5), O1 (X_{O1}, 0, Z_{O1}) within the range of 0.23≤X_{O1}≤0.24 and 0.61≤Z_{O1}≤0.65, and O2 (X_{O2}, 0.5, Z_{O2}) within the range of 0.75≤X_{O2}≤0.78 and 0.68≤Z_{O2}≤0.71. The unit cell has lattice constants a=4.880±0.05 (×10⁻¹ nm), b=2.817±0.05 (×10⁻¹ nm), c=4.839±0.05 (×10⁻¹ nm), α=90°, β=109.6±0.1°, and γ=90°.

Note that this crystal structure can have the lattice constants even when belonging to the space group R-3m if a certain error is allowed. In this case, the coordinates of cobalt and oxygen in the unit cell can be represented by Co (0, 0, 0.5) and O (0, 0, Z_{O}) within the range of 0.21≤Z_{O}≤0.23. The unit cell has lattice constants a=2.817±0.02 (×10⁻¹ nm) and c=13.68±0.1 (×10⁻¹ nm).

In each of the O3′ type structure and the monoclinic O1(15) type structure, an ion of cobalt, nickel, magnesium, or the like occupies a site coordinated to six oxygen atoms. Note that a light element such as lithium or magnesium sometimes occupies a site coordinated to four oxygen atoms.

As denoted by the dotted lines in FIG. 16, the CoO₂ layers hardly shift between the R-3m O3 type structure in a discharged state, the O3′ type structure, and the monoclinic O1(15) type structure.

The R-3m O3 type structure in a discharged state and the O3′ type structure that contain the same number of cobalt atoms have a difference in volume of 2.5% or less, specifically 2.2% or less, typically 1.8%.

The R-3m O3 type structure in a discharged state and the monoclinic O1(15) type structure that contain the same number of cobalt atoms have a difference in volume of 3.3% or less, specifically 3.0% or less, typically 2.5%.

Table 1 shows a difference in volume per cobalt atom between the R-3m O3 type structure in a discharged state, the O3′ type structure, the monoclinic O1(15) type structure, the H1-3 type structure, and the trigonal O1 type structure. For the lattice constants of the R-3m O3 type structure in a discharged state and the trigonal O1 type structure in Table 1, which are used for the calculation, ICSD coll. code. 172909 and 88721 can be referred to. For the lattice constants of the H1-3 type structure, Non-Patent Document 4 can be referred to. The lattice constants of the O3′ type structure and the monoclinic O1(15) type structure can be calculated from the experimental values of XRD. Note that 1 Å=10⁻¹⁰ m.

TABLE 1

| | Lattice constant | | | | Volume of | Volume per | Volume |
|---|---|---|---|---|---|---|---|
| Crystal | a | b | c | β | unit cell | Co atom | change rate |
| structure | (Å) | (Å) | (Å) | (°) | (Å³) | (Å³) | (%) |
| R-3m O3 | 2.8156 | 2.8156 | 14.0542 | 90 | 96.49 | 32.16 | — |
| (LiCoO₂) | | | | | | | |
| O3′ | 2.818 | 2.818 | 13.78 | 90 | 94.76 | 31.59 | 1.8 |
| Monoclinic | 4.881 | 2.817 | 4.839 | 109.6 | 62.69 | 31.35 | 2.5 |
| O1(15) | | | | | | | |
| H1-3 | 2.82 | 2.82 | 26.92 | 90 | 185.4 | 30.90 | 3.9 |
| Trigonal O1 | 2.8048 | 2.8048 | 4.2509 | 90 | 28.96 | 28.96 | 10.0 |
| (CoO_{1.92}) | | | | | | | |

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume in the case where the positive electrode active materials having the same number of cobalt atoms are compared is inhibited. Thus, the crystal structure of the positive electrode active material 100 is less likely to break even when charging that makes x be 0.24 or less and discharging are repeated. Therefore, a decrease in charge and discharge capacity of the positive electrode active material 100 in charge and discharge cycles is inhibited. Furthermore, the positive electrode active material 100 can stably use a large amount of lithium than a conventional positive electrode active material and thus has high discharge capacity per weight and per volume. Thus, with the use of the positive electrode active material 100, a secondary battery with high discharge capacity per weight and per volume can be fabricated.

Note that the positive electrode active material 100 actually has the O3′ type structure in some cases when x in LiₓCoO₂ is greater than or equal to 0.15 and less than or equal to 0.24, and is assumed to have the O3′ type structure even when x is greater than 0.24 and less than or equal to 0.27. In addition, the positive electrode active material 100 actually has the monoclinic O1(15) type structure in some cases when x in LiₓCoO₂ is greater than 0.1 and less than or equal to 0.2, typically greater than or equal to 0.15 and less than or equal to 0.17. However, the crystal structure is affected by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 100 may have the O3′ type structure and/or the monoclinic O1(15) type structure. Not all the particles contained in the inner portion 100b of the positive electrode active material 100 necessarily have the O3′ type structure and/or the monoclinic O1(15) type structure. Some of the particles may have another crystal structure or be amorphous.

In order to make x in LiₓCoO₂ small, charging at a high charge voltage is necessary in general. Therefore, the state where x in LiₓCoO₂ is small can be rephrased as a state where charging at a high charge voltage has been performed. For example, when CC/CV charging is performed at 25° C. and 4.6 V or higher using the potential of a lithium metal as a reference, the H1-3 type structure appears in a conventional positive electrode active material. Therefore, a charge voltage of 4.6 V or higher can be regarded as a high charge voltage with reference to the potential of a lithium metal. In this specification and the like, unless otherwise specified, a charge voltage is shown with reference to the potential of a lithium metal.

That is, the positive electrode active material 100 of one embodiment of the present invention is preferable because the positive electrode active material 100 can maintain the R-3m O3 type structure having symmetry even when charging at a high charge voltage, e.g., 4.6 V or higher at 25° C., is performed. Moreover, the positive electrode active material 100 of one embodiment of the present invention is preferable because the positive electrode active material 100 can have the O3′ type structure when charging at a higher charge voltage, e.g., a voltage higher than or equal to 4.65 V and lower than or equal to 4.7 V at 25° C., is performed. Furthermore, the positive electrode active material 100 of one embodiment of the present invention is preferable because the positive electrode active material 100 can have the monoclinic O1(15) type structure when charging at a much higher charge voltage, e.g., a voltage higher than 4.7 V and lower than or equal to 4.8 V at 25° C., is performed.

At a far higher charge voltage, the H1-3 type structure is eventually observed in the positive electrode active material 100 in some cases. As described above, the crystal structure is affected by the number of charge and discharge cycles, a charge current and a discharge current, temperature, an electrolyte, and the like, so that the positive electrode active material 100 of one embodiment of the present invention sometimes has the O3′ type structure even at a lower charge voltage, e.g., a charge voltage higher than or equal to 4.5 V and lower than 4.6 V at 25° C. Similarly, the positive electrode active material 100 sometimes has the monoclinic O1(15) type structure when charging is performed at a voltage higher than or equal to 4.65 V and lower than or equal to 4.7 V at 25° C.

Note that in the case where graphite is used as a negative electrode active material in a secondary battery, the voltage of the secondary battery is lower than the above-mentioned voltages by the potential of graphite. The potential of graphite is approximately 0.05 V to 0.2 V with reference to the potential of a lithium metal. Therefore, in the case of a secondary battery using graphite as a negative electrode active material, a crystal structure similar to the above-described crystal structure is obtained at a voltage corresponding to a difference between the above-described voltage and the potential of the graphite.

Although a chance of the existence of lithium at all lithium sites is the same in the O3′ type structure and the monoclinic O1(15) type structure in FIG. 16, the present invention is not limited thereto. Lithium may exist unevenly in only some of the lithium sites. For example, lithium may symmetrically exist as in the monoclinic O1 type structure (Li_{0.5}CoO₂) in FIG. 17. The distribution of lithium can be analyzed by neutron diffraction, for example.

Each of the O3′ type structure and the monoclinic O1(15) type structure can be regarded as a crystal structure that contains lithium between layers randomly and is similar to a CdCl₂ crystal structure. The crystal structure similar to the CdCl₂ crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ crystal structure generally.

### <<Crystal Grain Boundary>>

It is further preferable that the additive element contained in the positive electrode active material 100 of one embodiment of the present invention have the above-described distribution and be at least partly unevenly distributed at the crystal grain boundary 101 and the vicinity thereof.

In this specification and the like, uneven distribution refers to a state where the concentration of a certain element in a certain region is different from that in other regions, and may be rephrased as segregation, precipitation, unevenness, deviation, a mixture of a high-concentration portion and a low-concentration portion, or the like.

For example, the magnesium concentration at the crystal grain boundary 101 and the vicinity thereof in the positive electrode active material 100 is preferably higher than that in the other regions in the inner portion 100b. In addition, the fluorine concentration at the crystal grain boundary 101 and the vicinity thereof is preferably higher than that in the other regions in the inner portion 100b. In addition, the nickel concentration at the crystal grain boundary 101 and the vicinity thereof is preferably higher than that in the other regions in the inner portion 100b. In addition, the aluminum concentration at the crystal grain boundary 101 and the vicinity thereof is preferably higher than that in the other regions in the inner portion 100b.

The crystal grain boundary 101 is a plane defect, and thus tends to be unstable and suffer a change in the crystal structure like the surface of the particle. Thus, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100 of one embodiment of the present invention. Thus, the positive electrode active material including a crack can also have an increased corrosion resistance to hydrofluoric acid.

### <Particle Diameter>

When the particle diameter of the positive electrode active material 100 of one embodiment of the present invention is too large, there are problems such as difficulty in lithium diffusion and large surface roughness of an active material layer at the time when the material is applied to a current collector. By contrast, too small a particle diameter causes problems such as an overreaction with the electrolyte solution. Therefore, the median diameter (D50) is preferably greater than or equal to 1 μm and less than or equal to 100 μm, further preferably greater than or equal to 2 μm and less than or equal to 40 m, still further preferably greater than or equal to 5 μm and less than or equal to 30 μm. Alternatively, the median diameter (D50) is preferably greater than or equal to 1 μm and less than or equal to 40 μm, greater than or equal to 1 μm and less than or equal to 30 μm, greater than or equal to 2 μm and less than or equal to 100 μm, greater than or equal to 2 m and less than or equal to 30 μm, greater than or equal to 5 μm and less than or equal to 100 μm, or greater than or equal to 5 μm and less than or equal to 40 μm.

A positive electrode is preferably formed using a mixture of particles having different particle diameters to have an increased electrode density and enable a high energy density of a secondary battery. The positive electrode active material 100 with a relatively small particle diameter is expected to enable favorable charge and discharge rate characteristics. A secondary battery that includes the positive electrode active material 100 having a relatively large particle diameter is expected to have high charge and discharge cycle performance and maintain high discharge capacity.

### <Analysis Method>

Whether or not a positive electrode active material is the positive electrode active material 100 of one embodiment of the present invention, which has the O3′ type structure and/or the monoclinic O1(15) type structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt in the positive electrode active material can be analyzed with high resolution, comparison of the degree of crystallinity and comparison of the crystal orientation can be performed, distortion of lattice arrangement and the crystallite size can be analyzed, and a positive electrode obtained only by disassembling a secondary battery can be measured with sufficient accuracy, for example. The peaks appearing in the powder XRD patterns reflect the crystal structure of the inner portion 100b of the positive electrode active material 100, which accounts for the majority of the volume of the positive electrode active material 100.

In the case where the crystallite size is measured by powder XRD, the measurement is preferably performed while the adverse effect of orientation of the positive electrode active material particles due to pressure application or the like is eliminated. For example, it is preferable that the positive electrode active material be taken out from a positive electrode obtained from a disassembled secondary battery, the positive electrode active material be made into a powder sample, and then the measurement be performed.

As described above, the feature of the positive electrode active material 100 of one embodiment of the present invention is a small change in the crystal structure between a state with x in LiₓCoO₂ of 1 and a state with x of 0.24 or less. A material 50% or more of which has the crystal structure that will be largely changed by high-voltage charging is not preferable because the material cannot withstand repetition of high-voltage charging and discharging.

It should be noted that the O3′ type structure or the monoclinic O1(15) type structure is not obtained in some cases only by addition of the additive element. For example, in a state with x in LiₓCoO₂ of 0.24 or less, lithium cobalt oxide containing magnesium and fluorine or lithium cobalt oxide containing magnesium and aluminum has the O3′ type structure and/or the monoclinic O1(15) type structure at 60% or more in some cases, and has the H1-3 type structure at 50% or more in other cases, depending on the concentration and distribution of the additive element.

In addition, in a state where x is too small, e.g., 0.1 or less, or a charge voltage is higher than 4.9 V, the positive electrode active material 100 of one embodiment of the present invention sometimes has the H1-3 type structure or the trigonal O1 type structure. Thus, to determine whether or not a positive electrode active material is the positive electrode active material 100 of one embodiment of the present invention, analysis of the crystal structure by XRD and other methods and data such as charge capacity or charge voltage are needed.

Note that the crystal structure of a positive electrode active material in a state with small x may be changed with exposure to the air. For example, the O3′ type structure and the monoclinic O1(15) type structure change into the H1-3 type structure in some cases. For that reason, all samples subjected to analysis of the crystal structure are preferably handled in an inert atmosphere such as an argon atmosphere.

Whether the additive element contained in a positive electrode active material has the above-described distribution can be judged by analysis using XPS, energy dispersive X-ray spectroscopy (EDX), electron probe microanalysis (EPMA), or the like.

The crystal structure of the surface portion 100a, the crystal grain boundary 101, or the like can be analyzed by electron diffraction of a cross section of the positive electrode active material 100, for example.

### <<Charging Method>>

Whether or not a composite oxide is the positive electrode active material 100 of one embodiment of the present invention can be determined by charging a CR2032 coin cell (with a diameter of 20 mm and a height of 3.2 mm) that is formed using the composite oxide and a lithium metal respectively for a positive electrode and a counter electrode, for example. The coin cell includes an electrolyte solution, a separator, a positive electrode can, and a negative electrode can.

More specifically, the positive electrode can be formed by application of a slurry in which the composite oxide as a positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used, and as the electrolyte solution, a solution in which ethylene carbonate (EC) and diethyl carbonate (DEC) at a volume ratio of 3:7 and vinylene carbonate (VC) at 2 wt % are mixed can be used.

As the separator, a 25-μm-thick polypropylene porous film can be used.

Stainless steel (SUS) can be used for the positive electrode can and the negative electrode can.

The coin cell fabricated with the above conditions is charged to a freely selected voltage (e.g., 4.5 V, 4.55 V, 4.6V, 4.65 V, 4.7 V, 4.75 V, or 4.8 V). The charge conditions are not particularly limited as long as charging can be performed for enough time to a freely selected voltage. In the case of CCCV charging, for example, CC charging can be performed with a current higher than or equal to 20 mA/g and lower than or equal to 100 mA/g, and CV charging can be ended with a current higher than or equal to 2 mA/g and lower than or equal to 10 mA/g. To observe a phase change of the positive electrode active material, charging with such a small current value is preferably performed. Meanwhile, in the case where a current does not reach higher than or equal to 2 mA/g and lower than or equal to 10 mA/g even when CV charging is performed for a long time, the CV charging may be ended after the sufficient time passes from the start because the current is probably consumed not for charging the positive electrode active material but for decomposing the electrolyte solution. The sufficient time here can be longer than or equal to 1.5 hours and shorter than or equal to 3 hours. The temperature is set to 25° C. or 45° C. After the charging is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode active material is preferably enclosed in an argon atmosphere in performing various analyses later. For example, XRD can be performed on the positive electrode active material enclosed in an airtight container with an argon atmosphere. After the charging is completed, the positive electrode is preferably taken out immediately and subjected to the analysis. Specifically, the positive electrode is preferably subjected to the analysis within 1 hour after the completion of the charging, further preferably 30 minutes after the completion of the charging.

In the case where the crystal structure in a charged state after charging and discharging are performed multiple times is analyzed, the conditions of the charging and discharging which are performed multiple times may be different from the above-described charge conditions. For example, the charging can be performed in the following manner: constant current charging to a freely selected voltage (e.g., 4.6 V, 4.65 V, 4.7 V, 4.75 V, or 4.8 V) at a current value higher than or equal to 20 mA/g and lower than or equal to 100 mA/g is performed and then, constant voltage charging is performed until the current value becomes higher than or equal to 2 mA/g and lower than or equal to 10 mA/g. As the discharging, constant current discharging can be performed at higher than or equal to 20 mA/g and lower than or equal to 100 mA/g until the discharge voltage reaches 2.5 V.

Also in the case where the crystal structure in a discharged state after charging and discharging are performed multiple times is analyzed, constant current discharging can be performed at a current value of higher than or equal to 20 mA/g and lower than or equal to 100 mA/g until the discharge voltage reaches 2.5 V, for example.

### <<XRD>>

The apparatus and conditions adopted in the XRD measurement are not particularly limited. Analysis can be performed with the apparatus and conditions as described below, for example.
XRD apparatus: D8 ADVANCE produced by Bruker AXS
X-ray: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: one second/step
Rotation of sample stage: 15 rpm

In the case where the measurement sample is powder, the powder can be set by, for example, being put in a glass sample holder or being sprinkled on a reflection-free silicon plate to which grease is applied. In the case where the measurement sample is a positive electrode, the positive electrode can be set by being attached to a substrate with a double-sided adhesive tape such that the heights of the positive electrode active material layer and the measurement plane required by the apparatus are aligned.

FIG. 19, FIG. 20, and FIGS. 21A and 21B show ideal powder XRD patterns with CuKα₁ radiation that are calculated from models of the O3′ type structure, the monoclinic O1(15) type structure, and the H1-3 type structure. For comparison, ideal XRD patterns calculated from the crystal structure of LiCoO₂ (O3) with x in LiₓCoO₂ of 1 and the trigonal O1 type structure with x of 0 are also shown. FIGS. 21A and 21B each show both the XRD pattern of the O3′ type structure, that of the monoclinic O1(15) type structure, and that of the H1-3 type structure; FIG. 21A is an enlarged view showing a range of 2θ of greater than or equal to 18° and less than or equal to 21° and FIG. 21B is an enlarged view showing a range of 2θ of greater than or equal to 42° and less than or equal to 46°. Note that the patterns of LiCoO₂ (O3) and CoO₂ (O1) are made from crystal structure data obtained from the Inorganic Crystal Structure Database (ICSD) (see Non-Patent Document 6) with Reflex Powder Diffraction, which is a module of Materials Studio (BIOVIA). The range of 20 was from 15° to 75°, the step size was 0.01, the wavelength λ1 was 1.540562×10⁻¹⁰ m, the wavelength λ2 was not set, and a single monochromator was used. The pattern of the H1-3 type structure is similarly made from the crystal structure data disclosed in Non-Patent Document 4. The O3′ type structure and the monoclinic O1(15) type structure were estimated from the XRD pattern of the positive electrode active material of one embodiment of the present invention, the crystal structures were fitted with TOPAS ver. 3 (crystal structure analysis software produced by Bruker Corporation), and the XRD patterns of the O3′ type structure and the monoclinic O1(15) type structure were made in a similar manner to other structures.

As shown in FIG. 19 and FIGS. 21A and 21B, the O3′ type structure exhibits diffraction peaks at 2θ of 19.25±0.12° (greater than or equal to 19.13° and less than 19.37°) and 2θ of 45.47±0.10° (greater than or equal to 45.37° and less than 45.57°).

The monoclinic O1(15) type structure exhibits diffraction peaks at 2θ of 19.47±0.10° (greater than or equal to 19.37° and less than or equal to 19.57°) and 2θ of 45.62±0.05° (greater than or equal to 45.57° and less than or equal to 45.67°).

However, as shown in FIG. 20 and FIGS. 21A and 21B, the H1-3 type structure and the trigonal O1 type structure do not exhibit peaks at these positions. Thus, exhibiting the peak at 2θ of greater than or equal to 19.13° and less than 19.37° and/or the peak at 2θ of greater than or equal to 19.37° and less than or equal to 19.57° and the peak at 2θ of greater than or equal to 45.37° and less than 45.57° and/or the peak at 2θ of greater than or equal to 45.57° and less than or equal to 45.67° in a state with small x in LiₓCoO₂ can be the feature of the positive electrode active material 100 of one embodiment of the present invention.

It can be said that, in the positive electrode active material 100 of one embodiment of the present invention, the position of an XRD diffraction peak exhibited by the crystal structure with x of 1 is close to that of an XRD diffraction peak exhibited by the crystal structure with x of 0.24 or less. More specifically, it can be said that in the 2θ range of 42° to 46°, a difference in 2θ between the main diffraction peak exhibited by the crystal structure with x of 1 and the main diffraction peak exhibited by the crystal structure with x of 0.24 or less is 0.7° or less, preferably 0.5° or less.

Although the positive electrode active material 100 of one embodiment of the present invention has the O3′ type structure and/or the monoclinic O1(15) type structure when x in LiₓCoO₂ is small, not all the particles necessarily have the O3′ type structure and/or the monoclinic O1(15) type structure. Some of the particles may have another crystal structure or be amorphous. Note that when the XRD patterns are subjected to the Rietveld analysis, the O3′ type structure and/or the monoclinic O1(15) type structure preferably account for greater than or equal to 50%, further preferably greater than or equal to 60%, still further preferably greater than or equal to 66% of the positive electrode active material. The positive electrode active material in which the O3′ type structure and/or the monoclinic O1(15) type structure account for greater than or equal to 50%, preferably greater than or equal to 60%, further preferably greater than or equal to 66% enables sufficiently good cycle performance.

In addition, the H1-3 type structure and the O1 type structure account for preferably less than or equal to 50%, further preferably less than or equal to 34%, in the Rietveld analysis performed in a similar manner. It is still further preferable that substantially no H1-3 type structure and substantially no O1 type structure be observed.

Furthermore, even after 100 or more cycles of charging and discharging after the measurement starts, the O3′ type structure and/or the monoclinic O1(15) type structure preferably account for greater than or equal to 35%, further preferably greater than or equal to 40%, still further preferably greater than or equal to 43%, in the Rietveld analysis.

Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions and the 2θ value. In the case of the above-described measurement conditions, the peak observed in the 2θ range of 43° to 46° preferably has a full width at half maximum less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity efficiently contributes to stability of the crystal structure after charging.

The crystallite size of the O3′ type structure and the monoclinic O1(15) type structure of the positive electrode active material 100 is decreased to approximately 1/20 of that of LiCoO₂ (O3) in a discharged state. Thus, the peak of the O3′ type structure and/or the monoclinic O1(15) type structure can be clearly observed when x in LiₓCoO₂ is small even under the same XRD measurement conditions as those of a positive electrode before charging and discharging. By contrast, conventional LiCoO₂ has a small crystallite size and exhibits a broad and small peak although it can partly have a structure similar to the O3′ type structure and/or the monoclinic O1(15) type structure. The crystallite size can be calculated from the half width of the XRD peak.

As described above, the influence of the Jahn-Teller effect is preferably small in the positive electrode active material 100 of one embodiment of the present invention. The positive electrode active material 100 of one embodiment of the present invention may contain a transition metal such as nickel or manganese as the additive element in addition to cobalt as long as the influence of the Jahn-Teller effect is small.

The proportions of nickel and manganese and the range of the lattice constants with which the influence of the Jahn-Teller effect is presumed to be small in the positive electrode active material are examined by XRD analysis.

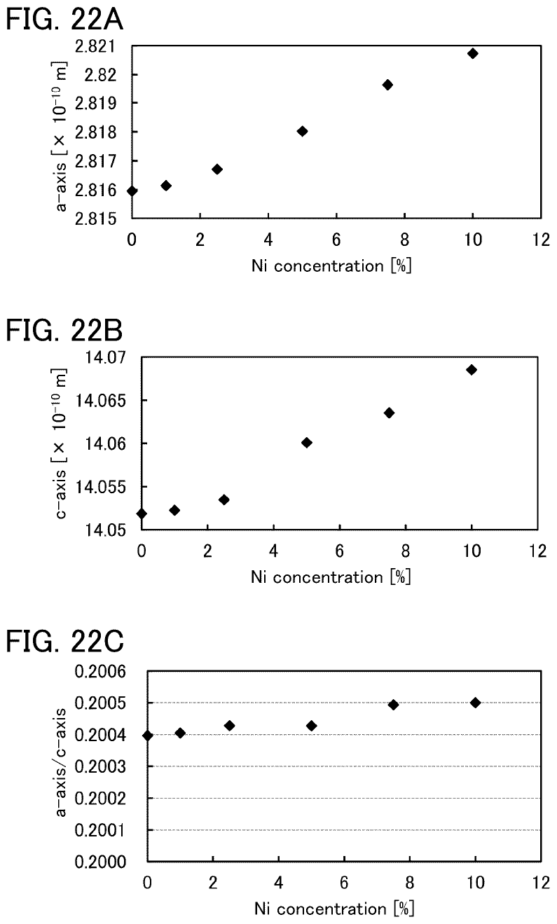

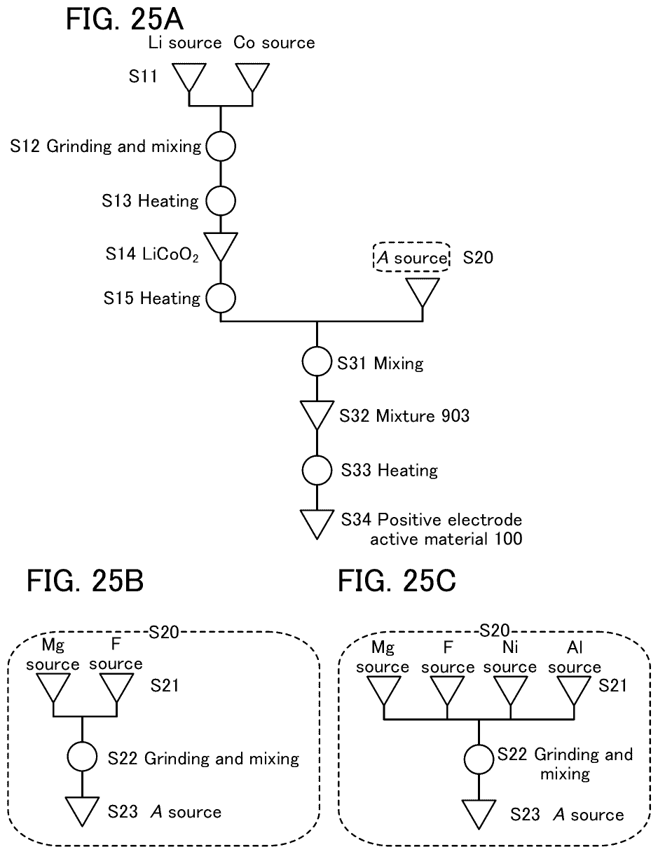

FIGS. 22A to 22C show the calculation results of the lattice constants of the a-axis and the c-axis by XRD in the case where the positive electrode active material 100 of one embodiment of the present invention has a layered rock-salt crystal structure and contains cobalt and nickel. FIG. 22A shows the results of the a-axis, and FIG. 22B shows the results of the c-axis. Note that the XRD patterns of powder after the synthesis of the positive electrode active material before incorporation into a positive electrode were used for the calculation. The nickel concentration on the horizontal axis represents a nickel concentration with the sum of the number of cobalt atoms and the number of nickel atoms regarded as 100%. The positive electrode active material was formed in accordance with the formation steps shown in FIGS. 25A to 25C except that the aluminum source was not used.

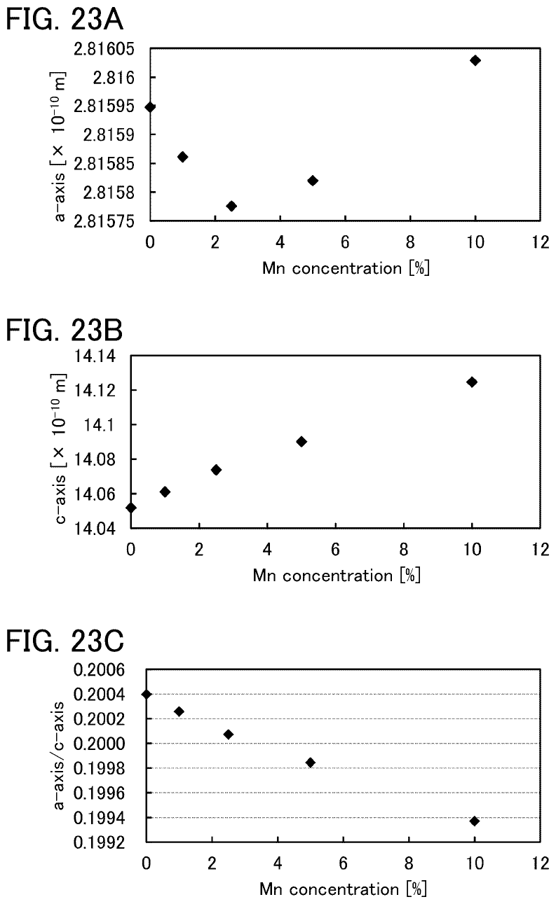

FIGS. 23A to 23C show the estimation results of the lattice constants of the a-axis and the c-axis by XRD in the case where the positive electrode active material 100 of one embodiment of the present invention has a layered rock-salt crystal structure and contains cobalt and manganese. FIG. 23A shows the results of the a-axis, and FIG. 23B shows the results of the c-axis. Note that the lattice constants shown in FIGS. 23A to 23C were obtained by XRD measurement of a powder after the synthesis of the positive electrode active material before incorporation into a positive electrode. The manganese concentration on the horizontal axis represents a manganese concentration with the sum of cobalt atoms and manganese atoms regarded as 100%. The positive electrode active material was formed in accordance with the formation steps shown in FIGS. 25A to 25C except that a manganese source was used instead of the nickel source and the aluminum source was not used.

FIG. 22C shows values obtained by dividing the lattice constants of the a-axis by the lattice constants of the c-axis (a-axis/c-axis) in the positive electrode active material, whose results of the lattice constants are shown in FIGS. 22A and 22B. FIG. 23C shows values obtained by dividing the lattice constants of the a-axis by the lattice constants of the c-axis (a-axis/c-axis) in the positive electrode active material, whose results of the lattice constants are shown in FIGS. 23A and 23B.

As shown in FIG. 22C, the value of a-axis/c-axis tends to significantly change between nickel concentrations of 5% and 7.5%, and the distortion of the a-axis becomes large at a nickel concentration of 7.5%. This distortion may be derived from the Jahn-Teller distortion of trivalent nickel. It is suggested that an excellent positive electrode active material with small Jahn-Teller distortion can be obtained at a nickel concentration lower than 7.5%.

FIG. 23A indicates that the lattice constant changes differently at manganese concentrations of 5% or higher and does not follow the Vegard's law. This suggests that the crystal structure changes at manganese concentrations of 5% or higher. Thus, the manganese concentration is preferably 4% or lower, for example.

Note that the nickel concentration and the manganese concentration in the surface portion 100a are not limited to the above ranges. In other words, the nickel concentration in the surface portion 100a may be higher than the above concentration.

Preferable ranges of the lattice constants of the positive electrode active material of one embodiment of the present invention are examined above. In the layered rock-salt crystal structure of the positive electrode active material 100 in a discharged state or a state where charging and discharging are not performed, which can be estimated from the XRD patterns, the lattice constant of the a-axis is preferably greater than 2.814×10⁻¹⁰ m and less than 2.817×10⁻¹⁰ m, and the lattice constant of the c-axis is preferably greater than 14.05×10⁻¹⁰ m and less than 14.07×10⁻¹⁰ m. The state where charging and discharging are not performed may be the state of powder before the formation of a positive electrode of a secondary battery.

Alternatively, in the layered rock-salt crystal structure of the positive electrode active material 100 in a discharged state or the state where charging and discharging are not performed, the value obtained by dividing the lattice constant of the a-axis by the lattice constant of the c-axis (a-axis/c-axis) is preferably greater than 0.20000 and less than 0.20049.

Alternatively, when the layered rock-salt crystal structure of the positive electrode active material 100 in a discharged state or the state where charging and discharging are not performed is subjected to XRD analysis, a first peak is observed in the 2θ range of 18.50° to 19.30° and a second peak is observed in the 2θ range of 38.00° to 38.80°, in some cases.

### <<XPS>>

In an inorganic oxide, a region that extends from the surface to a depth of approximately 2 nm to 8 nm (normally, less than or equal to 5 nm) can be analyzed by XPS using monochromatic aluminum Kα radiation as an X-ray; thus, the concentrations of elements in a region extending to approximately half the depth of the surface portion 100a can be quantitatively analyzed by XPS. The bonding states of the elements can be analyzed by narrow scanning. The lower detection limit is approximately 1 atomic % but depends on the element.

In the positive electrode active material 100 of one embodiment of the present invention, the concentration of one or more selected from the additive elements is preferably higher in the surface portion 100a than in the inner portion 100b. This means that the concentration of one or more selected from the additive elements in the surface portion 100a is preferably higher than the average concentration of the selected element(s) in the entire positive electrode active material 100. For this reason, for example, it is preferable that the concentration of one or more additive elements selected from the surface portion 100a, which is measured by XPS or the like, be higher than the average concentration of the additive element(s) in the entire positive electrode active material 100, which is measured by ICP-MS, GD-MS, or the like. For example, the concentration of magnesium of at least part of the surface portion 100a, which is measured by XPS or the like, is preferably higher than the average concentration of magnesium of the entire positive electrode active material 100. In addition, the concentrations of nickel, aluminum, and fluorine of at least part of the surface portion 100a are preferably higher than the concentrations of nickel, aluminum, and fluorine of the entire positive electrode active material 100, respectively.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is not easily dissolved even in that case; thus, the atomic ratio of the additive element is not affected.

The concentration of the additive element may be compared using the ratio of the additive element to cobalt. The use of the ratio of the additive element to cobalt enables comparison while inhibiting the influence of a carbonate or the like which is chemically adsorbed after formation of the positive electrode active material. For example, in the XPS analysis, the ratio of the number of magnesium atoms to the number of cobalt atoms (Mg/Co) is preferably greater than or equal to 0.4 and less than or equal to 1.5. In the ICP-MS analysis, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements in the surface portion 100a of the positive electrode active material 100. This means that the concentrations of lithium and cobalt in the surface portion 100a are preferably higher than that of one or more selected from the additive elements contained in the surface portion 100a, which is measured by XPS or the like. For example, the concentrations of cobalt and lithium in at least part of the surface portion 100a, which are measured by XPS or the like, are preferably higher than those of magnesium, nickel, aluminum, and fluorine in at least part of the surface portion 100a, which are measured by XPS or the like.

It is further preferable that aluminum be widely distributed in a deep region, for example, in a region at a depth greater than or equal to 5 nm and less than or equal to 50 nm from the surface or the reference point. Therefore, aluminum is detected by analysis on the entire positive electrode active material 100 by ICP-MS, GD-MS, or the like, but the concentration of aluminum detected by XPS or the like is preferably lower than or equal to the lower detection limit in XPS or the like.

Moreover, when XPS analysis is performed on the positive electrode active material 100 of one embodiment of the present invention, the number of magnesium atoms is preferably greater than or equal to 0.4 times and less than or equal to 1.2 times, further preferably greater than or equal to 0.65 times and less than or equal to 1.0 times the number of cobalt atoms. The number of nickel atoms is preferably less than or equal to 0.15 times, further preferably greater than or equal to 0.03 times and less than or equal to 0.13 times the number of cobalt atoms. The number of aluminum atoms is preferably less than or equal to 0.12 times, further preferably less than or equal to 0.09 times the number of cobalt atoms. The number of fluorine atoms is preferably greater than or equal to 0.3 times and less than or equal to 0.9 times, further preferably greater than or equal to 0.1 times and less than or equal to 1.1 times the number of cobalt atoms. When the atomic ratio is within the above range, it can be said that the additive element is not attached to the surface of the positive electrode active material 100 in a narrow range but widely distributed at a preferable concentration in the surface portion 100a of the positive electrode active material 100.

In the XPS analysis, monochromatic aluminum Kα radiation can be used as an X-ray, for example. An extraction angle is, for example, 45°. For example, the measurement can be performed using the following apparatus and conditions.
Measurement device: Quantera II produced by PHI, Inc.
X-ray: monochromatic Al Kα (1486.6 eV)
Detection area: 100 μmφ
Detection depth: approximately 4 nm to 5 nm (extraction angle 45°)
Measurement spectrum: wide scanning, narrow scanning of each detected element

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. This value is different from the bonding energy of lithium fluoride (685 eV) and that of magnesium fluoride (686 eV).

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably approximately 1303 eV. This value is different from the bonding energy of magnesium fluoride (1305 eV) and is close to that of magnesium oxide.

### <<EDX>>

One or more selected from the additive elements contained in the positive electrode active material 100 preferably have a concentration gradient. It is further preferable that the additive elements contained in the positive electrode active material 100 exhibit concentration peaks at different depths from the surface. The concentration gradient of the additive element can be evaluated by exposing a cross section of the positive electrode active material 100 using an FIB or the like and analyzing the cross section using EDX, EPMA, or the like.

EDX measurement for two-dimensional evaluation of an area by area scan is referred to as EDX area analysis. EDX measurement for evaluation of the atomic concentration distribution in a positive electrode active material by line scan is referred to as EDX line analysis. Furthermore, extracting data of a linear region from EDX area analysis is referred to as line analysis in some cases. The measurement of a region without scanning is referred to as point analysis.

By EDX area analysis (e.g., element mapping), the concentrations of the additive element in the surface portion 100a, the inner portion 100b, the vicinity of the crystal grain boundary 101, and the like of the positive electrode active material 100 can be quantitatively analyzed. By EDX line analysis, the concentration distribution and the highest concentration of the additive element can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

Since the positive electrode active material 100 is a compound containing oxygen and a transition metal into and from which lithium can be inserted and extracted, an interface between a region where oxygen and the transition metal M(Co, Ni, Mn, Fe, or the like) that is oxidized or reduced due to insertion and extraction of lithium exist and a region where oxygen and the transition metal M do not exist is considered as the surface of the positive electrode active material. When the positive electrode active material is analyzed, a protective film is attached on its surface in some cases; however, the protective film is not included in the positive electrode active material. As the protective film, a single-layer film or a multilayer film of carbon, a metal, an oxide, a resin, or the like is sometimes used.

Therefore, when STEM-EDX line analysis or the like in the depth direction is described, the reference point is a point where the detected amount of the characteristic X-ray of the transition metal M is equal to 50% of the sum of the average value M_{AVE} of the detected amounts of the characteristic X-ray of the transition metal M in the inner portion and the average value M_{BG} of the detected amounts of the characteristic X-ray of the transition metal M of the background or a point where the detected amount of the characteristic X-ray of oxygen is equal to 50% of the sum of the average value O_{AVE} of the detected amounts of the characteristic X-ray of oxygen in the inner portion and the average value O_{BG} of the detected amounts of the characteristic X-ray of oxygen of the background. Note that when the position of the point where the detected amount of the characteristic X-ray of the transition metal M is equal to 50% of the sum of the average value of the detected amounts of the characteristic X-ray of the transition metal Min the inner portion and the average value of the detected amounts of the characteristic X-ray of the transition metal M of the background is different from the position of the point where the detected amount of the characteristic X-ray of oxygen is equal to 50% of the sum of the average value of the detected amounts of the characteristic X-ray of oxygen in the inner portion and the average value of the detected amounts of the characteristic X-ray of oxygen of the background, the difference is probably due to the influence of a carbonate, a metal oxide containing oxygen, or the like, which is attached to the surface. Thus, in such a case, the point where the detected amount of the characteristic X-ray of the transition metal M is equal to 50% of the sum of the average value M_{AVE} of the detected amounts of the characteristic X-ray of the transition metal Min the inner portion and the average value M_{BG} of the detected amounts of the characteristic X-ray of the transition metal M of the background can be employed as the reference point. In the case of a positive electrode active material containing a plurality of the transition metals M, the reference point can be determined using M_{AVE} and M_{BG} of the element whose detected amount of the characteristic X-ray in the inner portion is larger than that of any other element.

The average value M_{BG} of the detected amounts of the characteristic X-ray of the transition metal M of the background can be calculated by averaging the detected amounts in the range outside a portion of a positive electrode active material in the vicinity of the portion at which the detected amount of the characteristic X-ray of the transition metal M begins to increase, for example. Note that the detected range is greater than or equal to 2 nm, preferably greater than or equal to 3 nm. The average value M_{AVE} of the detected amounts of the characteristic X-ray of the transition metal M in the inner portion can be calculated by averaging the detected amounts in the range greater than or equal to 2 nm, preferably greater than or equal to 3 nm at the depth at which the detected amounts of the characteristic X-ray of the transition metal M and oxygen are saturated and stabilized, e.g., at a depth larger than, by greater than or equal to 30 nm, preferably greater than 50 nm, the depth at which the detected amount of the characteristic X-ray of the transition metal M begins to increase. The average value O_{BG} of the detected amounts of the characteristic X-ray of oxygen of the background and the average value O_{AVE} of the detected amounts of the characteristic X-ray of oxygen in the inner portion can be calculated in a similar manner.

The surface of the positive electrode active material 100 in, for example, a cross-sectional STEM image is a boundary between a region where an image derived from the crystal structure of the positive electrode active material is observed and a region where the image is not observed. The surface of the positive electrode active material 100 is also determined as the outermost surface of a region where an atomic column derived from an atomic nucleus of, among metal elements which constitute the positive electrode active material, a metal element that has a larger atomic number than lithium is observed in the cross-sectional STEM image.

The spatial resolution of STEM-EDX is approximately 1 nm. Thus, the position where the detected amount of the characteristic X-ray of the additive element has the maximum value may be shifted by approximately 1 nm. For example, even when the position where the detected amount of the characteristic X-ray of the additive element such as magnesium has the maximum value is outside the surface determined in the above-described manner, it can be said that a difference between the maximum value and the surface portion is within the margin of error when the difference is less than 1 nm.

A peak in STEM-EDX line analysis refers to the maximum value of detection intensity of the characteristic X-ray of each element or the position where the maximum value is observed. As an example of a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by performing scanning six times can be used to make the graph of the characteristic X-ray of each element. The number of times of scanning is not limited to six and an average of measured values obtained by performing scanning seven or more times can be used to make the graph of the characteristic X-ray of each element.

STEM-EDX line analysis can be performed as follows, for example. First, a protective film is deposited by evaporation over the surface of a positive electrode active material. For example, carbon can be deposited with an ion sputtering apparatus (MC1000, produced by Hitachi High-Tech Corporation).

Next, the positive electrode active material is thinned to fabricate a cross-section sample to be subjected to STEM-EDX line analysis. For example, the positive electrode active material can be thinned with an FIB-SEM apparatus (XVision 200TBS, produced by Hitachi High-Tech Corporation). Here, picking up can be performed by a micro probing system (MPS), and the acceleration voltage at final processing can be, for example, 10 kV.

The STEM-EDX line analysis can be performed using, for example, HD-2700 produced by Hitachi High-Tech Corporation as a STEM apparatus and Octane T Ultra W produced by EDAX Inc as an EDX detector. In the EDX linear analysis, the emission current of the STEM apparatus is set to be in the range of 6 μA to 10 μA, and a portion of the thinned sample, which is not positioned at a deep level and has little unevenness, is measured. The magnification is approximately 150,000 times, for example. The EDX line analysis can be performed under conditions where drift correction is performed, the line width is 42 nm, the pitch is 0.2 nm, and the number of frames is 6 or more.

EDX area analysis or EDX point analysis of the positive electrode active material 100 of one embodiment of the present invention preferably reveals that the concentration of the additive element such as magnesium in the surface portion 100a is higher than that in the inner portion 100b.

For example, EDX area analysis or EDX point analysis of the positive electrode active material 100 containing magnesium as the additive element preferably reveals that the magnesium concentration in the surface portion 100a is higher than that in the inner portion 100b. In the EDX line analysis, a peak of the magnesium concentration in the surface portion 100a is preferably observed in a region extending to a depth of 3 nm, further preferably 1 nm, still further preferably 0.5 nm, in a direction from the surface of the positive electrode active material 100 or the reference point toward the center of the positive electrode active material 100. In addition, the magnesium concentration preferably attenuates, at a depth of 1 nm from the point where the concentration reaches the peak, to less than or equal to 60% of the peak concentration. In addition, the magnesium concentration preferably attenuates, at a depth of 2 nm from the point where the concentration reaches the peak, to less than or equal to 30% of the peak concentration. Here, “a peak of concentration (also referred to as a peak top)” refers to the local maximum value of concentration.

In the EDX line analysis, the magnesium concentration (the detected amount of magnesium/the sum of the detected amounts of magnesium, oxygen, cobalt, fluorine, aluminum, and silicon) in the surface portion 100a is preferably higher than or equal to 0.5 atom % and lower than or equal to 10 atom %, further preferably higher than or equal to 1 atom % and lower than or equal to 5 atom %.

When the positive electrode active material 100 contains magnesium and fluorine as the additive elements, the distribution of fluorine preferably overlaps with the distribution of magnesium. For example, a difference in the depth direction between a peak of the fluorine concentration and a peak of the magnesium concentration is preferably within 10 nm, further preferably within 3 nm, still further preferably within 1 nm.

In the EDX line analysis, a peak of the fluorine concentration in the surface portion 100a is preferably observed in a region extending to a depth of 3 nm, further preferably 1 nm, still further preferably 0.5 nm, in a direction from the surface of the positive electrode active material 100 or the reference point toward the center of the positive electrode active material 100. It is further preferable that a peak of the fluorine concentration be exhibited slightly closer to the surface side than a peak of the magnesium concentration is, which increases resistance to hydrofluoric acid. For example, it is preferable that a peak of the fluorine concentration be exhibited closer to the surface side than a peak of the magnesium concentration is by 0.5 nm or more, further preferably 1.5 nm or more.

In the positive electrode active material 100 containing nickel as the additive element, a peak of the nickel concentration in the surface portion 100a is preferably observed in a region extending to a depth of 3 nm, further preferably 1 nm, still further preferably 0.5 nm, in a direction from the surface of the positive electrode active material 100 or the reference point toward the center of the positive electrode active material 100. When the positive electrode active material 100 contains magnesium and nickel, the distribution of nickel preferably overlaps with the distribution of magnesium. For example, a difference in the depth direction between a peak of the nickel concentration and a peak of the magnesium concentration is preferably within 3 nm, further preferably within 1 nm.

In the case where the positive electrode active material 100 contains aluminum as the additive element, in the EDX line analysis, the peak of the magnesium concentration, the nickel concentration, or the fluorine concentration is preferably closer to the surface than the peak of the aluminum concentration is in the surface portion 100a. For example, the peak of the aluminum concentration is preferably observed in a region extending to a depth of greater than or equal to 0.5 nm and less than or equal to 50 nm, further preferably greater than or equal to 5 nm and less than or equal to 50 nm, in a direction from the surface of the positive electrode active material 100 or the reference point toward the center of the positive electrode active material 100.

EDX line, area, or point analysis of the positive electrode active material 100 preferably reveals that the ratio of the number of magnesium (Mg) atoms to the number of cobalt (Co) atoms (Mg/Co) at a peak of the magnesium concentration is preferably greater than or equal to 0.05 and less than or equal to 0.6, further preferably greater than or equal to 0.1 and less than or equal to 0.4. The ratio of the number of aluminum (Al) atoms to the number of cobalt (Co) atoms (Al/Co) at a peak of the aluminum concentration is preferably greater than or equal to 0.05 and less than or equal to 0.6, further preferably greater than or equal to 0.1 and less than or equal to 0.45. The ratio of the number of nickel (Ni) atoms to the number of cobalt (Co) atoms (Ni/Co) at a peak of the nickel concentration is preferably greater than or equal to 0 and less than or equal to 0.2, further preferably greater than or equal to 0.01 and less than or equal to 0.1. The ratio of the number of fluorine (F) atoms to the number of cobalt (Co) atoms (F/Co) at a peak of the fluorine concentration is preferably greater than or equal to 0 and less than or equal to 1.6, further preferably greater than or equal to 0.1 and less than or equal to 1.4.

When the positive electrode active material 100 is subjected to line analysis or area analysis, the ratio of the number of atoms of an additive element A to the number of cobalt (Co) atoms (A/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30.

In the case where the additive element is magnesium, for example, when the positive electrode active material 100 is subjected to line analysis or area analysis, the ratio of the number of magnesium atoms to the number of cobalt atoms (Mg/Co) in the vicinity of the crystal grain boundary 101 is preferably greater than or equal to 0.020 and less than or equal to 0.50, further preferably greater than or equal to 0.025 and less than or equal to 0.30, still further preferably greater than or equal to 0.030 and less than or equal to 0.20. Alternatively, the ratio is preferably greater than or equal to 0.020 and less than or equal to 0.30, greater than or equal to 0.020 and less than or equal to 0.20, greater than or equal to 0.025 and less than or equal to 0.50, greater than or equal to 0.025 and less than or equal to 0.20, greater than or equal to 0.030 and less than or equal to 0.50, or greater than or equal to 0.030 and less than or equal to 0.30. When the ratio is within the above range in a plurality of portions, e.g., three or more portions of the positive electrode active material 100, it can be said that the additive element is not attached to the surface of the positive electrode active material 100 in a narrow range but widely distributed at a preferable concentration in the surface portion 100a of the positive electrode active material 100.

### <<EPMA>>

Quantitative analysis of elements can be conducted by EPMA. In area analysis, the distribution of each element can be analyzed.

EPMA area analysis of a cross section of the positive electrode active material 100 of one embodiment of the present invention preferably reveals that one or two selected from the additive elements have a concentration gradient, as in the EDX analysis. It is further preferable that the additive elements exhibit concentration peaks at different depths from the surface. The preferred ranges of the concentration peaks of the additive elements are the same as those in the case of EDX.

In EPMA, a region from a surface to a depth of approximately 1 μm is analyzed. Thus, the quantitative value of each element is sometimes different from measurement results obtained by other analysis methods. For example, when EPMA surface analysis is performed on the positive electrode active material 100, the concentration of the additive element existing in the surface portion 100a might be lower than the concentration obtained in XPS.

### <<Raman Spectroscopy>>

As described above, at least part of the surface portion 100a of the positive electrode active material 100 of one embodiment of the present invention preferably has a rock-salt crystal structure. Thus, when the positive electrode active material 100 and a positive electrode including the positive electrode active material 100 are analyzed by Raman spectroscopy, a cubic crystal structure such as a rock-salt crystal structure is preferably observed in addition to a layered rock-salt crystal structure. In a HAADF-STEM image and a nanobeam electron diffraction pattern described later, a bright spot cannot be detected when cobalt that is substituted at a lithium site, cobalt that exists at a site coordinated to four oxygen atoms, or the like does not appear with a certain frequency in the depth direction in observation. Meanwhile, Raman spectroscopy observes a vibration mode of a bond such as a Co—O bond, so that even when the number of Co—O bonds is small, a peak of a wave number of a vibration mode corresponding to cobalt can be observed in some cases. Furthermore, since Raman spectroscopy can measure a range with a several square micrometers and a depth of approximately 1 μm of a surface portion, a Co—O bond that exists only at the surface of a particle can be observed with high sensitivity.

When a laser wavelength is 532 nm, for example, peaks (vibration mode: E_{g}, A_{1g}) of LiCoO₂ having a layered rock-salt crystal structure are observed in a range from 470 cm⁻¹ to 490 cm⁻¹ and in a range from 580 cm⁻¹ to 600 cm⁻¹. Meanwhile, a peak (vibration mode: A_{1g}) of cubic CoOₓ (0<x<1) (Co_{1-y}O having a rock-salt crystal structure (0<y<1) or Co₃O₄ having a spinel structure) is observed in a range from 665 cm⁻¹ to 685 cm⁻¹.

Thus, in the case where the integrated intensities of the peak in the range from 470 cm⁻¹ to 490 cm⁻¹, the peak in the range from 580 cm⁻¹ to 600 cm⁻¹, and the peak in the range from 665 cm⁻¹ to 685 cm⁻¹ are represented by I1, I2, and I3, respectively, I3/I2 is preferably greater than or equal to 1% and less than or equal to 10%, further preferably greater than or equal to 3% and less than or equal to 9%.

In the case where a cubic crystal structure such as a rock-salt crystal structure is observed in the above-described range, it can be said that the surface portion 100a of the positive electrode active material 100 has a rock-salt crystal structure in an appropriate range.

### <<Nanobeam Electron Diffraction Pattern>>

As in Raman spectroscopy, features of both a layered rock-salt crystal structure and a rock-salt crystal structure are preferably observed in a nanobeam electron diffraction pattern. Note that in consideration of the above-described difference in sensitivity, in a STEM image and a nanobeam electron diffraction pattern, it is preferable that the features of a rock-salt crystal structure not be too significant at the surface portion 100a, in particular, the outermost surface (e.g., a region extending to a depth of 1 nm from the surface). This is because a diffusion path of lithium can be ensured and a function of stabilizing a crystal structure can be increased in the case where the additive element such as magnesium exists in the lithium layer while the outermost surface has a layered rock-salt crystal structure as compared with the case where the outermost surface is covered with a rock-salt crystal structure.

Therefore, for example, when a nanobeam electron diffraction pattern of a region that extends from the surface to a depth less than or equal to 1 nm and a nanobeam electron diffraction pattern of a region that extends from a depth from the surface of 3 nm to a depth from the surface of 10 nm are obtained, a difference between lattice constants calculated from the patterns is preferably small.

For example, a difference between lattice constants calculated from a measured portion that is at a depth less than or equal to 1 nm from the surface and a measured portion that is at a depth greater than or equal to 3 nm and less than or equal to 10 nm from the surface is preferably less than or equal to 0.1×10⁻¹ nm (a-axis) and less than or equal to 0.1×10⁻¹ nm (c-axis). The difference is further preferably less than or equal to 0.05×10⁻¹ nm (a-axis) and less than or equal to 0.6×10⁻¹ nm (c-axis), still further preferably less than or equal to 0.04×10⁻¹ nm (a-axis) and less than or equal to 0.3×10⁻¹ nm (c-axis).

### <<Surface Roughness and Specific Surface Area>>

The positive electrode active material 100 of one embodiment of the present invention preferably has a smooth surface with little unevenness. A smooth surface with little unevenness indicates that a fusing agent described later adequately functions and the surfaces of the additive element source and lithium cobalt oxide melt. Thus, a smooth surface with little unevenness indicates favorable distribution of the additive element in the surface portion 100a.

A smooth surface with little unevenness can be recognized from, for example, a cross-sectional SEM image or a cross-sectional TEM image of the positive electrode active material 100 or the specific surface area of the positive electrode active material 100.

The level of the surface smoothness of the positive electrode active material 100 can be quantified from its cross-sectional SEM image, as described below, for example.

First, the positive electrode active material 100 is processed with an FIB or the like such that its cross section is exposed. At this time, the positive electrode active material 100 is preferably covered with a protective film, a protective agent, or the like. Next, a SEM image of the interface between the positive electrode active material 100 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 100 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square (RMS) surface roughness is obtained by calculating standard deviation. This surface roughness refers to the surface roughness of part of the particle periphery (at least 400 nm) of the positive electrode active material.

On the surface of the particle of the positive electrode active material 100 of this embodiment, root-mean-square (RMS) surface roughness, which is an index of roughness, is preferably less than 3 nm, further preferably less than 1 nm, still further preferably less than 0.5 nm.

Note that the image processing software used for the noise processing, the interface extraction, or the like is not particularly limited, and for example, “ImageJ” described in Non-Patent Documents 9 to 11 can be used. In addition, the spreadsheet software or the like is not particularly limited, and Microsoft Office Excel can be used, for example.

For example, the level of surface smoothness of the positive electrode active material 100 can also be quantified from the ratio of an actual specific surface area S_{R} measured by a constant-volume gas adsorption method to an ideal specific surface area Sᵢ.

The ideal specific surface area Sᵢ is calculated on the assumption that all the particles have the same diameter as D50, have the same weight, and have ideal spherical shapes.

The median diameter D50 can be measured with a particle size analyzer or the like using a laser diffraction and scattering method. The specific surface area can be measured with a specific surface area analyzer or the like by a constant-volume gas adsorption method, for example.

In the positive electrode active material 100 of one embodiment of the present invention, the ratio of the actual specific surface area S_{R} to the ideal specific surface area Sᵢ obtained from the median diameter D50 (S_{R}/Sᵢ) is preferably less than or equal to 2.1.

Alternatively, the level of the surface smoothness of the positive electrode active material 100 can be quantified from its cross-sectional SEM image by a method as described below.

First, a surface SEM image of the positive electrode active material 100 is taken. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., ImageJ). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The value obtained by the quantification is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 100 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <Additional Features>

The positive electrode active material 100 has a depression, a crack, a concave, a V-shaped cross section, or the like in some cases. These are examples of defects, and when charging and discharging are repeated, dissolution of cobalt, breakage of a crystal structure, cracking of the positive electrode active material 100, extraction of oxygen, or the like might be derived from these defects. However, when there is the filling portion 102 in FIG. 9B that fills such defects, dissolution of cobalt or the like can be inhibited. Thus, a secondary battery that includes the positive electrode active material 100 can have improved reliability and improved cycle performance.

As described above, an excessive amount of the additive element in the positive electrode active material 100 might adversely affect insertion and extraction of lithium. The use of such a positive electrode active material 100 for a secondary battery might cause an internal resistance increase, a charge and discharge capacity decrease, and the like. Meanwhile, when the amount of the additive element is insufficient, the additive element is not distributed throughout the surface portion 100a, which might diminish the effect of inhibiting degradation of a crystal structure. The additive element is required to be contained in the positive electrode active material 100 at an appropriate concentration; however, the adjustment of the concentration is not easy.

For this reason, in the positive electrode active material 100, when the region where the additive element is unevenly distributed is included, some excess atoms of the additive element are removed from the inner portion 100b of the positive electrode active material 100, so that the additive element concentration can be appropriate in the inner portion 100b. This can inhibit an internal resistance increase, a charge and discharge capacity decrease, and the like when the positive electrode active material 100 is used for a secondary battery. A feature of inhibiting an internal resistance increase in a secondary battery is extremely preferable especially in charging and discharging with a large amount of current such as charging and discharging at 400 mA/g or more.

In the positive electrode active material 100 including the region where the additive element is unevenly distributed, addition of excess additive elements to some extent in the formation process is acceptable. This is preferable because the margin of production can be increased.

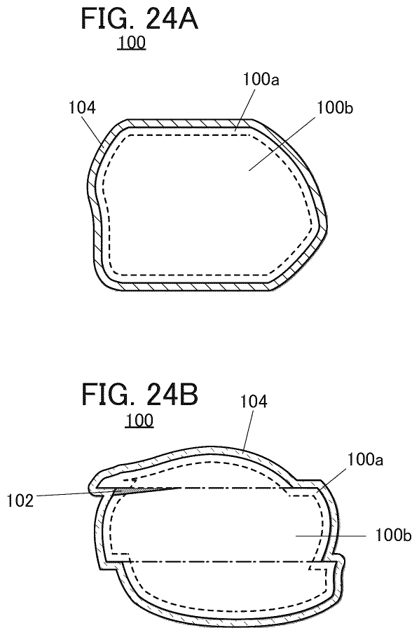

A coating portion may be attached to at least part of the surface of the positive electrode active material 100. FIGS. 24A and 24B illustrate examples of the positive electrode active material 100 to which the coating portion 104 is attached.

The coating portion 104 is preferably formed by deposition of a decomposition product of an electrolyte and an organic electrolyte solution due to charging and discharging, for example. A coating portion originating from an electrolyte solution, which is formed on the surface of the positive electrode active material 100, is expected to improve charge and discharge cycle performance particularly when charging making x in LiₓCoO₂ be 0.24 or less is repeated. This is because an increase in impedance of the surface of the positive electrode active material is inhibited or dissolution of cobalt is inhibited, for example. The coating portion 104 preferably contains carbon, oxygen, and fluorine, for example. The coating portion can have high quality easily when the electrolyte solution includes LiBOB and/or suberonitrile (SUN), for example. Accordingly, the coating portion 104 preferably contains one or more selected from boron, nitrogen, sulfur, and fluorine to possibly have high quality. The coating portion 104 does not necessarily cover the positive electrode active material 100 entirely. For example, the coating portion 104 covers greater than or equal to 50%, preferably greater than or equal to 70%, further preferably greater than or equal to 90% of the surface of the positive electrode active material 100.

### <<Powder Resistivity>>

The positive electrode active material 100 of one embodiment of the present invention has a stable crystal structure even at a high voltage. The stable crystal structure of the positive electrode active material in a charged state can suppress a charge and discharge capacity decrease due to repeated charging and discharging. In <<XRD>>, the positive electrode active material 100 having an excellent characteristics as described above has a feature of having the O3′ type structure and/or the monoclinic O1(15) type structure when x in LiₓCoO₂ is small. In <<EDX>>, the preferable distribution of the additive elements when the positive electrode active material 100 is subjected to the STEM-EDX analysis is described. Furthermore, the positive electrode active material 100 of one embodiment of the present invention also has a feature in the volume resistivity of powder.

As the feature of the positive electrode active material 100 of one embodiment of the present invention, the volume resistivity of the powder thereof is preferably higher than or equal to 1.0×10⁴ Ω·cm, further preferably higher than or equal to 1.0×10⁵ Ω·cm, still further preferably higher than or equal to 1.0×10⁶ Ω·cm under a pressure of 64 MPa. The volume resistivity of the powder of the positive electrode active material 100 of one embodiment of the present invention is preferably lower than or equal to 1.0×10⁹ Ω·cm, further preferably lower than or equal to 1.0×10⁸ Ω·cm, still further preferably lower than or equal to 1.0×10⁷ Ω·cm under a pressure of 64 MPa.

The positive electrode active material 100 with the above volume resistivity has a stable crystal structure at a high voltage. Thus, the volume resistivity of the powder of the positive electrode active material 100 falling within the above-described range can indicate the favorable formation of the surface portion 100a, which is an important factor for a stable crystal structure of the positive electrode active material in a charged state. In other words, it is preferable that the surface portion 100a have high resistance.

Note that a battery reaction might be hindered in the case where a high-resistance region extends from the surface of the positive electrode active material 100 toward the inner portion thereof to have a large thickness. It is thus further preferable that only a thin region near the surface of the surface portion 100a have high resistance. That is, a high-resistance region preferably extends from the surface toward the inner portion to have a small thickness in the surface portion 100a.

This embodiment can be implemented in combination with any of the other embodiments.

### Embodiment 3

In this embodiment, an example of a formation method of a positive electrode active material that can be used for a positive electrode of the battery of one embodiment of the present invention is described.

A way of adding an additive element is important in forming the positive electrode active material 100 having the distribution of the additive element, the composition, and/or the crystal structure that were/was described in the above embodiment. Favorable crystallinity of the inner portion 100b is also important.

Thus, in the formation process of the positive electrode active material 100, it is preferred that lithium cobalt oxide be synthesized first, and then an additive element source be mixed and heat treatment be performed.

In a method of synthesizing lithium cobalt oxide containing an additive element by mixing an additive element source concurrently with a cobalt source and a lithium source, it is sometimes difficult to increase the concentration of the additive element in the surface portion 100a. In addition, after lithium cobalt oxide is synthesized, only mixing an additive element source without performing heating causes the additive element to be just attached to, not dissolved in, the lithium cobalt oxide. It is difficult to distribute the additive element favorably without sufficient heating. Therefore, it is preferable that lithium cobalt oxide be synthesized, and then an additive element source be mixed and heat treatment be performed. The heat treatment after mixing of the additive element source may be referred to as annealing.

However, annealing at an excessively high temperature may cause cation mixing, which increases the possibility of entry of the additive element such as magnesium into the cobalt sites. Magnesium that exists at the cobalt sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

In view of the above, a material functioning as a fusing agent is preferably mixed together with the additive element source. A material having a lower melting point than lithium cobalt oxide can be regarded as a material functioning as a fusing agent. For example, a fluorine compound such as lithium fluoride is preferably used. Addition of a fusing agent lowers the melting points of the additive element source and lithium cobalt oxide. Lowering the melting points makes it easier to distribute the additive element favorably at a temperature at which cation mixing is less likely to occur.

### [Initial Heating]

It is further preferable that heat treatment be performed between the synthesis of the lithium cobalt oxide and the mixing of the additive element. This heating is referred to as initial heating in some cases.

Since lithium is extracted from part of the surface portion 100a of the lithium cobalt oxide by the initial heating, the distribution of the additive element becomes more favorable.

Specifically, the distributions of the additive elements can be easily made different from each other by the initial heating in the following mechanism. First, lithium is extracted from part of the surface portion 100a by the initial heating. Next, additive element sources such as a nickel source, an aluminum source, and a magnesium source and lithium cobalt oxide including the surface portion 100a that is deficient in lithium are mixed and heated. Among the additive elements, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed. Note that this phase is formed in part of the surface portion 100a, and thus is sometimes not clearly observed in an image obtained with an electron microscope, such as a STEM image, and an electron diffraction pattern.

Among the additive elements, nickel is likely to form a solid solution and is diffused to the inner portion 100b in the case where the surface portion 100a is lithium cobalt oxide having a layered rock-salt crystal structure, but nickel is likely to remain in the surface portion 100a in the case where part of the surface portion 100a has a rock-salt crystal structure. Thus, the initial heating can make it easy for a divalent additive element such as nickel to remain in the surface portion 100a. The effect of this initial heating is large particularly at the surface having an orientation other than the (001) orientation of the positive electrode active material 100 and the surface portion 100a thereof.

Furthermore, in such a rock-salt crystal structure, the bond distance between a metal Me and oxygen (Me-O distance) tends to be longer than that in a layered rock-salt crystal structure.

For example, Me-O distance is 2.09×10⁻¹ nm and 2.11×10⁻¹ nm in Ni_{0.5}Mg_{0.5}O having a rock-salt crystal structure and MgO having a rock-salt crystal structure, respectively. Even when a spinel phase is formed in part of the surface portion 100a, Me-O distance is 2.0125×10⁻¹ nm and 2.02×10⁻¹ nm in NiAl₂O₄ having a spinel structure and MgAl₂O₄ having a spinel structure, respectively. In each case, Me-O distance is longer than 2×10⁻¹ nm.

Meanwhile, in a layered rock-salt crystal structure, the bond distance between oxygen and a metal other than lithium is shorter than the above-described distance. For example, Al—O distance is 1.905×10⁻¹ nm (Li—O distance is 2.11×10⁻¹ nm) in LiAlO₂ having a layered rock-salt crystal structure. In addition, Co—O distance is 1.9224×10⁻¹ nm (Li—O distance is 2.0916×10⁻¹ nm) in LiCoO₂ having a layered rock-salt crystal structure.

According to Shannon's ionic radii (Non-Patent Document 1), the ion radius of hexacoordinated aluminum and the ion radius of hexacoordinated oxygen are 0.535×10⁻¹ nm and 1.4×10⁻¹ nm, respectively, and the sum of these values is 1.935×10⁻¹ nm.

From the above, aluminum is considered to exist at a site other than a lithium site more stably in a layered rock-salt crystal structure than in a rock-salt crystal structure. Thus, in the surface portion 100a, aluminum is more likely to be distributed in, than in a region having a rock-salt phase that is close to the surface, a region having a layered rock-salt phase at a larger depth and/or the inner portion 100b.

Moreover, the initial heating is expected to increase the crystallinity of the layered rock-salt crystal structure of the inner portion 100b.

For this reason, the initial heating is preferably performed in order to form the positive electrode active material 100 that has the monoclinic O1(15) type structure when x in LiₓCoO₂ is, for example, greater than or equal to 0.15 and less than or equal to 0.17.

However, the initial heating is not necessarily performed. In some cases, by controlling atmosphere, temperature, time, or the like in another heating step, e.g., annealing, the positive electrode active material 100 that has the O3′ type structure and/or the monoclinic O1(15) type structure when x in LiₓCoO₂ is small can be formed.

### <<Formation Method 1 of Positive Electrode Active Material>>

A formation method 1 of the positive electrode active material 100, in which annealing and the initial heating are performed, is described with reference to FIGS. 25A to 25C.

### <Step S11>

In Step S11 shown in FIG. 25A, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used and for example, cobalt hydroxide, cobalt oxide such as tricobalt tetroxide, or the like can be used.

The cobalt source preferably has a high purity and is preferably a material having a purity higher than or equal to 3N (99.9%), further preferably higher than or equal to 4N (99.99%), still further preferably higher than or equal to 4N5 (99.995%) yet still further preferably higher than or equal to 5N (99.999%), for example. Impurities of the positive electrode active material can be controlled by using such a high-purity material. As a result, a secondary battery with increased capacity and/or increased reliability can be obtained.

Furthermore, the cobalt source preferably has high crystallinity and for example, the cobalt source preferably includes single crystal grains. The crystallinity of the cobalt source can be evaluated with a TEM image, an STEM image, a HAADF-STEM image, or an ABF-STEM image or by XRD, electron diffraction, neutron diffraction, or the like. Note that the above methods for evaluating crystallinity can also be employed to evaluate the crystallinity of materials other than the cobalt source.

### <Step S12>

Next, in Step S12 shown in FIG. 25A, the lithium source and the cobalt source are ground and mixed to form a mixed material. The grinding and mixing can be performed by a dry method or a wet method. A wet method is preferred because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the cobalt source be mixed into dehydrated acetone whose moisture content is less than or equal to 10 ppm and which has a purity higher than or equal to 99.5% in the grinding and mixing. With the use of dehydrated acetone with the above-described purity, impurities that might be mixed can be reduced.

A ball mill, a bead mill, or the like can be used for the grinding and mixing. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the grinding and mixing are performed at a peripheral speed of 838 mm/s (the number of rotations: 400 rpm, the ball mill diameter: 40 mm).

### <Step S13>

Next, in Step S13 shown in FIG. 25A, the above mixed material is heated. The heating is preferably performed at higher than or equal to 800° C. and lower than or equal to 1100° C., further preferably at higher than or equal to 900° C. and lower than or equal to 1000° C., still further preferably at approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

When the heating time is too short, lithium cobalt oxide is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 parts per billion (ppb).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as “flowing”.

In the case where the heating atmosphere is an oxygen-containing atmosphere, flowing is not necessarily performed. For example, a method may be employed in which the pressure in the reaction chamber is reduced, the reaction chamber is filled (or “purged”) with oxygen, and the exit and entry of the oxygen are prevented. For example, the pressure in the reaction chamber may be reduced to −970 hPa and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible used at the time of the heating is preferably made of aluminum oxide. An aluminum oxide crucible is made of a material that hardly releases impurities. In this embodiment, a crucible made of aluminum oxide with a purity of 99.9% is used. The heating is preferably performed with the crucible covered with a lid, in which case volatilization of a material can be prevented.

A used crucible is preferable to a new crucible. In this specification and the like, anew crucible refers to a crucible that is subjected to heating two or less times while a material containing lithium, the transition metal M, and/or the additive element is contained therein. A used crucible refers to a crucible that is subjected to heating three or more times while a material containing lithium, the transition metal M, and/or the additive element is contained therein. In the case where a new crucible is used, some materials such as lithium fluoride might be absorbed by, diffused in, transferred to, and/or attached to a sagger. Lost of some materials due to such phenomena increases a concern that an element is not distributed in a preferred range particularly in the surface portion of the positive electrode active material. In contrast, such a risk is low in the case of a used crucible.

The heated material is ground as needed and may be made to pass through a sieve. Before collection of the heated material, the material may be moved from the crucible to a mortar. As the mortar, an aluminum oxide mortar can be suitably used. An aluminum oxide mortar is made of a material that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 25A.

Although the example is described in which the composite oxide is formed by a solid phase method as in Steps S11 to S14, the composite oxide may be formed by a coprecipitation method. Alternatively, the composite oxide may be formed by a hydrothermal method.

### <Step S15>

Next, as Step S15 shown in FIG. 25A, the lithium cobalt oxide is heated. The heating in Step S15 is the first heating performed on the lithium cobalt oxide and thus, this heating is sometimes referred to as the initial heating. The heating is performed before Step S20 described below and thus is sometimes referred to as preheating or pretreatment.

By the initial heating, lithium is extracted from part of the surface portion 100a of the lithium cobalt oxide as described above. In addition, an effect of increasing the crystallinity of the inner portion 100b can be expected. The lithium source and/or cobalt source prepared in Step S11 and the like might contain impurities. The initial heating can reduce impurities in the lithium cobalt oxide obtained in Step S14.

Furthermore, through the initial heating, the surface of the lithium cobalt oxide becomes smooth. The lithium cobalt oxide having a smooth surface refers to the composite oxide having little unevenness and rounded as a whole with its corner portion rounded. A smooth surface refers to a surface to which few foreign substances are attached. Foreign substances are deemed to cause unevenness and are preferably not attached to a surface.

For the initial heating, a lithium source is not needed. Alternatively, an additive element source is not needed. Alternatively, a material functioning as a fusing agent is not needed.

When the heating time in this step is too short, an efficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature higher than or equal to 700° C. and lower than or equal to 1000° C. for longer than or equal to 2 hours and shorter than or equal to 20 hours.

The effect of increasing the crystallinity of the internal portion 100b is, for example, an effect of reducing distortion, a shift, or the like derived from differential shrinkage or the like of the lithium cobalt oxide formed in Step S13.

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth, or “surface improvement is achieved”. In other words, it is deemed that Step S15 reduces the differential shrinkage caused in the lithium cobalt oxide to make the surface of the composite oxide smooth.

Such differential shrinkage might cause a micro shift in the lithium cobalt oxide such as a shift in a crystal. To reduce the shift, this step is preferably performed. Performing this step can distribute a shift uniformly in the composite oxide. When the shift is distributed uniformly, the surface of the composite oxide might become smooth, or “crystal grains might be aligned”. In other words, it is deemed that Step S15 reduces the shift in a crystal or the like which is caused in the composite oxide to make the surface of the composite oxide smooth.

In a secondary battery including lithium cobalt oxide with a smooth surface as a positive electrode active material, degradation by charging and discharging is suppressed and cracking of the positive electrode active material can be prevented.

Note that pre-synthesized lithium cobalt oxide may be used in Step S14. In this case, Steps S11 to S13 can be skipped. When Step S15 is performed on the pre-synthesized lithium cobalt oxide, lithium cobalt oxide with a smooth surface can be obtained.

### <Step S20>

Next, as shown in Step S20, the additive element A is preferably added to the lithium cobalt oxide that has been subjected to the initial heating. When the additive element A is added to the lithium cobalt oxide that has been subjected to the initial heating, the additive element A can be uniformly added. It is thus preferable that the initial heating precede the addition of the additive element A. The step of adding the additive element A is described with reference to FIGS. 25B and 25C.

### <Steps S21 to S23>

The steps of preparing an additive element A source (A source) are described with reference to FIGS. 25B and 25C. A lithium source may be prepared in addition to the additive element A source.

As the additive element A, the additive element described in the above embodiment can be used. Specifically, one or more selected from magnesium, fluorine, nickel, aluminum, titanium, zirconium, vanadium, iron, manganese, chromium, niobium, arsenic, zinc, silicon, sulfur, phosphorus, and boron can be used. Furthermore, one or both of bromine and beryllium can be used.

### <Step S21>

Step S21 shown in FIG. 25B is described. When magnesium is selected as the additive element, the additive element source can be referred to as a magnesium source (Mg source). As the magnesium source, magnesium fluoride, magnesium oxide, magnesium hydroxide, magnesium carbonate, or the like can be used. Two or more of these magnesium sources may be used.

When fluorine is selected as the additive element, the additive element source can be referred to as a fluorine source (F source). As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used also as the lithium source. Another example of the lithium source that can be used in Step S21 is lithium carbonate.

The fluorine source may be a gas; for example, fluorine (F₂), carbon fluoride, sulfur fluoride, oxygen fluoride (e.g., OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride (LiF) and magnesium fluoride (MgF₂) are mixed at a molar ratio of approximately 65:35, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride (LiF:MgF₂) is preferably x:1 (0≤x≤1.9), further preferably x:1 (0.1≤x≤0.5), still further preferably x:1 (x=0.33 or an approximate value thereof). Note that in this specification and the like, “an approximate value of a given value” means a value greater than 0.9 times and less than 1.1 times the given value.

### <Step S22>

Next, in Step S22 shown in FIG. 25B, the magnesium source and the fluorine source are ground and mixed. Any of the conditions for the grinding and mixing that are described for Step S12 can be selected to perform Step S22.

### <Step S23>

Next, in Step S23 shown in FIG. 25B, the materials ground and mixed in the above step are collected to give the additive element A source (A source). Note that the additive element A source in Step S23 contains a plurality of starting materials and can be referred to as a mixture.

As for the particle diameter of the mixture, its median diameter (D50) is preferably greater than or equal to 600 nm and less than or equal to 10 μm, further preferably greater than or equal to 1 μm and less than or equal to 5 μm. Also when one kind of material is used as the additive element source, the median diameter (D50) is preferably greater than or equal to 600 nm and less than or equal to 10 μm, further preferably greater than or equal to 1 μm and less than or equal to 5 μm.

Such a pulverized mixture (which may contain only one kind of the additive element) is easily attached to the surface of a lithium cobalt oxide particle uniformly in a later step of mixing with the lithium cobalt oxide. The mixture is preferably attached uniformly to the surface of the lithium cobalt oxide particle, in which case the additive element is easily distributed or dispersed uniformly in the surface portion 100a of the composite oxide after heating.

### <Step S21>

A process different from that in FIG. 25B is described with reference to FIG. 25C. In Step S21 shown in FIG. 25C, four kinds of additive element sources to be added to the lithium cobalt oxide are prepared. In other words, FIG. 25C is different from FIG. 25B in the kinds of the additive element sources. A lithium source may be prepared together with the additive element sources.

As the four kinds of additive element sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 25B. As the nickel source, nickel oxide, nickel hydroxide, or the like can be used. As the aluminum source, aluminum oxide, aluminum hydroxide, or the like can be used.

### <Steps S22 and S23>

Step S22 and Step S23 shown in FIG. 25C are similar to the steps described with reference to FIG. 25B.

### <Step S31>

Next, in Step S31 shown in FIG. 25A, the lithium cobalt oxide and the additive element A source (A source) are mixed. The ratio of the number of cobalt (Co) atoms in the lithium cobalt oxide to the number of magnesium (Mg) atoms in the additive element A source (Co: Mg) is preferably 100:y (0.1≤y≤6), further preferably 100:y (0.3≤y≤3).

The mixing in Step S31 is preferably performed under milder conditions than the mixing in Step S12, in order not to damage the shapes of the lithium cobalt oxide particles. For example, a condition with a smaller number of rotations or a shorter time than that for the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 25A, the materials mixed in the above step are collected, whereby a mixture 903 is obtained. At the time of the collection, the materials may be crushed as needed and made to pass through a sieve.

Note that although FIGS. 25A to 25C show the formation method in which the addition of the additive element is performed only after the initial heating, the present invention is not limited to the above-described method. The addition of the additive element may be performed at another timing or may be performed a plurality of times. The timing of the addition may be different between the elements.

For example, the additive element may be added to the lithium source and the cobalt source in Step S11, i.e., at the stage of the starting materials of the composite oxide. Then, lithium cobalt oxide containing the additive element can be obtained in Step S13. In that case, there is no need to separately perform Steps S11 to S14 and Steps S21 to S23, so that the method is simplified and enables increased productivity.

Alternatively, lithium cobalt oxide that contains some of the additive elements in advance may be used. When lithium cobalt oxide to which magnesium and fluorine are added is used, for example, part of the processes in Steps S11 to S14 and Step S20 can be skipped, so that the method is simplified and enables increased productivity.

Alternatively, after the heating in Step S15, to lithium cobalt oxide to which magnesium and fluorine are added in advance, a magnesium source and a fluorine source, or a magnesium source, a fluorine source, a nickel source, and an aluminum source may be added as in Step S20.

### <Step S33>

Then, in Step S33 shown in FIG. 25A, the mixture 903 is heated. Any of the heating conditions described for Step S13 can be selected. The heating time is preferably longer than or equal to 2 hours. Here, the pressure in a furnace may be higher than atmospheric pressure to make the oxygen partial pressure of the heating atmosphere high. An insufficient oxygen partial pressure of the heating atmosphere might cause reduction of cobalt or the like and prevent the lithium cobalt oxide or the like from maintaining a layered rock-salt crystal structure.

Here, a supplementary explanation of the heating temperature is provided. The lower limit of the heating temperature in Step S33 needs to be higher than or equal to the temperature at which a reaction between the lithium cobalt oxide and the additive element source proceeds. The temperature at which the reaction proceeds is the temperature at which interdiffusion of the elements included in the lithium cobalt oxide and the additive element source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 650° C.

Needless to say, the reaction more easily proceeds at a temperature higher than or equal to the temperature at which one or more selected from the materials contained in the mixture 903 are melted. For example, in the case where LiF and MgF₂ are included as the additive element sources, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in DSC measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of the lithium cobalt oxide might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 650° C. and lower than or equal to 1130° C., further preferably higher than or equal to 650° C. and lower than or equal to 1000° C., still further preferably higher than or equal to 650° C. and lower than or equal to 950° C., yet still further preferably higher than or equal to 650° C. and lower than or equal to 900° C. Furthermore, the heating temperature in Step S33 is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature in Step S33 is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably higher than that in Step S13.

In addition, at the time of heating the mixture 903, the partial pressure of fluorine or a fluoride originating from the fluorine source or the like is preferably controlled to be within an appropriate range.

In the formation method described in this embodiment, some of the materials, e.g., LiF as the fluorine source, function as a fusing agent in some cases. Owing to the material functioning as a fusing agent, the heating temperature can be lower than the decomposition temperature of the lithium cobalt oxide, e.g., higher than or equal to 742° C. and lower than or equal to 950° C., which allows distribution of the additive element such as magnesium in the surface portion and formation of a positive electrode active material having favorable characteristics.

However, since LiF in a gas phase has a specific gravity less than that of oxygen, the heating might volatilize or sublimate LiF. In the case where LiF is volatilized, LiF in the mixture 903 decreases. As a result, the function of a fusing agent is degraded. Therefore, the heating needs to be performed while volatilization of LiF is inhibited. Note that even when LiF is not used as the fluorine source or the like, Li at the surface of LiCoO₂ and F of the fluorine source might react to produce LiF, which might be volatilized. Therefore, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and block a path of diffusion of the additive element (e.g., fluorine), thereby hindering distribution of the additive element (e.g., magnesium and fluorine) in the surface portion.

It is considered that uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the flow rate of an oxygen-containing atmosphere in the kiln is preferably controlled during the heating. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container in which the mixture 903 is put covered with a lid.

A supplementary explanation of the heating time is provided. The heating time depends on conditions such as the heating temperature and the particle size and composition of the lithium cobalt oxide in Step S14. The heating may be preferably performed at a lower temperature or for a shorter time in the case where the particle size of the lithium cobalt oxide is small than in the case where the particle size is large.

In the case where the lithium cobalt oxide in Step S14 in FIG. 25A has a median diameter (D50) of approximately 12 μm, the heating temperature is preferably higher than or equal to 650° C. and lower than or equal to 950° C., for example. The heating time is preferably longer than or equal to 3 hours and shorter than or equal to 60 hours, further preferably longer than or equal to 10 hours and shorter than or equal to 30 hours, still further preferably approximately 20 hours, for example. Note that the time for lowering the temperature after the heating is preferably longer than or equal to 10 hours and shorter than or equal to 50 hours, for example.

In the case where the lithium cobalt oxide in Step S14 has a median diameter (D50) of approximately 5 μm, the heating temperature is preferably higher than or equal to 650° C. and lower than or equal to 950° C., for example. The heating time is preferably longer than or equal to 1 hour and shorter than or equal to 10 hours, further preferably approximately 5 hours, for example. Note that the time for lowering the temperature after the heating is preferably longer than or equal to 10 hours and shorter than or equal to 50 hours, for example.

### <Step S34>

Next, the heated material is collected in Step S34 shown in FIG. 25A, in which crushing is performed as needed; thus, the positive electrode active material 100 is obtained. Here, the collected particles are preferably made to pass through a sieve. Through the above process, the positive electrode active material 100 of one embodiment of the present invention can be formed. The positive electrode active material of one embodiment of the present invention has a smooth surface.

### <<Formation Method 2 of Positive Electrode Active Material>>

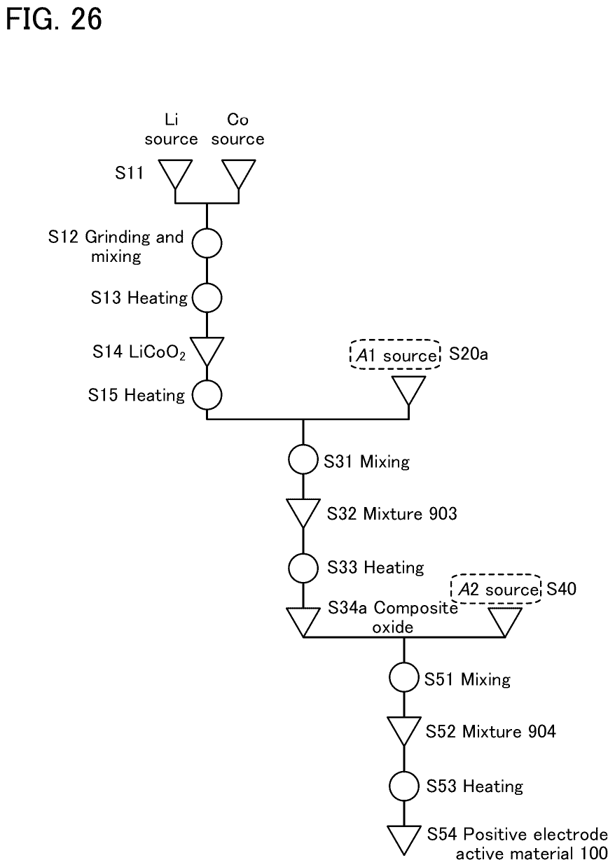

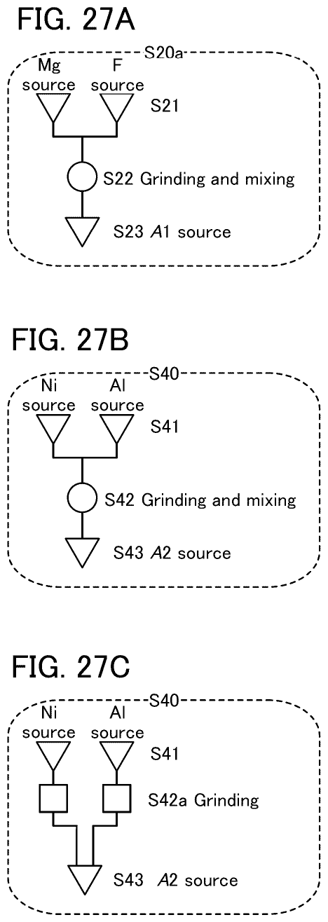

Next, as one embodiment of the present invention, a formation method 2 of a positive electrode active material, which is different from the formation method 1 of a positive electrode active material, is described with reference to FIG. 26 and FIGS. 27A to 27C. The formation method 2 of a positive electrode active material is different from the formation method 1 mainly in the number of times of adding the additive element and a mixing method. For the description except for the above, the description of the formation method 1 of a positive electrode active material can be referred to.

Steps S11 to S15 in FIG. 26 are performed as in FIG. 25A to prepare lithium cobalt oxide that has been subjected to the initial heating.

### <Step S20a>

Next, in Step S20a, an additive element A1 source used to add an additive element A1 to the lithium cobalt oxide that has been subjected to the initial heating is prepared. The steps of preparing the additive element A1 source are described with reference to FIG. 24A.

### <Step S21>

Step S21 shown in FIG. 27A is described. The additive element A1 source can be selected from the elements that are given as the examples of the additive element A described for Step S21 with reference to FIG. 25B. For example, one or more elements selected from magnesium, fluorine, and calcium can be suitably used as the additive element A1. FIG. 27A shows an example in which magnesium and fluorine are selected as the additive elements A1 and a magnesium source (Mg source) and a fluorine source (F source) are prepared in Step S21.

Steps S21 to S23 shown in FIG. 27A can be performed under conditions similar to those of Steps S21 to S23 shown in FIG. 25B, whereby the additive element A1 source (A1 source) can be obtained in Step S23.

Steps S31 to S33 shown in FIG. 26 can be performed in a manner similar to that of Steps S31 to S33 shown in FIG. 25A.

### <Step S34a>

Next, the material heated in Step S33 is collected to give lithium cobalt oxide containing the additive element A1. This composite oxide is called a second composite oxide to be distinguished from the composite oxide in Step S14.

### <Step S40>

In Step S40 shown in FIG. 26, an additive element A2 source used to add an additive element A2 to the second composite oxide is prepared. The steps of preparing the additive element A2 source are described with reference to FIGS. 27B and 27C.

### <Step S41>

Step S41 shown in FIG. 27B is described. The additive element A2 can be selected from the elements that are given as the examples of the additive element A described for Step S21 with reference to FIG. 25B. For example, one or more elements selected from nickel, titanium, boron, zirconium, and aluminum can be suitably used as the additive element A2. FIG. 27B shows an example in which nickel and aluminum are selected as the additive elements A2 and a nickel source (Ni source) and an aluminum source (Al source) are prepared.

Steps S41 to S43 shown in FIG. 27B can be performed under conditions similar to those of Steps S21 to S23 shown in FIG. 25B, whereby the additive element A2 source (A2 source) can be obtained in Step S43.

FIG. 27C shows a variation example of the steps of preparing the additive element A2 source which are described with reference to FIG. 27B. A nickel source (Ni source) and an aluminum source (Al source) are prepared in Step S41 shown in FIG. 27C and are separately ground in Step S42a. Accordingly, a plurality of the additive element A2 sources (A2 sources) are prepared in Step S43. FIG. 27C is different from FIG. 27B in separately grinding the additive elements in Step S42a.

### <Steps S51 to S53>

Next, Steps S51 to S53 shown in FIG. 26 can be performed under conditions similar to those of Steps S31 to S34 shown in FIG. 25A. In Step S52, a mixture 904 is obtained. The heating in Step S53 may be performed at a lower temperature and for a shorter time than the heating in Step S33. Through the above process, the positive electrode active material 100 of one embodiment of the present invention can be formed in Step S54. The positive electrode active material of one embodiment of the present invention has a smooth surface.

As shown in FIG. 26 and FIGS. 27A to 27C, in the formation method 2, introduction of the additive elements to the lithium cobalt oxide is separated into introduction of the additive element A1 and that of the additive element A2. When the additive elements are separately introduced, the distribution of the additive elements in the depth direction can be changed. For example, the additive element A1 can be added such that its concentration is higher in the surface portion 100a than in the inner portion 100b, and the additive element A2 can be added such that its concentration is higher in the inner portion 100b than in the surface portion 100a.

The initial heating described in this embodiment makes it possible to obtain a positive electrode active material having a smooth surface.

The initial heating described in this embodiment is performed on lithium cobalt oxide. Thus, the initial heating is preferably performed at a temperature lower than the heating temperature for forming the lithium cobalt oxide and for a time shorter than the heating time for forming the lithium cobalt oxide. The additive element is preferably added to the lithium cobalt oxide after the initial heating. The adding step may be separated into two or more steps. Such an order of steps is preferred in order to maintain the smoothness of the surface achieved by the initial heating.

The positive electrode active material 100, whose surface is smooth, may be less likely to be physically broken by pressure application or the like than a positive electrode active material whose surface is not smooth. For example, the positive electrode active material 100 is unlikely to be broken in a test involving pressure application such as a nail penetration test, meaning that the positive electrode active material 100 has high safety.

This embodiment can be implemented in combination with any of the other embodiments.

### Embodiment 4

In this embodiment, a positive electrode active material that can be used for a positive electrode of the battery of one embodiment of the present invention is described.

Lithium cobalt oxide including a barrier film (the surface portion 100a) is described as the positive electrode active material 100 that can be used for the positive electrode of the battery of one embodiment of the present invention is described in Embodiment 1. The positive electrode active material used in the battery of one embodiment of the present invention is not limited to lithium cobalt oxide including a barrier film, and a positive electrode active material including a barrier film, represented by LiₓMO₂, can be used. Note that M is one or more selected from Co, Ni, Mn, and Al. The positive electrode active material represented by LiₓMO₂ has a layered rock-salt crystal structure belonging to the space group R-3m.

As the positive electrode active material represented by LiₓMO₂, one or more of lithium cobalt oxide, lithium cobalt-nickel oxide, lithium nickel-cobalt-manganese oxide, lithium nickel-cobalt-aluminum oxide, and lithium nickel-manganese-aluminum oxide can be used.

As the lithium cobalt-nickel oxide, for example, lithium cobalt-nickel oxide to which magnesium and fluorine are added can be used. It is preferable to use lithium cobalt-nickel oxide to which magnesium, fluorine, and aluminum are added. Note that in lithium cobalt-nickel oxide, the number of cobalt atoms is larger than that of nickel atoms.

As the lithium nickel-cobalt-manganese oxide, for example, lithium nickel-cobalt-manganese oxide with an atomic ratio of nickel:cobalt:manganese=1:1:1, 5:2:3, 6:2:2, 8:1:1, or 9:0.5:0.5 or the vicinity thereof can be used.

As the feature of LiₓMO₂ including a barrier film, the volume resistivity of powder is preferably higher than or equal to 1.0×10⁴ Ω·cm, further preferably higher than or equal to 1.0×10⁵ Ω·cm, still further preferably higher than or equal to 1.0×10⁶ Ω·cm under a pressure of 64 MPa. The volume resistivity of the powder is preferably lower than or equal to 1.0×10⁹ Ω·cm, further preferably lower than or equal to 1.0×10⁸ Ω·cm, still further preferably lower than or equal to 1.0×10⁷ Ω·cm under a pressure of 64 MPa.

The positive electrode active material with the above volume resistivity has a stable crystal structure at a high voltage, and can indicate the favorable formation of a surface portion, which is an important factor for a stable crystal structure of a positive electrode active material in a charged state. In other words, it is preferable that the surface portion have high resistance.

Note that a battery reaction might be hindered in the case where a high-resistance region extends from the surface of the positive electrode active material toward the inner portion thereof to have a large thickness. It is thus further preferable that only a thin region near the surface of the surface portion have high resistance. That is, a high-resistance region preferably extends from the surface toward the inner portion to have a small thickness in the surface portion.

This embodiment can be implemented in combination with any of the other embodiments.

### Embodiment 5

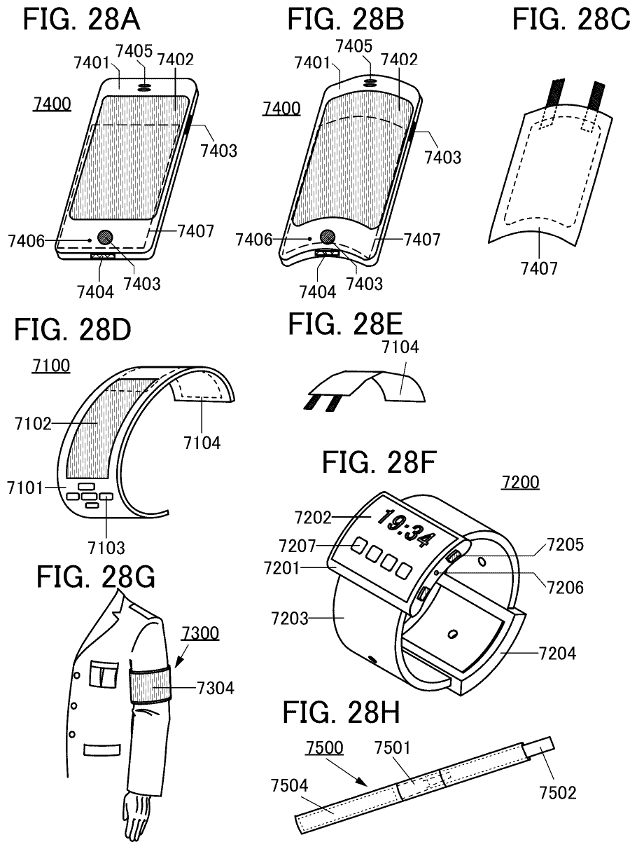

In this embodiment, examples of electronic devices each including the secondary battery of one embodiment of the present invention are described with reference to FIGS. 28A to 28H, FIGS. 29A to 29D, and FIGS. 30A to 30C.

FIGS. 28A to 28G show examples of electronic devices each including the secondary battery containing a positive electrode active material described in the above embodiment. Examples of electronic devices each including a secondary battery include television devices (also referred to as televisions or television receivers), monitors of computers or the like, digital cameras, digital video cameras, digital photo frames, cellular phones (also referred to as mobile phones or mobile phone devices), portable game machines, portable information terminals, audio reproducing devices, and large game machines such as pachinko machines.

A flexible secondary battery can also be incorporated along a curved inside/outside wall surface of a house, a building, or the like or a curved interior/exterior surface of an automobile.

FIG. 28A illustrates an example of a mobile phone. A mobile phone 7400 is provided with a display portion 7402 incorporated in a housing 7401, operation buttons 7403, an external connection port 7404, a speaker 7405, a microphone 7406, and the like. The mobile phone 7400 includes a secondary battery 7407. By using the secondary battery of one embodiment of the present invention as the secondary battery 7407, a lightweight long-life mobile phone can be provided.

FIG. 28B illustrates the mobile phone 7400 in a state of being bent. When the whole mobile phone 7400 is bent by the external force, the secondary battery 7407 included in the mobile phone 7400 is also bent. FIG. 28C illustrates the secondary battery 7407 that is being bent at that time. The secondary battery 7407 is a thin storage battery. The secondary battery 7407 is fixed in a state of being bent. The secondary battery 7407 includes a lead electrode electrically connected to a current collector.

FIG. 28D illustrates an example of a bangle-type display device. A portable display device 7100 includes a housing 7101, a display portion 7102, operation buttons 7103, and a secondary battery 7104. FIG. 28E illustrates the secondary battery 7104 that is being bent. When the display device is worn on a user's arm while the secondary battery 7104 is bent, the housing changes its shape and the curvature of part or the whole of the secondary battery 7104 is changed. Note that the radius of curvature of a curve at a point refers to the radius of the circular arc that best approximates the curve at that point. The reciprocal of the radius of curvature is curvature. Specifically, part or the whole of the housing or the main surface of the secondary battery 7104 is changed with a radius of curvature in the range of 40 mm to 150 mm. When the radius of curvature of the main surface of the secondary battery 7104 ranges from 40 mm to 150 mm, the reliability can be kept high. By using the secondary battery of one embodiment of the present invention as the secondary battery 7104, a lightweight long-life portable display device can be provided.

FIG. 28F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, an application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by the operating system incorporated in the portable information terminal 7200.

The portable information terminal 7200 can employ near field communication based on an existing communication standard. In that case, for example, mutual communication between the portable information terminal 7200 and a headset capable of wireless communication can be performed, and thus hands-free calling is possible.

Moreover, the portable information terminal 7200 includes the input/output terminal 7206, and data can be directly transmitted to and received from another information terminal via a connector. In addition, charge via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. With the use of the secondary battery of one embodiment of the present invention, a lightweight long-life portable information terminal can be provided. For example, the secondary battery 7104 in FIG. 28E that is in the state of being curved can be provided in the housing 7201. Alternatively, the secondary battery 7104 in FIG. 28E can be provided in the band 7203 such that it can be curved.

The portable information terminal 7200 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 28G illustrates an example of an armband display device. A display device 7300 includes a display portion 7304 and the secondary battery of one embodiment of the present invention. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication based on an existing communication standard.

The display device 7300 includes an input/output terminal, and data can be directly transmitted to and received from another information terminal via a connector. In addition, charge via the input/output terminal is possible. Note that the charging operation may be performed by wireless power feeding without using the input/output terminal.

By using the secondary battery of one embodiment of the present invention as the secondary battery included in the display device 7300, a lightweight long-life display device can be provided.

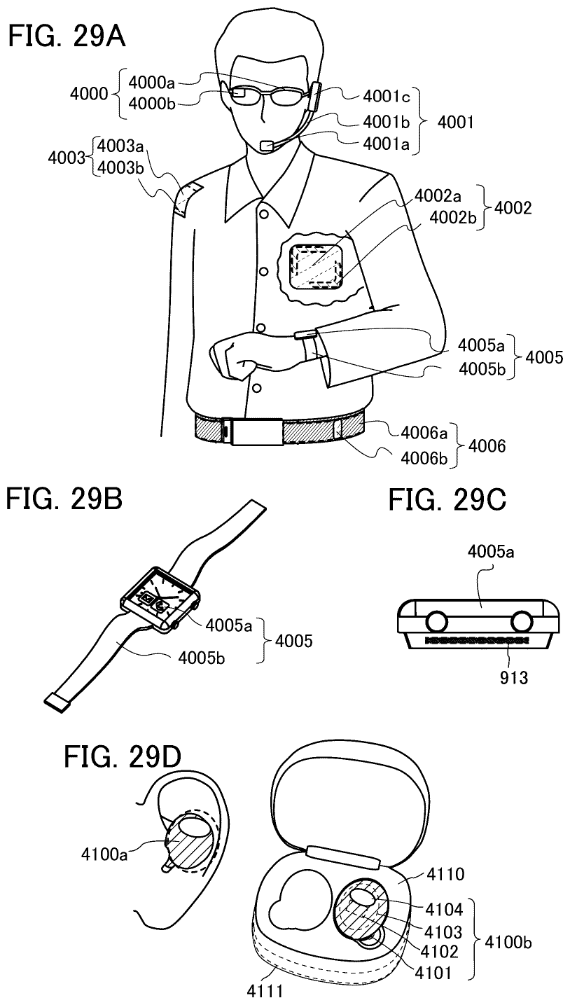

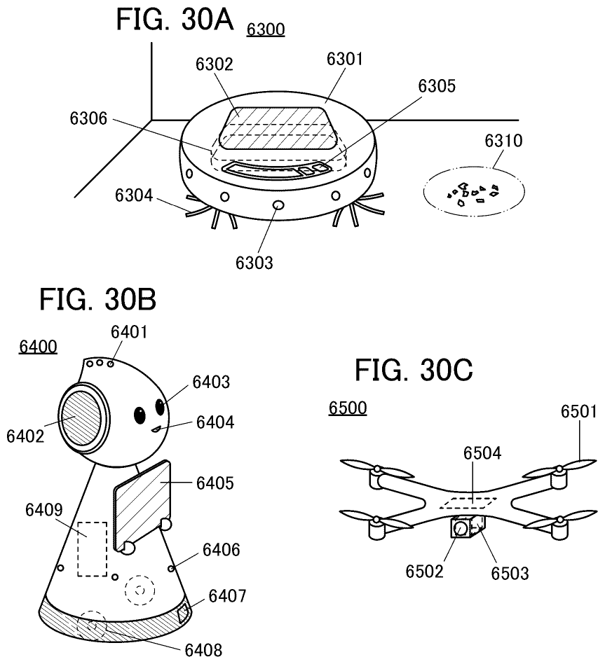

Examples of electronic devices each including the secondary battery with excellent cycling performance described in the above embodiment are described with reference to FIG. 28H, FIGS. 29A to 29D, and FIGS. 30A to 30C.

By using the secondary battery of one embodiment of the present invention as a secondary battery of a daily electronic device, a lightweight long-life product can be provided. Examples of daily electronic devices include an electric toothbrush, an electric shaver, and electric beauty equipment. As secondary batteries for these products, small and lightweight stick-type secondary batteries with high discharge capacity are desired in consideration of handling ease for users.

FIG. 28H is a perspective view of a device called a vaporizer (electronic cigarette). In FIG. 28H, an electronic cigarette 7500 includes an atomizer 7501 including a heating element, a secondary battery 7504 that supplies power to the atomizer, and a cartridge 7502 including a liquid supply bottle, a sensor, and the like. To improve safety, a protection circuit that prevents overcharge and/or overdischarge of the secondary battery 7504 may be electrically connected to the secondary battery 7504. The secondary battery 7504 in FIG. 28H includes an external terminal for connection to a charger. When the electronic cigarette 7500 is held by a user, the secondary battery 7504 is at the tip of the device; thus, it is preferred that the secondary battery 7504 have a short total length and be lightweight. With the secondary battery of one embodiment of the present invention, which has high discharge capacity and excellent cycle performance, the small and lightweight electronic cigarette 7500 that can be used for a long time over a long period can be provided.

FIG. 29A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 4000 illustrated in FIG. 29A. The glasses-type device 4000 includes a frame 4000a and a display part 4000b. The secondary battery is provided in a temple of the frame 4000a having a curved shape, whereby the glasses-type device 4000 can be lightweight, can have a well-balanced weight, and can be used continuously for along time. With the use of the secondary battery of one embodiment of the present invention, space saving required with downsizing of a housing can be achieved.

The secondary battery of one embodiment of the present invention can be provided in a headset-type device 4001. The headset-type device 4001 includes at least a microphone part 4001a, a flexible pipe 4001b, and an earphone portion 4001c. The secondary battery can be provided in the flexible pipe 4001b and/or the earphone portion 4001c. With the use of the secondary battery of one embodiment of the present invention, space saving required with downsizing of a housing can be achieved.

The secondary battery of one embodiment of the present invention can be provided in a device 4002 that can be attached directly to a body. A secondary battery 4002b can be provided in a thin housing 4002a of the device 4002. With the use of the secondary battery of one embodiment of the present invention, space saving required with downsizing of a housing can be achieved.

The secondary battery of one embodiment of the present invention can be provided in a device 4003 that can be attached to clothes. A secondary battery 4003b can be provided in a thin housing 4003a of the device 4003. With the use of the secondary battery of one embodiment of the present invention, space saving required with downsizing of a housing can be achieved.

The secondary battery of one embodiment of the present invention can be provided in a belt-type device 4006. The belt-type device 4006 includes a belt portion 4006a and a wireless power feeding and receiving portion 4006b, and the secondary battery can be provided inside the belt portion 4006a. With the use of the secondary battery of one embodiment of the present invention, space saving required with downsizing of a housing can be achieved.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. With the use of the secondary battery of one embodiment of the present invention, space saving required with downsizing of a housing can be achieved.

The display portion 4005a can display various kinds of information such as time and reception information of an e-mail or an incoming call.

In addition, the watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 29B is a perspective view of the watch-type device 4005 that is detached from an arm.

FIG. 29C is a side view. FIG. 29C illustrates a state where the secondary battery 913 is incorporated in the watch-type device 4005. The secondary battery 913 is the secondary battery described in Embodiment 5. The secondary battery 913, which is small and lightweight, overlaps with the display portion 4005a.

FIG. 29D illustrates an example of wireless earphones. The wireless earphones shown as an example consist of, but not limited to, a pair of earphone bodies 4100a and 4100b.

Each of the earphone bodies 4100a and 4100b includes a driver unit 4101, an antenna 4102, and a secondary battery 4103. Each of the earphone bodies 4100a and 4100b may also include a display portion 4104. Moreover, each of the earphone bodies 4100a and 4100b preferably includes a substrate where a circuit such as a wireless IC is provided, a terminal for charge, and the like. Each of the earphone bodies 4100a and 4100b may also include a microphone.

A case 4110 includes a secondary battery 4111. Moreover, the case 4110 preferably includes a substrate where a circuit such as a wireless IC or a charge control IC is provided, and a terminal for charge. The case 4110 may also include a display portion, a button, and the like.

The earphone bodies 4100a and 4100b can communicate wirelessly with another electronic device such as a smartphone. Thus, sound data and the like transmitted from another electronic device can be played through the earphone bodies 4100a and 4100b. When the earphone bodies 4100a and 4100b include a microphone, sound captured by the microphone is transmitted to another electronic device, and sound data obtained by processing with the electronic device can be transmitted to and played through the earphone bodies 4100a and 4100b. Hence, the wireless earphones can be used as a translator, for example.

The secondary battery 4103 included in the earphone body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery whose positive electrode includes the positive electrode active material 100 obtained in Embodiment 1 has a high energy density; thus, with the use of the secondary battery as the secondary battery 4103 and the secondary battery 4111, space saving required with downsizing of the wireless earphones can be achieved.

FIG. 30A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes the secondary battery 6306 of one embodiment of the present invention and a semiconductor device or an electronic component. The cleaning robot 6300 including the secondary battery 6306 of one embodiment of the present invention can be a highly reliable electronic device that can operate for a long time.

FIG. 30B illustrates an example of a robot. A robot 6400 illustrated in FIG. 30B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 30C illustrates an example of a flying object. A flying object 6500 illustrated in FIG. 30C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there is an obstacle in the way of the movement. Moreover, the electronic component 6504 can estimate the remaining battery level from a change in the power storage capacity of the secondary battery 6503. The flying object 6500 further includes the secondary battery 6503 of one embodiment of the present invention. The flying object 6500 including the secondary battery of one embodiment of the present invention can be a highly reliable electronic device that can operate for a long time.

This embodiment can be implemented in appropriate combination with any of the other embodiments.

### Embodiment 6

In this embodiment, examples of vehicles each including the secondary battery containing a positive electrode active material of one embodiment of the present invention are described.

The use of secondary batteries in vehicles enables production of next-generation clean energy vehicles such as hybrid vehicles (HV), electric vehicles (EV), and plug-in hybrid vehicles (PHV).

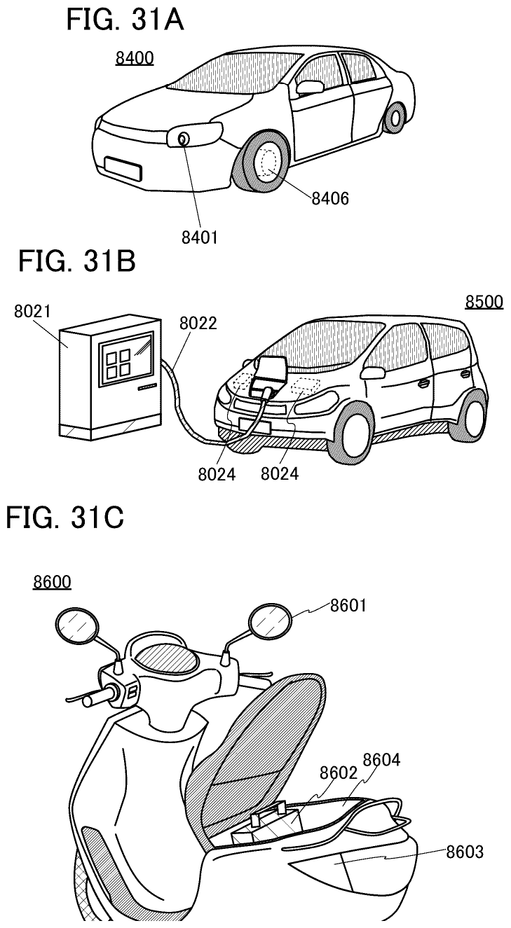

FIGS. 31A to 31C illustrate examples of vehicles each including the secondary battery of one embodiment of the present invention. An automobile 8400 illustrated in FIG. 31A is an electric vehicle that runs on the power of an electric motor. Alternatively, the automobile 8400 is a hybrid vehicle capable of driving using either an electric motor or an engine as appropriate. The use of one embodiment of the present invention allows fabrication of a high-mileage vehicle. The automobile 8400 includes the secondary battery. For example, the modules of the secondary battery can be arranged in a floor portion in the automobile to be used. The secondary battery is used not only for driving an electric motor 8406, but also for supplying electric power to light-emitting devices such as a headlight 8401 and a room light (not illustrated).

The secondary battery can also supply electric power to a display device included in the automobile 8400, such as a speedometer and a tachometer. Furthermore, the secondary battery can supply electric power to a semiconductor device included in the automobile 8400, such as a navigation system.

FIG. 31B illustrates an automobile 8500 including the secondary battery. The automobile 8500 can be charged when the secondary battery is supplied with electric power from external charging equipment by a plug-in system and/or a contactless power feeding system, for example. In FIG. 31B, a secondary battery 8024 included in the automobile 8500 is charged with the use of a ground-based charging apparatus 8021 through a cable 8022. In charging, a given method such as CHAdeMO (registered trademark) or Combined Charging System can be employed as a charging method, the standard of a connector, or the like as appropriate. The charging apparatus 8021 may be a charging station provided in a commerce facility or a power source in a house. For example, with the use of a plug-in technique, the secondary battery 8024 included in the automobile 8500 can be charged by being supplied with electric power from the outside. The charging can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road and/or an exterior wall, charging can be performed not only when the vehicle is stopped but also when driven. In addition, the contactless power feeding system may be utilized to perform transmission and reception of electric power between vehicles. Furthermore, a solar cell may be provided in the exterior of the vehicle to charge the secondary battery when the vehicle stops and/or moves. To supply electric power in such a contactless manner, an electromagnetic induction method and/or a magnetic resonance method can be used.

FIG. 31C illustrates an example of a motorcycle including the secondary battery of one embodiment of the present invention. A motor scooter 8600 illustrated in FIG. 31C includes a secondary battery 8602, side mirrors 8601, and indicators 8603. The secondary battery 8602 can supply electric power to the indicators 8603.

In the motor scooter 8600 illustrated in FIG. 31C, the secondary battery 8602 can be held in an under-seat storage unit 8604. The secondary battery 8602 can be held in the under-seat storage unit 8604 even with a small size. The secondary battery 8602 is detachable; thus, the secondary battery 8602 is carried indoors when charged, and is stored before the motor scooter is driven.

According to one embodiment of the present invention, the secondary battery can have improved cycle performance and an increased discharge capacity. Thus, the secondary battery itself can be made more compact and lightweight. The compact and lightweight secondary battery contributes to a reduction in the weight of a vehicle and thereby increases the mileage. Furthermore, the secondary battery included in the vehicle can be used as a power source for supplying electric power to products other than the vehicle. In such a case, the use of a commercial power supply can be avoided at peak time of electric power demand, for example. Avoiding the use of a commercial power supply at peak time of electric power demand can contribute to energy saving and a reduction in carbon dioxide emissions. Moreover, the secondary battery with excellent cycle performance can be used over a long period; thus, the use amount of rare metals such as cobalt can be reduced.

This embodiment can be implemented in appropriate combination with any of the other embodiments.

### Example 1

In this example, the positive electrode that is used in the battery of one embodiment of the present invention was formed and its charge and discharge characteristics were evaluated.

### [Formation of Positive Electrode Active Material]

Sample 1 of a positive electrode active material formed in this example is described with reference to the formation method in FIG. 26 and FIGS. 27A to 27C.

As the LiCoO₂ in Step S14 in FIG. 26, commercially available lithium cobalt oxide (Cellseed C-10N produced by NIPPON CHEMICAL INDUSTRIAL CO., LTD.) containing cobalt as the transition metal M and no additive element was prepared and sieved by an automatic sieving machine. As the initial heating in Step S15, heating was performed on this lithium cobalt oxide put in a sagger covered with a lid, in a roller hearth kiln simulator furnace (produced by NORITAKE CO., LIMITED) as a baking furnace at 850° C. for 2 hours. Air (compressed air which was sufficiently dried) was made to flow at 10 L/min in the furnace. The flow rate was adjusted such that a differential pressure gauge read 5 Pa. Cooling in the furnace was performed at a rate of 200° C./h, with the air keeping on flowing until the temperature reached 200° C.

In this example, Mg, F, Ni, and Al were separately added as the additive elements in accordance with Step S21 and Step S41 shown in FIG. 27A and FIG. 27C. First, in accordance with Step S21 shown in FIG. 27A, LiF and MgF₂ were prepared as the F source and the Mg source, respectively. The LiF and MgF₂ were weighed such that LiF: MgF₂=1:3 (molar ratio), and sieved by an automatic sieving machine in accordance with Step S22. Then, the LiF and MgF₂ were mixed in dehydrated acetone at a rotational speed of 500 rpm for 20 hours to give an additive element source (A1 source).

Then, in Step S31, the A1 source and the lithium cobalt oxide subjected to the initial heating were weighed such that the magnesium of the A1 source was 1 mol % with respect to the cobalt, and were mixed by a dry method. The resulting mixture was stirred using a picobond (produced by HOSOKAWA MICRON CORPORATION) at a rotational speed of 3000 rpm for 10 minutes and sieved by an automatic sieving machine to give the mixture 903 (Step S32).

Subsequently, in Step S33, the mixture 903 was heated. The heating was performed at 900° C. for 20 hours. During the heating, the mixture 903 was in a sagger covered with a lid. Covering the sagger with the lid makes it possible that the sagger is filled with an atmosphere containing oxygen and entry and exit of the oxygen are blocked (O₂ purging). During the heating performed at the above heating temperature, the sagger was in a roller hearth kiln simulator furnace (produced by NORITAKE CO., LIMITED). Oxygen was made to flow at 10 L/min in the furnace (O₂ flowing). The flow rate, specifically, the opening width of an outlet was adjusted such that a differential pressure gauge read 5 Pa. Cooling in the furnace was performed at a rate of 200° C./h, with oxygen keeping on flowing until the temperature reached 200° C. Accordingly, a composite oxide containing Mg and F was obtained (Step S34a).

Then, in Step S51, the composite oxide and the additive element sources (the A2 sources) were mixed. Nickel hydroxide on which a grinding step was performed was prepared as the nickel source and aluminum hydroxide on which a grinding step was performed was prepared as the aluminum source in accordance with Step S41 shown in FIG. 27C, so that the additive element sources (the A2 sources) were obtained. The nickel hydroxide, the aluminum hydroxide, and the composite oxide were weighed such that the nickel in the nickel hydroxide and the aluminum in the aluminum hydroxide were each 0.5 mol % with respect to the cobalt, and the nickel hydroxide, the aluminum hydroxide, and the composite oxide were mixed by a dry method. The resulting mixture was stirred using a picobond (produced by HOSOKAWA MICRON CORPORATION) at a rotational speed of 3000 rpm for 10 minutes to give the mixture 904 (Step S52).

Subsequently, in Step S53, the mixture 904 was heated. The heating was performed at 850° C. for 10 hours. During the heating, the mixture 904 was in a sagger covered with a lid. During the heating performed at the above heating temperature, the sagger was in a roller hearth kiln simulator furnace (produced by NORITAKE CO., LIMITED). Oxygen was made to flow at 10 L/min in the furnace (O₂ flowing). The flow rate was adjusted such that a differential pressure gauge read 5 Pa. Cooling in the furnace was performed at a rate of 200° C./h, with oxygen keeping on flowing until the temperature reached 200° C. Thus, lithium cobalt oxide containing Mg, F, Ni, and Al was obtained (Step S54). This positive electrode active material (composite oxide), which was obtained through the above steps, was used as Sample 1 of a positive electrode active material.

### [Formation of Positive Electrode]

A positive electrode sample was formed referring to the formation method in FIGS. 6A to 6E. Note that the positive electrode lead 21 was not provided.

A 25-μm-thick polypropylene film, Sample 1 of a positive electrode active material formed in the above, and a carbon sheet were used as a base, a positive electrode active material, and a positive electrode current collector, respectively. Note that as the carbon sheet manufactured by Hamamatsu Carbonics Corporation was used.

The compounding ratio of lithium cobalt oxide, acetylene black, and polyvinylidene fluoride in a positive electrode active material layer was set to 95:3:2 in weight ratio. NMP was used as a dispersion medium of a positive electrode active material slurry.

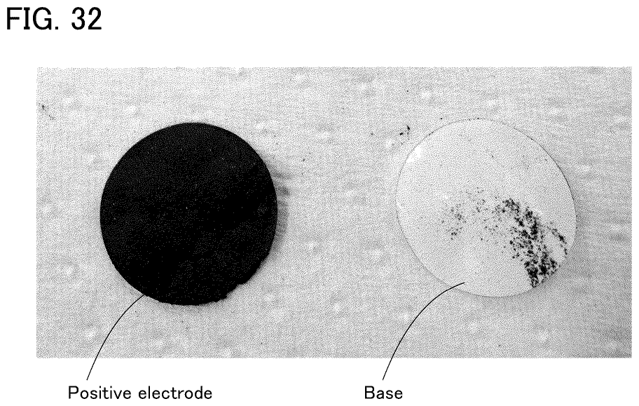

FIG. 32 is a photograph of the appearance of the formed positive electrode sample and the base separated from the positive electrode sample.

As shown in FIG. 32, a favorable positive electrode with almost no active material remaining on the base was obtained.

### [Fabrication of Battery]

Next, a test cell for a charge and discharge test was fabricated with the use of the positive electrode sample. A coin-type cell was used as the test cell.

As an electrolyte solution, EMI-FSI containing LiFSI as an electrolyte at a concentration of 2.15 mol/L was used. As a separator, a polyimide porous film was used.

For a negative electrode (counter electrode), a lithium metal was used. The coin-type test cell was fabricated using these components.

### [Charge and Discharge Test]

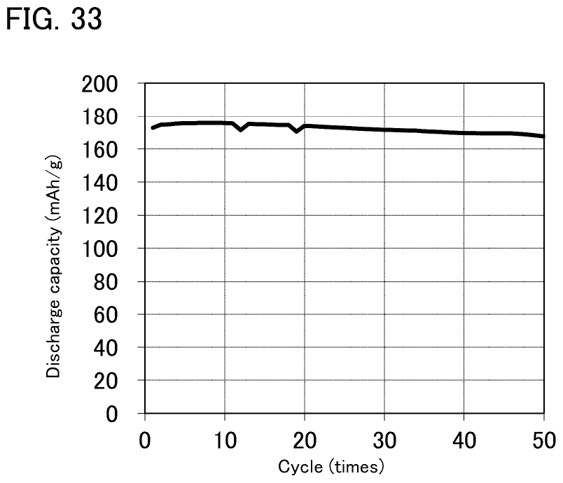

A charge and discharge test was performed with the use of the above test cell. In the charging, constant current charging was performed at 0.2 C was performed until the voltage reached 4.5 V and then, constant voltage charging was performed until the current value reached 0.02 C. In the discharging, constant current discharging at 0.2 C was performed up to 2.5 V. Note that here, 1 C was set to 200 mA/g. The environmental temperature of the measurement was 25° C. The charging and discharging were repeated 50 times. FIG. 33 shows the results of the charge and discharge cycle test.

As shown in FIG. 33, the test cell exhibits favorable charge and discharge characteristics.

This application is based on Japanese Patent Application Serial No. 2022-117349 filed with Japan Patent Office on Jul. 22, 2022, the entire contents of which are hereby incorporated by reference.

What is claimed is:

1. A battery comprising a positive electrode,
wherein the positive electrode comprises a positive electrode current collector and a positive electrode active material layer, and
wherein the positive electrode current collector is a carbon sheet.

2. The battery according to claim 1, wherein the carbon sheet comprises carbon nanotubes.

3. The battery according to claim 1,
wherein the positive electrode active material layer comprises a positive electrode active material,
wherein the positive electrode active material comprises lithium cobalt oxide comprising nickel and magnesium,
wherein a detected amount of nickel in a surface portion of the positive electrode active material is larger than a detected amount of nickel in an inner portion of the positive electrode active material,
wherein a detected amount of magnesium in the surface portion of the positive electrode active material is larger than a detected amount of magnesium in the inner portion of the positive electrode active material, and
wherein the surface portion of the positive electrode active material comprises a region where distribution of nickel and distribution of magnesium overlap with each other.

4. The battery according to claim 3, wherein nickel is detected on a plane other than a (001) plane of lithium cobalt oxide in the surface portion of the positive electrode active material.

5. A battery comprising a positive electrode,
wherein the positive electrode comprises a positive electrode current collector and a positive electrode active material layer,
wherein the positive electrode current collector comprises a stack of a first carbon sheet and a second carbon sheet, and
wherein the first carbon sheet and the second carbon sheet each comprise carbon nanotubes.

6. The battery according to claim 5,
wherein in the first carbon sheet, the carbon nanotubes are oriented in a first direction parallel to a surface of the first carbon sheet,
wherein in the second carbon sheet, the carbon nanotubes are oriented in a second direction parallel to a surface of the second carbon sheet, and
wherein the first direction and the second direction are substantially orthogonal to each other.

7. The battery according to claim 5,
wherein the battery comprises an exterior body surrounding the positive electrode and a positive electrode lead extending from an inside to an outside of the exterior body, and
wherein the positive electrode lead comprises a region positioned between the first carbon sheet and the second carbon sheet.

8. The battery according to claim 5,
wherein the positive electrode active material layer comprises a positive electrode active material,
wherein the positive electrode active material comprises lithium cobalt oxide comprising nickel and magnesium,
wherein a detected amount of nickel in a surface portion of the positive electrode active material is larger than a detected amount of nickel in an inner portion of the positive electrode active material,
wherein a detected amount of magnesium in the surface portion of the positive electrode active material is larger than a detected amount of magnesium in the inner portion of the positive electrode active material, and
wherein the surface portion of the positive electrode active material comprises a region where distribution of nickel and distribution of magnesium overlap with each other.

9. The battery according to claim 8, wherein nickel is detected on a plane other than a (001) plane of lithium cobalt oxide in the surface portion of the positive electrode active material.

10. The battery according to claim 9, wherein in EDX line analysis, a difference between a depth of a peak of the detected amount of nickel and a peak of the detected amount of magnesium in the surface portion of the positive electrode active material is less than or equal to 3 nm.

11. The battery according to claim 8,
wherein the positive electrode active material comprises aluminum,
wherein in EDX line analysis of nickel, magnesium, and aluminum in the positive electrode active material, a maximum value of a detected amount of aluminum is observed at an inner portion than a maximum value of a detected amount of nickel and a maximum value of a detected amount of magnesium, and
wherein in EDX line analysis, when a peak width at a height that is ⅕ of a height of the maximum value of the detected amount of aluminum is divided into two parts by a perpendicular extending from the maximum value to a horizontal axis, a peak width W_{c} on an inner portion side is larger than a peak width Wₛ on a surface side.

12. The battery according to claim 8,
wherein the lithium is used for the positive electrode and a counter electrode, and
wherein when the positive electrode is analyzed by powder X-ray diffraction using a CuKα₁ ray in a state where the battery is charged to 4.6 V, a diffraction pattern of the positive electrode active material comprises at least a first peak at 2θ of greater than or equal to 19.13° and less than 19.37° and a second peak at 2θ of greater than or equal to 45.37° and less than 45.57°.

13. The battery according to claim 8,
wherein the positive electrode active material comprises fluorine, and
wherein a detected amount of fluorine in the surface portion of the positive electrode active material is larger than a detected amount of fluorine in the inner portion of the positive electrode active material.

14. A battery comprising a positive electrode,
wherein the positive electrode comprises a positive electrode current collector and a positive electrode active material layer,
wherein the positive electrode current collector comprises a stack of a first carbon sheet and a second carbon sheet,
wherein the first carbon sheet and the second carbon sheet each comprise carbon nanotubes,
wherein in the first carbon sheet, the carbon nanotubes are oriented in a first direction parallel to a surface of the first carbon sheet,
wherein in the second carbon sheet, the carbon nanotubes are oriented in a second direction parallel to a surface of the second carbon sheet,
wherein the first direction and the second direction are substantially orthogonal to each other,
wherein the positive electrode active material layer comprises a positive electrode active material,
wherein the positive electrode active material comprises lithium cobalt oxide comprising nickel and magnesium,
wherein a detected amount of nickel in a surface portion of the positive electrode active material is larger than a detected amount of nickel in an inner portion of the positive electrode active material,
wherein a detected amount of magnesium in the surface portion of the positive electrode active material is larger than a detected amount of magnesium in the inner portion of the positive electrode active material, and
wherein the surface portion of the positive electrode active material comprises a region where distribution of nickel and distribution of magnesium overlap with each other.

15. The battery according to claim 14,
wherein the battery comprises an exterior body surrounding the positive electrode and a positive electrode lead extending from an inside to an outside of the exterior body, and
wherein the positive electrode lead comprises a region positioned between the first carbon sheet and the second carbon sheet.

16. The battery according to claim 14, wherein nickel is detected on a plane other than a (001) plane of lithium cobalt oxide in the surface portion of the positive electrode active material.

17. The battery according to claim 14, wherein in EDX line analysis, a difference between a depth of a peak of the detected amount of nickel and a peak of the detected amount of magnesium in the surface portion of the positive electrode active material is less than or equal to 3 nm.

18. The battery according to claim 14,
wherein the positive electrode active material comprises aluminum,
wherein in EDX line analysis of nickel, magnesium, and aluminum in the positive electrode active material, a maximum value of a detected amount of aluminum is observed at an inner portion than a maximum value of a detected amount of nickel and a maximum value of a detected amount of magnesium, and
wherein in EDX line analysis, when a peak width at a height that is ⅕ of a height of the maximum value of the detected amount of aluminum is divided into two parts by a perpendicular extending from the maximum value to a horizontal axis, a peak width W_{c} on an inner portion side is larger than a peak width Wₛ on a surface side.

19. The battery according to claim 14,
wherein the lithium is used for the positive electrode and a counter electrode, and
wherein when the positive electrode is analyzed by powder X-ray diffraction using a CuKα₁ ray in a state where the battery is charged to 4.6 V, a diffraction pattern of the positive electrode active material comprises at least a first peak at 2θ of greater than or equal to 19.13° and less than 19.37° and a second peak at 2θ of greater than or equal to 45.37° and less than 45.57°.

20. The battery according to claim 14,
wherein the positive electrode active material comprises fluorine, and
wherein a detected amount of fluorine in the surface portion of the positive electrode active material is larger than a detected amount of fluorine in the inner portion of the positive electrode active material.
